(19) United States
(12) Patent Application Publication
(10) Pub. No.: US 2026/0073232 A1
(43) Pub. Date: Mar. 12, 2026

(54) MASS ANALYZER CALIBRATION VIA REINFORCEMENT LEARNING

(71) Applicant: Thermo Fisher Scientific (Bremen) GmbH, Bremen (DE)

(72) Inventor: Amelia Corinne Peterson, Aalen (DE)

(21) Appl. No.: 18/971,893

(22) Filed: Dec. 6, 2024

Related U.S. Application Data
(60) Provisional application No. 63/692,695, filed on Sep. 9, 2024.
(60) Provisional application No. 63/705,725, filed on Oct. 10, 2024.

(51) Int. Cl. G06N 3/092; H01J 49/00

(52) U.S. Cl. CPC G06N 3/092; H01J 49/0009

(57) ABSTRACT

Systems/techniques are provided for facilitating mass analyzer calibration via reinforcement learning. In various embodiments, a system can predict, via execution of one or more reinforcement learning neural networks on present-time state data of a mass analyzer of a scientific instrument, what adjustments to one or more operational parameters of the mass analyzer would cause the mass analyzer to approach a calibrated state, wherein the one or more operational parameters include an electrode voltage of the mass analyzer or a timing control of the mass analyzer. In various aspects, the system can modify the one or more operational parameters based on the adjustments, thereby causing the mass analyzer to approach the calibrated state.

### CROSS-REFERENCE TO RELATED APPLICATIONS

This application claims priority to and the benefit of U.S. Provisional Application No. 63/692,695, entitled “DEEP REINFORCEMENT LEARNING AGENTS FOR SCIENTIFIC INSTRUMENT SELF-CALIBRATION,” which was filed on Sep. 9, 2024, and claims priority to and the benefit of U.S. Provisional Application No. 63/705,725, entitled “DEEP REINFORCEMENT LEARNING AGENTS FOR SCIENTIFIC INSTRUMENT SELF-CALIBRATION.” which was filed on Oct. 10, 2024. The entireties of the aforementioned applications are hereby incorporated herein by reference.

### BACKGROUND

Calibrating a mass analyzer can be considered as a complicated or otherwise non-trivial task.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate mass analyzer calibration via reinforcement learning are described.

According to one or more embodiments, a system is provided. The system can comprise a non-transitory computer-readable memory that can store computer-executable components. The system can further comprise a processor that can be operably coupled to the non-transitory computer-readable memory and that can execute the computer-executable components stored in the non-transitory computer-readable memory. In various embodiments, the computer-executable components can comprise a calibration component that can predict, via execution of one or more reinforcement learning neural networks on present-time state data of a mass analyzer of a scientific instrument, what adjustments to one or more operational parameters of the mass analyzer would cause the mass analyzer to approach a calibrated state, wherein the one or more operational parameters include an electrode voltage of the mass analyzer or a timing control of the mass analyzer. In various aspects, the computer-executable components can comprise an execution component that can modify the one or more operational parameters based on the adjustments, thereby causing the mass analyzer to approach the calibrated state.

According to one or more embodiments, a computer-implemented method is provided. In various embodiments, the computer-implemented method can comprise predicting, by a device operatively coupled to a processor and via execution of one or more reinforcement learning neural networks on present-time state data of a mass analyzer of a scientific instrument, what adjustments to one or more operational parameters of the mass analyzer would cause the mass analyzer to approach a calibrated state, wherein the one or more operational parameters include an electrode voltage of the mass analyzer or a timing control of the mass analyzer. In various aspects, the computer-implemented method can comprise modifying, by the device, the one or more operational parameters based on the adjustments, thereby causing the mass analyzer to approach the calibrated state.

According to one or more embodiments, a computer program product for facilitating mass analyzer calibration via reinforcement learning is provided. In various embodiments, the computer program product can comprise a non-transitory computer-readable memory having program instructions embodied therewith. In various aspects, the program instructions can be executable by a processor to cause the processor to access present-time state data of a mass analyzer of a mass spectrometer. In various instances, the program instructions can be executable to cause the processor to predict, via execution of one or more reinforcement learning neural networks on the present-time state data, what adjustments to one or more electrode voltages of the mass analyzer would cause the mass analyzer to get closer to a calibrated state. In various cases, the program instructions can be executable to cause the processor to increase or decrease the one or more electrode voltages according to the predicted adjustments, thereby causing the mass analyzer to be calibrated.

### DESCRIPTION OF THE DRAWINGS

Various embodiments will be readily understood by the following detailed description in conjunction with the accompanying figures. To facilitate this description, like reference numerals designate like structural elements. Embodiments are illustrated by way of example, not by way of limitation, in the figures. The figures are not necessarily drawn to scale.

FIG. 1 illustrates an example, non-limiting block diagram of a scientific instrument module in accordance with various embodiments described herein.

FIG. 2 illustrates an example, non-limiting flow diagram of a computer-implemented method in accordance with various embodiments described herein.

FIG. 3 illustrates a block diagram of an example, non-limiting system that facilitates mass analyzer calibration via reinforcement learning in accordance with one or more embodiments described herein.

FIG. 4 illustrates a block diagram of an example, non-limiting system including a prioritized experience replay buffer and a set of reinforcement learning neural networks that facilitates mass analyzer calibration via reinforcement learning in accordance with one or more embodiments described herein.

FIG. 5 illustrates an example, non-limiting block diagram showing a prioritized experience replay buffer in accordance with one or more embodiments described herein.

FIG. 6 illustrates an example, non-limiting block diagram of a mass analyzer state in accordance with one or more embodiments described herein.

FIG. 7 illustrates an example, non-limiting block diagram showing a set of reinforcement learning neural networks in accordance with one or more embodiments described herein.

FIGS. 8-12 illustrate example, non-limiting block diagrams showing how a set of reinforcement learning neural networks can be trained based on a prioritized replay buffer in accordance with one or more embodiments described herein.

FIG. 13 illustrates a block diagram of an example, non-limiting system including a present-time mass analyzer state and a voltage/timing adjustment that facilitates mass analyzer calibration via reinforcement learning in accordance with one or more embodiments described herein.

FIG. 14 illustrates an example, non-limiting block diagram showing how a voltage/timing adjustment can be generated for calibration based on a present-time mass analyzer state in accordance with one or more embodiments described herein.

FIG. 15 illustrates a block diagram of an example, non-limiting operating environment in which one or more embodiments described herein can be facilitated.

FIG. 16 illustrates an example networking environment operable to execute various implementations described herein.

FIG. 17 illustrates a cycle of agent-environment interaction in deep reinforcement learning, in accordance with various embodiments.

FIG. 18 illustrates the deep reinforcement learning cycle applied to the problem of orbital trapping mass analyzer calibration, in accordance with various embodiments.

FIGS. 19-22 illustrate an exemplary algorithm and explain various components, in accordance with various embodiments.

FIG. 23 illustrates the inter-relationship of various mass analyzer metrics, in accordance with various embodiments.

FIGS. 24-27 illustrate inputs, processing steps, and outputs associated with various mass analyzer metrics, in accordance with various embodiments.

FIG. 28 is a schematic of a mass analyzer state, in accordance with various embodiments.

FIG. 29 illustrates a reward function, in accordance with various embodiments.

FIG. 30 illustrates the creation of tuples from a manually-crafted calibration trajectory, in accordance with various embodiments.

FIG. 31 shows calibration tuning state over several timesteps on-instrument in response to (top) no agent interaction, and (bottom) random agent interaction, in accordance with various embodiments.

FIG. 32 illustrates a training plan, in accordance with various embodiments.

FIG. 33 illustrates modalities for post-training usage and calibration, in accordance with various embodiments.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details. It is also evident that new embodiments can be created by combining the embodiments described herein and/or by omitting certain features from the embodiments described therein, as appropriate.

Various operations can be described as multiple discrete actions or operations in turn, in a manner that is most helpful in understanding the subject matter disclosed herein. However, the order of description should not be construed as to imply that these operations are necessarily order dependent. In particular, these operations can be performed in an order different from the order of presentation. Operations described can be performed in a different order from the described embodiments. Various additional operations can be performed, or described operations can be omitted in additional embodiments.

Although some elements may be referred to in the singular (e.g., “a processing device”), any appropriate elements may be represented by multiple instances of that element, and vice versa. For example, a set of operations described as performed by a processing device may be implemented with different ones of the operations performed by different processing devices. As used herein, the phrase “based on” should be understood to mean “based at least in part on,” unless otherwise specified.

A mass spectrometer coupled to a chromatograph can be considered as a type of scientific instrument that can be deployed in a scientific, laboratory, research, or clinical operational context or setting, so as to determine the chemical composition or make-up of unknown samples. To facilitate such chemical composition determination, the mass spectrometer or chromatograph can comprise a complex arrangement of actuatable parts (e.g., ion sources, ion lenses, heaters, coolers, columns, ovens, injectors, mass analyzers, fluid valves, fluid pumps, circuit switches), sensors (e.g., ion detectors, voltmeters, thermistors, potentiometers, pressure gauges), or consumables (e.g., carrier fluids, calibrants, filters).

A mass analyzer can be considered as a particularly complicated constituent component of a mass spectrometer. A mass analyzer separates (or, in some cases, measures without physically separating) ions based on their mass-to-charge ratios (based on their m/z values), so that whatever chemical species make up a sample or specimen can be identified or quantified. Different mass analyzers exhibit different physical constructions, designs, or operating principles (e.g., quadrupole mass analyzers versus time-of-flight mass analyzers versus orbital trapping mass analyzers). In order for a mass analyzer to operate properly (e.g., to correctly, accurately, or reliably distinguish ions according to their mass-to-charge ratios), the mass analyzer should first be calibrated. In other words, whatever configurable operating parameters that the mass analyzer has should be set to or otherwise assigned whatever specific values that cause performance of the mass spectrometer to be optimized or approximately optimized.

Because the mass analyzer can have dozens of configurable operating parameters (e.g., electrode voltages, timing controls) that are not necessarily independent of each other, identification or determination of what specific parameter values that cause performance to be maximized can be considered as a difficult or otherwise non-trivial task. This difficulty or non-triviality is exacerbated by the fact that “performance” of the mass analyzer can be considered as an ephemeral concept which might be represented or proxied by any of various different metrics (e.g., Does optimizing “performance” mean obtaining an optimal resolution? Or does optimizing “performance” instead mean obtaining an optimal mass accuracy? Or does it instead mean obtaining an optimal ion transmission efficiency?). Such difficulty or non-triviality is even further exacerbated by the stochasticity of ion sources, by the stochasticity of mass spectrometry measures, and by the fact that a change to any given configurable operating parameter might have opposing or conflict influences on any given set of performance metrics (e.g., increasing the given configurable operating parameter might cause one performance metric to improve while simultaneously causing another performance metric to degrade).

For at least these reasons, calibration of a mass analyzer is unfortunately considered to be a computationally intractable problem which existing techniques cannot adequately address. Indeed, some existing techniques facilitate mass analyzer calibration by applying gradient descent, gradient ascent, or Bayesian filtration to only a very small number (e.g., one or two) of performance metrics. Such existing techniques are of extremely limited scope (e.g., they ignore many potential performance metrics of a mass analyzer). In other words, when such existing techniques place a mass analyzer into a purportedly calibrated state, such purportedly calibrated state does not actually cause most of the possible performance metrics of the mass analyzer to be optimized. Other existing techniques leverage evolutionary algorithms to facilitate mass analyzer calibration (e.g., each possible permutation or combination of configurable operating parameter values proceeds through repetitive fitness-selection-mutation-elimination cycles, with the fitness of each permutation or combination being an aggregation of whatever performance metrics are being considered, and with the fittest or most optimal permutation or combination being the last to be eliminated). Such other existing techniques can be implemented without ignoring performance metrics. However, such other existing techniques are inordinately time-consuming (e.g., can take upwards of several hours to perform a single calibration).

Accordingly, systems or techniques that can facilitate mass analyzer calibration without ignoring performance metrics and without consuming excessive amounts of time can be desirable.

Various embodiments described herein can address this technical problem. One or more embodiments described herein can include systems, computer-implemented methods, apparatus, or computer program products that can facilitate mass analyzer calibration via reinforcement learning. In other words, the inventor of various embodiments described herein realized that the artificial intelligence technique of reinforcement learning can be adapted so as to provide fast calibration of mass analyzers without ignoring large swaths of mass analyzer performance metrics.

Reinforcement learning involves an actor that interacts with an environment. In particular, the actor can take actions that cause the environment to transition from one state to another; the actor can be rewarded or punished by the environment, depending upon the new or resultant state that the actor caused the environment to transition to; and whatever policy that the actor uses to decide which actions to take can be incrementally updated based on its reward or punishment. By repeating this cycle of actor-environment interaction numerous times, the actor's policy can ultimately become optimized such that the actor takes whatever actions that maximize its reward or that minimize its punishment.

Contrary to the wisdom of existing techniques, the present inventor realized that, in the context of mass analyzer calibration: a neural network could be considered as the actor; a mass analyzer to be calibrated can be considered as the environment; and voltage controls, timing controls, or scan results of the mass analyzer could be considered as the state of the environment. As described herein, that neural network can learn in reinforcement learning fashion how to change the voltage or timing parameters of the mass analyzer, so as to cause the mass analyzer to approach or get closer to a calibrated state. When various embodiments described herein are implemented, the mass analyzer can be calibrated in mere seconds or minutes by the neural network so as to optimize whatever performance metrics are desired. Thus, the need of some existing techniques to restrict calibration to only one or two performance metrics can be eliminated, and the inordinate calibration time-consumption of other existing techniques can also be eliminated. Accordingly, various embodiments described herein can be considered as desirable, beneficial, or advantageous.

Various embodiments described herein can be considered as a computerized tool (e.g., any suitable combination of computer-executable hardware or computer-executable software) that can facilitate mass analyzer calibration via reinforcement learning. In various aspects, such computerized tool can comprise a training component, a calibration component, or an execution component.

In various embodiments, there can be a mass spectrometer, which may or may not be operatively coupled in any suitable fashion to a chromatograph. In various aspects, the mass spectrometer can comprise any suitable constituent hardware (e.g., any suitable ion beam emitter; any suitable ion detector; any suitable ion optics equipment). In various instances, such constituent hardware can include a mass analyzer exhibiting any suitable design, construction, or architecture (e.g., quadrupole mass filter analyzer, time-of-flight (TOF) analyzer, electrostatic trap or orbital trapping (e.g., ORBITRAP™) mass analyzer, or Fourier transform ion cyclotron resonance (FT-ICR) mass analyzer).

In various cases, the mass analyzer can have any suitable types of configurable operating parameters. In various aspects, a configurable operating parameter can be any suitable selectively-controllable hardware characteristic or selectively-controllable software characteristic of the mass analyzer that can be directly adjusted or changed in response to electronic instructions or commands received from a user. For example, such configurable operating parameters can include electrode voltages of the mass analyzer (e.g., voltages of end-cap electrodes, of ring electrodes, of plate electrodes, or of rod electrodes) or timing controls of the mass analyzer (e.g., an ion injection duration or an ion trapping duration).

In any case, it can be desired to calibrate the configurable operating parameters of the mass analyzer. In various instances, the computerized tool described herein can accomplish such calibration.

In various embodiments, the training component of the computerized tool can electronically store, maintain, control, or otherwise access a prioritized experience replay buffer and a set of reinforcement learning neural networks. In various aspects, the training component can train the set of reinforcement learning neural networks to calibrate the mass analyzer, by leveraging the prioritized experience replay buffer as described herein.

In various instances, the prioritized experience replay buffer can include a plurality of mass analyzer states. In various cases, a mass analyzer state can be any suitable electronic data that conveys, indicates, or otherwise represents a calibration status or snap-shot of the mass analyzer. For example, the mass analyzer state can include specific values that can be assigned to the configurable operating parameters of the mass analyzer (e.g., specific voltage values to which the electrodes of the mass analyzer can be set; a specific value to which the ion injection duration of the mass analyzer can be set; a specific value to which the ion trapping duration of the mass analyzer can be set). As another example, the mass analyzer state can include specific metrics captured by or derived from any suitable scans that the mass analyzer can perform (e.g., isotope ratio fidelity metrics, mass error dispersion metrics, ion transmission metrics, resistance to coalescence metrics, any other desired performance metrics of the mass analyzer).

In various aspects, the prioritized experience replay buffer can include a plurality of mass analyzer parameter adjustments. In various instances, the plurality of mass analyzer parameter adjustments can respectively correspond to the plurality of mass analyzer states. In various cases, each of the plurality of mass analyzer parameter adjustments can be any suitable electronic data that indicates or specifies absolute or relative amounts by which respective configurable operating parameters of the mass analyzer can be increased, decreased, or otherwise adjusted (e.g., absolute or relative amounts by which electrode voltages, the ion injection duration, or the ion trapping duration of the mass analyzer can be modified).

In various aspects, the prioritized experience replay buffer can include a plurality of rewards. In various instances, the plurality of rewards can respectively correspond to the plurality of mass analyzer states and to the plurality of mass analyzer parameter adjustments. In various cases, each of the plurality of rewards can be any suitable scalar that indicates or represents how well or how poorly application of a respective mass analyzer parameter adjustment to a respective mass analyzer state would cause the mass analyzer to move toward a truly or properly calibrated state.

In various aspects, the prioritized experience replay buffer can include a plurality of resultant mass analyzer states. In various instances, the plurality of resultant mass analyzer states can respectively correspond to the plurality of mass analyzer states, to the plurality of mass analyzer parameter adjustments, and to the plurality of rewards. In various cases, each of the plurality of resultant mass analyzer states can be any suitable electronic data that indicates or represents what new state the mass analyzer would have, in response to a respective mass analyzer parameter adjustment being applied to a respective mass analyzer state.

In various aspects, the prioritized experience replay buffer can include a plurality of priorities. In various instances, the plurality of priorities can respectively correspond to the plurality of mass analyzer states, to the plurality of mass analyzer parameter adjustments, to the plurality of rewards, and to the plurality of resultant mass analyzer states. In various cases, a respective mass analyzer state, mass analyzer parameter adjustment, reward, and resultant mass analyzer state can be collectively considered as forming an experience tuple. Thus, the prioritized experience replay buffer can be considered as containing a plurality of experience tuples. In various aspects, each of the plurality of priorities can be a scalar that conveys or represents how important or significant a respective experience tuple is with regard to learning how to calibrate the mass analyzer.

In various embodiments, the set of reinforcement learning neural networks can include a parameter adjustment neural network, a target parameter adjustment neural network, a parameter valuation neural network, or a target parameter valuation neural network.

In various aspects, the parameter adjustment neural network can exhibit any suitable deep learning internal architecture. For example, the parameter adjustment neural network can include any suitable numbers of any suitable types of layers (e.g., input layer, one or more hidden layers, output layer, any of which can be convolutional layers, dense layers, long short-term memory (LSTM) layers, transformer layers, non-linearity layers, pooling layers, batch normalization layers, or padding layers). As another example, the parameter adjustment neural network can include any suitable numbers of neurons in various layers (e.g., different layers can have the same or different numbers of neurons as each other). As yet another example, the parameter adjustment neural network can include any suitable activation functions (e.g., softmax, sigmoid, hyperbolic tangent, rectified linear unit) in various neurons (e.g., different neurons can have the same or different activation functions as each other). As still another example, the parameter adjustment neural network can include any suitable interneuron connections or interlayer connections (e.g., forward connections, skip connections, recurrent connections).

Regardless of its specific internal architecture, the parameter adjustment neural network can be configured as an actor that can adjust any of the configurable operating parameters of the mass analyzer in response to any given mass analyzer state. That is, the parameter adjustment neural network can be configured to receive as input a mass analyzer state and to produce as output a mass analyzer parameter adjustment based on that inputted mass analyzer state.

In various aspects, the target parameter adjustment neural network can have the same deep learning internal architecture as the parameter adjustment neural network. However, the learnable or trainable internal weights (e.g., weight matrices, bias values, convolutional kernels) of the target parameter adjustment neural network can lag those of the parameter adjustment neural network.

In various aspects, the parameter valuation neural network can exhibit any suitable deep learning internal architecture. For example, the parameter valuation neural network can include any suitable numbers of any suitable types of layers (e.g., input layer, one or more hidden layers, output layer, any of which can be convolutional layers, dense layers, LSTM layers, transformer layers, non-linearity layers, pooling layers, batch normalization layers, or padding layers). As another example, the parameter valuation neural network can include any suitable numbers of neurons in various layers (e.g., different layers can have the same or different numbers of neurons as each other). As yet another example, the parameter valuation neural network can include any suitable activation functions (e.g., softmax, sigmoid, hyperbolic tangent, rectified linear unit) in various neurons (e.g., different neurons can have the same or different activation functions as each other). As still another example, the parameter valuation neural network can include any suitable interneuron connections or interlayer connections (e.g., forward connections, skip connections, recurrent connections).

Regardless of its specific internal architecture, the parameter valuation neural network can be configured as a critic that can determine how valuable (in terms of calibration effectiveness) any given mass analyzer parameter adjustment would be if it were applied to a given mass analyzer state. That is, the parameter valuation neural network can be configured to receive as input a mass analyzer state and a mass analyzer parameter adjustment and to produce as output a valuation (which is distinct from a reward) based on that inputted mass analyzer state and inputted mass analyzer parameter adjustment.

In various aspects, the target parameter valuation neural network can have the same deep learning internal architecture as the parameter valuation neural network. However, the learnable or trainable internal weights of the target parameter valuation neural network can lag those of the parameter valuation neural network.

In some instances, the prioritized experience replay buffer can be populated by iteratively or repetitively executing the parameter adjustment neural network, no matter how much or how little training the parameter adjustment neural network has so far experienced (e.g., such executions can be performed, even if the learnable or trainable internal weights of the parameter adjustment neural network still have their randomly-initialized values).

As a non-limiting example, consider whatever mass analyzer state that the mass analyzer has or exhibits at the moment when it is desired to begin training of the set of reinforcement learning neural networks. In various aspects, the training component can execute the parameter adjustment neural network on that initial mass analyzer state, and such execution can cause the parameter adjustment neural network to predict or infer a mass analyzer parameter adjustment. More specifically, the training component can feed or route that initial mass analyzer state to the input layer of the parameter adjustment neural network, that initial mass analyzer state can complete a forward pass through the one or more hidden layers of the parameter adjustment neural network, and the output layer of the parameter adjustment neural network can compute or otherwise calculate the mass analyzer parameter adjustment, based on activation maps or feature maps provided by the one or more hidden layers of the parameter adjustment neural network. In various instances, the training component can compute a resultant mass analyzer state, by applying the predicted or inferred mass analyzer parameter adjustment to the mass analyzer (e.g., by increasing or decreasing the voltage or timing parameters of the mass analyzer in whatever ways are specified by the predicted or inferred mass analyzer parameter adjustment; and by evaluating, after implementing such adjustment, the new values of whatever performance metrics of the mass analyzer are included in or make up its state information). Furthermore, in various cases, the training component can compute a reward, via any suitable reward function that is fixed or intransient and that takes as input arguments the initial mass analyzer state, the predicted or inferred mass analyzer parameter adjustment, or the resultant mass analyzer state. Note that the reward function can involve any suitable mathematical operators that can be applied to whatever performance metrics make up the state information of the mass analyzer (e.g., can be any suitable linear or non-linear combination of any suitable number of performance metrics). In any case, the initial mass analyzer state, the predicted or inferred mass analyzer parameter adjustment, the resultant mass analyzer state, and the reward can collectively be considered as a newly-created or newly-generated experience tuple. In various aspects, that experience tuple can be assigned a priority having a default value (e.g., a value of 1), and both the priority and the experience tuple can be stored in the prioritized experience replay buffer. Such procedure can be repeated for any suitable number of times, so as to populate the prioritized experience replay buffer with any suitable or desired number of experience tuples.

Note that, before the parameter adjustment neural network has undergone any training, populating the prioritized experience replay buffer via execution of the parameter adjustment neural network can be considered as random exploration of the state-action space associated with calibrating the mass analyzer (e.g., the parameter adjustment neural network will not yet know how to accurately predict which mass analyzer parameter adjustments are most likely to cause the mass analyzer to approach a calibrated state). To help reduce the amount of such random exploration, the prioritized experience replay buffer can be initially populated (e.g., can be pre-populated) based on manual calibrations that have been previously performed on the mass analyzer (or on any other instantiations or copies of the mass analyzer). For example, consider whatever production logs that are maintained by a manufacturer or supplier of the mass analyzer. Such production logs usually or often record past manual calibrations in terms of “adjustment made” and “state achieved”. In some cases, such production logs can thus be considered as conveying an adjustment-state trajectory that begins from whatever default state information is known or deemed to be exhibited by the mass analyzer (e.g., the production log can indicate that performing adjustment 1 on an initial or beginning default state led to state 1, that performing adjustment 2 on state 1 led to state 2, and that performing adjustment 3 on state 2 led to state 3). In various aspects, an experience tuple can be generated based on any given pair of states in such trajectory (e.g., whatever cumulative mass analyzer parameter adjustments occurred between such given pair of states can be collectively considered as a singular or unified mass analyzer parameter adjustment that led from one of such given pair of states to the other of such given pair of states; and application of the reward function can yield a reward for such mass analyzer parameter adjustment). Such experience tuple generation can be performed any suitable number of times in any suitable directions (e.g., a respective experience tuple can be generated going from: state 1 to state 2; state 2 to state 3; state 1 to state 3; state 3 to state 1; state 3 to state 2; or state 2 to state 1). In other words, each permutation of state pairs chosen from the state-adjustment trajectory can yield a respective experience tuple. As above, each generated experience tuple can be assigned a priority having any suitable default value (e.g., a priority of 1).

In any case, once the prioritized experience replay buffer is populated with at least some experiences (e.g., obtained by execution of the parameter adjustment neural network, or derived from production logs), the training component can incrementally update the learnable or trainable internal weights of each of the set of reinforcement learning neural networks.

As a non-limiting example, consider any given experience tuple from the prioritized experience replay buffer. Such experience tuple can correspond to a particular priority and can include: a particular mass analyzer state; a particular mass analyzer parameter adjustment; a particular reward; and a particular resultant mass analyzer state.

In various aspects, the training component can execute the parameter valuation neural network on the particular mass analyzer state and the particular mass analyzer parameter adjustment (e.g., the particular mass analyzer state and the particular mass analyzer parameter adjustment can be concatenated together and can complete a forward pass through whatever layers make up the parameter valuation neural network), thereby yielding a first output.

In various instances, the training component can execute the target parameter adjustment neural network on the particular resultant mass analyzer state, thereby yielding a second output.

In various cases, the training component can execute the target parameter valuation neural network on both the particular resultant mass analyzer state and the second output, thereby yielding a third output.

In various aspects, the training component can compute, via any suitable error or objective function, a valuation loss based on the first output, the third output, the particular reward, and the particular priority (or a weight arising from the particular priority).

Moreover, the training component can execute the parameter adjustment neural network on the particular mass analyzer state, thereby yielding a fourth output.

In various instances, the training component can execute the parameter valuation neural network on the particular mass analyzer state and the fourth output, thereby yielding a fifth output.

In various cases, the training component can compute, via any suitable error or objective function, an adjustment loss based on the fifth output.

In various aspects, the training component can backpropagate the valuation loss through the parameter valuation neural network, thereby incrementally changing its learnable or trainable internal weights so as to become better at predicting valuations (again, these are distinct from rewards). In various instances, the training component can then incrementally update the learnable or trainable internal weights of the target parameter valuation neural network, by applying Polyak averaging based on whatever update was just made to the parameter valuation neural network.

Likewise, in various cases, the training component can backpropagate the adjustment loss through the parameter adjustment neural network, thereby incrementally changing its learnable or trainable internal weights so as to become better at predicting mass analyzer parameter adjustments. In various instances, the training component can then incrementally update the learnable or trainable internal weights of the target parameter adjustment neural network, by applying Polyak averaging based on whatever update was just made to the parameter adjustment neural network.

In some cases, the training component can update (e.g., increase or decrease) the particular priority of the experience tuple, based on a temporal difference (TD) error derived from the first through fifth outputs.

The training component can repeat this execution-and-update procedure any suitable number of times (e.g., for each experience tuple in the prioritized experience replay buffer). In some aspects, new experience tuples can be added to the prioritized experience replay buffer, by executing the parameter adjustment neural network on any suitable newly obtained or newly defined mass analyzer states (e.g., on whatever mass analyzer states the mass analyzer achieves or exhibits at various points in time), after its learnable or trainable internal parameters have been incrementally updated.

In any case, the ultimate effect of the herein-described training can be that the parameter adjustment neural network learns how to reliably predict mass analyzer adjustments that cause any inputted mass analyzer states to approach or get closer to a true or proper calibrated state.

In various embodiments, the calibration component of the computerized tool can, after such training, electronically deploy the parameter adjustment neural network, so as to calibrate the mass analyzer. In particular, the calibration component can electronically extract, read, or otherwise access a present-time mass analyzer state of the mass analyzer. In some instances, this can involve instructing the mass analyzer to perform one or more scans or partial scans on any suitable samples, specimens, or calibrants. In any case, the calibration component can electronically execute the parameter adjustment neural network on the present-time mass analyzer state, and such execution can yield a certain parameter adjustment. In various aspects, the certain parameter adjustment can be considered as representing whatever absolute or relative changes to electrode voltages or timing parameters of the mass analyzer that the parameter adjustment neural network believes would cause the mass analyzer to become calibrated or to otherwise get closer to being calibrated.

In various embodiments, the execution component of the computerized tool can electronically implement or apply the certain parameter adjustment to the mass analyzer, thereby causing the mass analyzer to actually approach calibration. In other words, the execution component can actually increase or decrease whatever values are currently or presently assigned to the configurable operating parameters of the mass analyzer in whatever ways are specified by the certain mass analyzer parameter adjustment.

In some cases, the calibration component and the execution component can repeat their above-described actions for any suitable number of times, iterations, or cycles. In other cases, the calibration component and the execution component can perform their above-described actions merely once. In any of such situations, the mass analyzer can be considered as now being calibrated. Note that such calibration can be accomplished without sacrificing or ignoring various performance metrics (e.g., the reward function that the training component utilizes can be configured or defined to take as input arguments as many performance metrics as desired). Additionally, note that, because the parameter adjustment neural network can have a post-training execution time of mere seconds, such calibration of the mass analyzer can consume on the order of seconds (e.g., in situations where the parameter adjustment neural network is executed just once by the calibration component) or minutes (e.g., in situations where the parameter adjustment neural network is executed multiple times by the calibration component). Contrast this with existing techniques which either need to purposefully ignore various performance metrics or consume hours upon hours each time a calibration is desired.

Various embodiments described herein can be employed to use hardware or software to solve problems that are highly technical in nature (e.g., to facilitate mass analyzer calibration via reinforcement learning), that are not abstract and that cannot be performed as a set of mental acts by a human. Further, some of the processes performed can be performed by a specialized computer (e.g., mass spectrometers coupled to liquid, gas, or ion chromatographs; artificial neural networks made up of convolutional kernels or LSTM weight matrices) for carrying out defined acts related to the field of mass analyzer calibration.

For example, such defined acts can include: predicting, by a device operatively coupled to a processor and via execution of one or more reinforcement learning neural networks on present-time state data of a mass analyzer of a scientific instrument, what adjustments to one or more operational parameters of the mass analyzer would cause the mass analyzer to approach a calibrated state, wherein the one or more operational parameters include an electrode voltage of the mass analyzer or a timing control of the mass analyzer; and modifying, by the device, the one or more operational parameters based on the adjustments, thereby causing the mass analyzer to approach the calibrated state. In some aspects, such defined tasks can include: training, by the device, the one or more reinforcement learning neural networks. In various instances, the one or more reinforcement learning neural networks can include: a parameter adjustment neural network that can: receive, as input, state data of the mass analyzer; and produce, as output, parameter adjustments based on such inputted state data; a target parameter adjustment neural network whose internal weights lag those of the parameter adjustment neural network; a parameter valuation neural network that can: receive, as input, the state data and the parameter adjustments; and produce, as output, a scalar that represents a valuation of the parameter adjustments; and a target parameter valuation neural network whose internal weights lag those of the parameter valuation neural network. In various cases, the training can utilize a prioritized experience replay buffer having pre-populated tuples, where each pre-populated tuple can include a respective state, one or more respective parameter adjustments, a respective reward, and a respective resultant state, and where the pre-populated tuples can be derived from one or more prior calibrations of the mass analyzer. In various aspects, the present-time state data can contain: one or more first scalars associated with an isotope ratio fidelity of the mass analyzer; one or more second scalars associated with an extent of mass error dispersion due to space charge of the mass analyzer; one or more third scalars associated with a transmission of the mass analyzer; and one or more fourth scalars associated with a resilience to coalescence due to space charge of the mass analyzer.

Such defined acts are inherently computerized. Indeed, a scientific instrument, such as a mass spectrometer coupled to a chromatograph, is a highly-technical computerized device comprising specific computerized hardware (e.g., temperature sensors, pressure sensors, voltage sensors, ion beam emitters, electron beam emitters, focusing lenses, ion detectors, electron detectors, beam apertures, fluid valves). A scientific instrument, the operations that it performs, and the electronic data that it captures cannot be implemented by the human mind, or by a human with mere pen and paper, in any reasonable or practicable way without computers. Furthermore, a mass analyzer is a specific, tangible constituent piece of hardware in various scientific instruments that separates, arranges, orders, measures, or otherwise distinguishes ions according to mass-to-charge ratio. A mass analyzer and the ion-distinguishing functionality that it performs cannot be implemented in any way whatsoever by the human mind or by a human with mere pen and paper. Further still, artificial neural networks are inherently computerized constructs comprising specific software-oriented architectures (e.g., input layers, hidden layers, or output layers, any of which can be made up of trainable or non-trainable internal weights such as convolutional kernels or LSTM weight matrices). Artificial neural networks cannot be trained or executed by the human mind, or by humans with mere pen and paper, in any reasonable or practicable way without computers.

Moreover, various embodiments described herein can integrate into a practical application various teachings relating to the field of mass analyzer calibration. As explained above, in order for a mass analyzer to properly, accurately, or correctly distinguish ions according to mass-to-charge ratio, the mass analyzer must first be calibrated. Some existing techniques facilitate such calibration by applying gradient descent, gradient ascent, or Bayesian filtering to one or two performance metrics of the mass analyzer. Such existing techniques cannot feasibly or reliably be applied to more performance metrics simultaneously due to intractability from combinatorial explosion. Since the performance of the mass analyzer can be measured by very many different metrics, such existing techniques can be considered as being severely restricted in scope (e.g., as completely ignoring large swaths of performance metrics). Other existing techniques facilitate such calibration by applying evolutionary algorithms to the mass analyzer. Such other existing techniques do not suffer from severely restricted scope (e.g., can take into account any suitable number of performance metrics). However, such other existing techniques are massively time-consuming (e.g., can require several hours each time calibration of a mass analyzer is called for). Such excessive consumption of time is caused by the fact that evolutionary algorithms start from scratch for each calibration (e.g., such evolutionary algorithms begin with all possible combinations of operating parameter values and whittle them down via repetitive fitness-selection-mutation-elimination cycles). Accordingly, existing techniques for facilitating mass analyzer calibration can be considered as suffering from various technical problems.

Various embodiments described herein can help to ameliorate one or more of these technical problems. In particular, various embodiments described herein can leverage reinforcement learning so as to reduce an amount of time required for mass analyzer calibration without having to ignore large numbers of mass analyzer performance metrics. Specifically, various embodiments described herein can leverage a prioritized experience replay buffer to train a first neural network to predict which electrode voltage adjustments or ion timing adjustments would cause a given mass analyzer state to become or otherwise get closer to a true calibrated state. That first neural network can be accompanied by: a second neural network that has the same architecture as, but that lags, the first neural network; a third neural network that is configured to predict how valuable given electrode voltage adjustments or ion timing adjustments are with respect to given mass analyzer states; and a fourth neural network that has the same architecture as, but that lags, the third neural network. In such situations, the mass analyzer can be considered as a reinforcement learning environment; the electrode voltages, ion timing parameters, and any desired performance metrics (e.g., isotope fidelity, mass error dispersion, ion transmission) can be collectively considered as forming or defining the state-space of the reinforcement learning environment; the first neural network can be considered as a reinforcement learning actor that can interact with the reinforcement learning environment; increases or decreases to electrode voltages or ion timing parameters of the mass analyzer can be considered as reinforcement learning actions that can be performed on the reinforcement learning environment; the third neural network can be considered as a critic that can help to boost the learning rate of the reinforcement learning actor; and the second and fourth neural networks can be considered as semi-stationary targets that also help to boost the learning rate or convergence likelihood of the reinforcement learning actor. By implementing this setup, the first neural network can learn how to reliably or accurately infer what electrode voltage changes or ion timing parameter changes would cause a mass analyzer to become (or get closer to becoming) calibrated. After being trained, the first neural network can have an execution time on the order of mere seconds. Thus, after the first neural network is trained as described herein, it can cause calibrate any suitable number of mass analyzers in mere seconds each (e.g., in embodiments where a single inferencing or post-training execution of the first neural network is implemented for each mass analyzer that is to be calibrated) or at most mere minutes each (e.g., in embodiments in which multiple inferencing or post-training executions of the first neural network are implemented for each mass analyzer that is to be calibrated). Additionally, the herein-described embodiments do not suffer from intractability or combinatorial explosion when large numbers of different performance metrics are considered simultaneously (e.g., when large numbers of different performance metrics are included in the state-space of the mass analyzer). Contrast this with existing techniques that either consume hours upon hours of calibration time or are limited to considering only one or two performance metrics.

Furthermore, it must be emphasized how clever and counterintuitive various embodiments described herein are. Indeed, various embodiments described herein can be considered as a highly unusual, strange, or unexpected application or utilization of reinforcement learning. After all, reinforcement learning is an artificial intelligence technique that conventional wisdom teaches should be used for the automation of continuously or continually ongoing tasks that require prompt or time-sensitive reactions or adaptations to dynamic, ever-evolving, or uncertain external conditions (e.g., for enabling an autonomous vehicle to immediately react to ever-evolving or uncertain traffic or weather occurrences; for enabling a financial services platform to swiftly react to ever-evolving or uncertain economic profits or losses; for enabling an automated medical device to quickly react to ever-evolving or uncertain patient vital signs). Prior to the herein-described embodiments devised by the present inventor, mass analyzer calibration was never interpreted, treated, or in any way considered as a continuously or continually ongoing task that required quick reaction or adaptation to dynamic, ever-evolving, or uncertain external conditions. To the contrary, conventional wisdom instead taught that mass analyzer calibration is a deterministic task that involves mapping the parameter space of a mass analyzer to a single, static, optimized configuration. Thus, prior to the herein-described teachings, mass analyzer calibration was never even entertained as a possible or appropriate use-case for reinforcement learning (e.g., prior to the herein-described teachings, it would not have been clear at all what specific things in a mass analyzer calibration context would constitute or qualify as reinforcement learning actions or as the ever-evolving or uncertain external conditions to which such reinforcement learning actions respond or adapt). In other words, the herein-described teachings can be considered as a paradigm shift in the field of mass analyzer calibration. In still other words, by devising the herein-described embodiments, the present inventor came up with a highly unusual, clever, counter-intuitive, or strange use of reinforcement learning that contravenes conventional wisdom (e.g., conventional wisdom teaches against viewing mass analyzer calibration as a sequence or series of parameter adjustment decisions made under uncertainty).

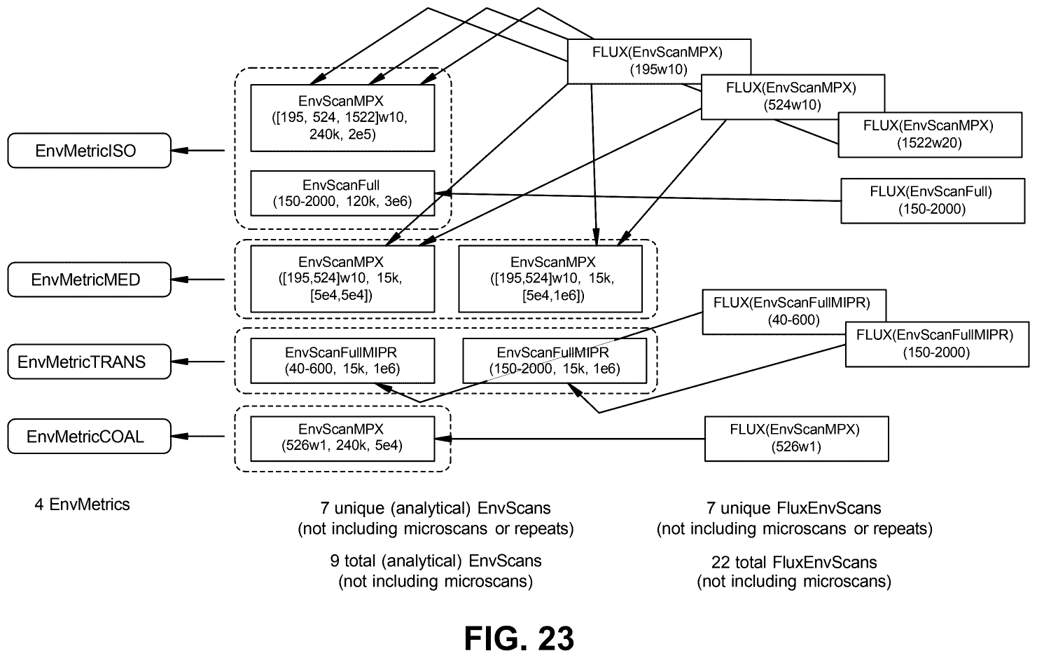

Further still, even if someone were to hypothetically consider applying reinforcement learning to mass analyzer calibration prior to the herein-described teachings, they would be swiftly dissuaded due to the immense non-triviality involved in actually facilitating such application. Indeed, in order to identify the performance metrics that a mass analyzer exhibits in any given mass analyzer state, the mass analyzer has to perform one or more scans. That is, the mass analyzer has to capture or measure one or more spectra. Acquiring the amount of information sufficient to form a single mass analyzer state can require the measurement or capture of thousands of spectra or sets of averaged spectra, which can collectively take upwards of ten to fifteen minutes. That is, it can take ten to fifteen minutes to obtain a single mass analyzer state. In order to obtain satisfactory prediction accuracy, reinforcement learning generally warrants execution on hundreds, thousands, or even millions of states. If each state requires ten to fifteen minutes to obtain, spending such time obtaining hundreds, thousands, or millions of states is indisputably impractical. In other words, state generation would be considered as an immense bottleneck that would prevent people from attempting to perform mass analyzer calibration via reinforcement learning. But, as described herein, particularly with respect to FIGS. 23-28, the present inventor devised various ways around such immense bottleneck. Specifically, rather than obtaining performance metrics of a mass analyzer state by capturing thousands of spectra, the present inventor realized that a very small number of scans (e.g., the seven EnvScans shown in FIG. 23) can be performed and enriched by a commensurately small number of partial or truncated scans (e.g., the seven scans denoted as FLUX in the figures). In particular, each partial scan can be considered as reducing the need for costly injection time determination processes in one or more respective ones of the small number of non-partial or non-truncated scans. In other words, rather than deriving the performance metrics from thousands upon thousands of directly measured spectra, the performance metrics can instead be inferred or predicted from the results of the above-mentioned small number of non-partial spectra and partial spectra via any suitable mathematical mapping functions (e.g., such functions might be extrapolations or interpolations; such functions might be linear regression models; such functions might be artificial intelligence models). Indeed, by implementing the partial scans described with respect to FIGS. 23-28, the present inventor was able to reduce the amount of time consumed in generating a single mass analyzer state from ten or fifteen minutes down to about four seconds. This innovative realization by the present inventor allows reinforcement learning to be implemented without suffering from the impracticality that would strongly dissuade others from even attempting to apply reinforcement learning to mass analyzer calibration.

For at least the above reasons, various embodiments described herein can be considered as addressing or ameliorating various technical problems or disadvantages that plague existing techniques. Therefore, various embodiments described herein can be considered as a concrete and tangible technical improvement in the field of mass analyzer calibration. Accordingly, various embodiments described herein certainly qualify as useful and practical applications of computers.

Furthermore, various embodiments described herein can control real-world tangible devices based on the disclosed teachings. For example, various embodiments described herein can electronically activate, deactivate, or otherwise actuate real-world hardware (e.g., electrodes) of real-world mass analyzers (e.g., Orbitrap™).

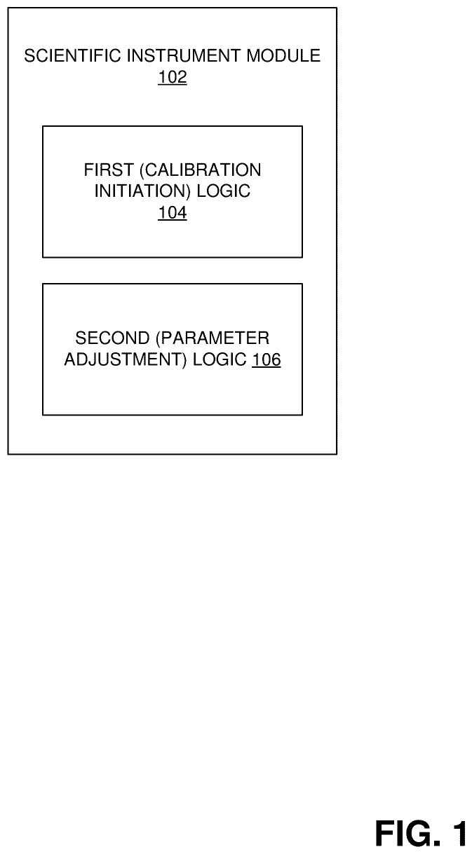

FIG. 1 illustrates an example, non-limiting block diagram of a scientific instrument module 102 in accordance with various embodiments described herein.

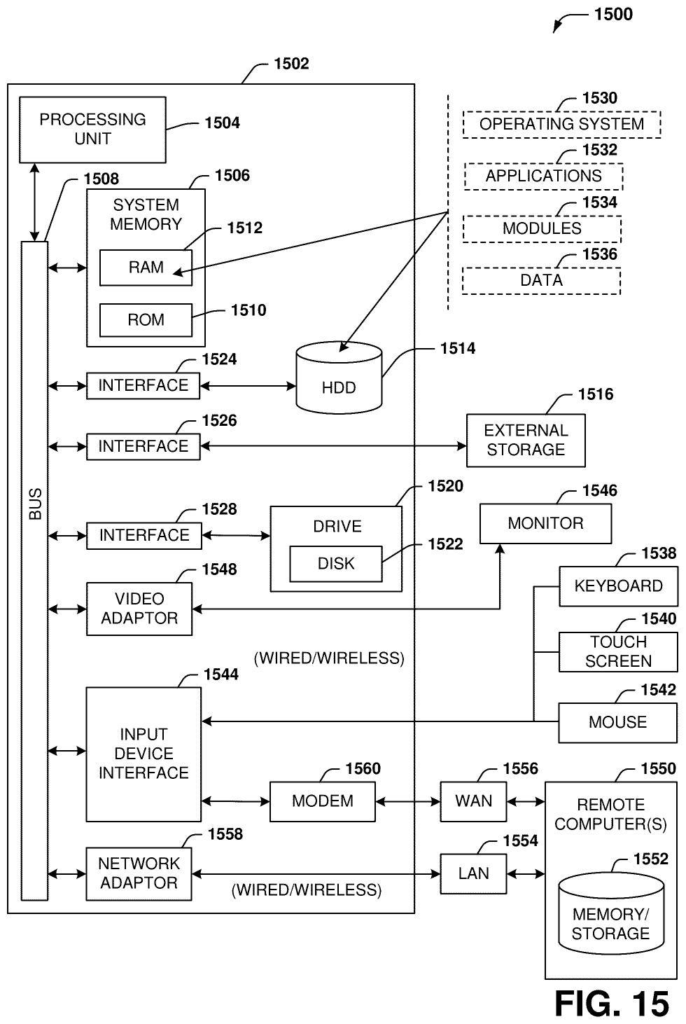

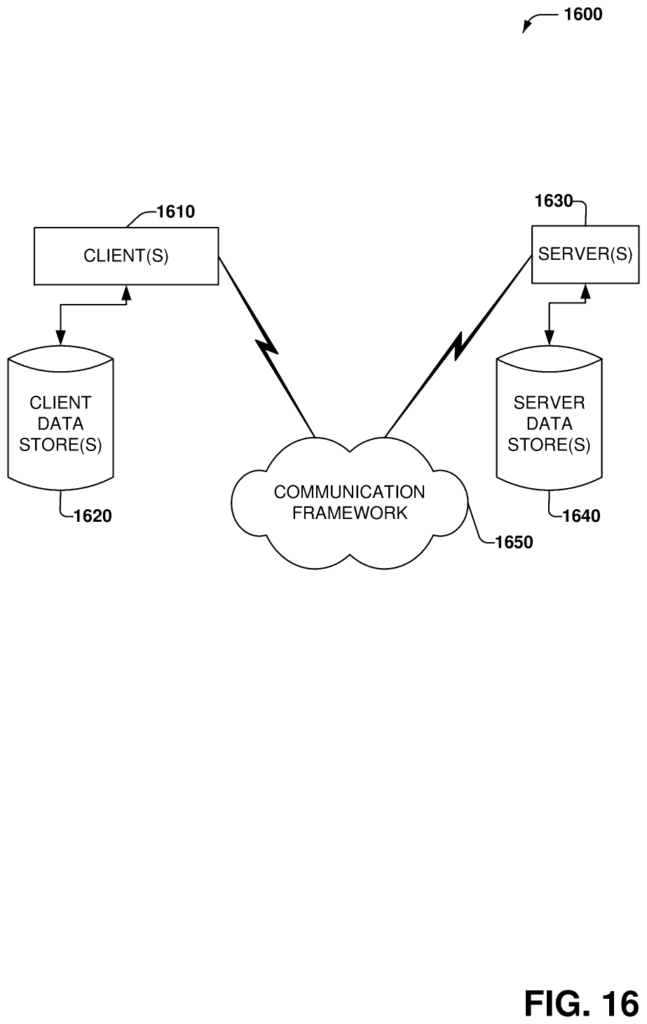

In various embodiments, the scientific instrument module 102 can be implemented by circuitry (e.g., including electrical or optical components), such as a programmed computing device. Logic of the scientific instrument module 102 can be included in a single computing device or can be distributed across multiple computing devices that are in communication with each other as appropriate. Examples of computing devices that may, singly or in combination, implement the scientific instrument module 102 are discussed herein with reference to FIG. 15, and examples of systems or networks of interconnected computing devices, in which the scientific instrument module 102 may be implemented across one or more of the computing devices, are discussed herein with reference to FIG. 16.

The scientific instrument module 102 can include first logic 104 and second logic 106. As used herein, the term “logic” can include an apparatus that is to perform a set of operations associated with the logic. For example, any of the logic elements included in the scientific instrument module 102 can be implemented by one or more computing devices programmed with instructions to cause one or more processing devices of the computing devices to perform the associated set of operations. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” can refer to a collection of one or more logic elements that, together, perform a function associated with the module. Different ones of the logic elements in a module may take the same form or may take different forms. For example, some logic in a module may be implemented by a programmed general-purpose processing device, while other logic in a module may be implemented by an application-specific integrated circuit (ASIC). In another example, different ones of the logic elements in a module may be associated with different sets of instructions executed by one or more processing devices. A module can omit one or more of the logic elements depicted in the associated drawings; for example, a module may include a subset of the logic elements depicted in the associated drawings when that module is to perform a subset of the operations discussed herein with reference to that module.

In various embodiments, there can be a scientific instrument corresponding to the scientific instrument module 102. In various aspects, the scientific instrument can be any suitable computerized device that can electronically measure some scientifically-relevant, clinically-relevant, or research-relevant characteristic, property, or attribute of an analytical specimen (e.g., of a known or unknown mixture, compound, or collection of matter). As a non-limiting example, a scientific instrument can be a scanning electron microscope. In such case, the scientific instrument can measure or determine a surface topography of the analytical specimen. As another non-limiting example, a scientific instrument can be a transmission electron microscope. In such case, the scientific instrument can measure or determine internal structural details of the analytical specimen. As yet another non-limiting example, a scientific instrument can be an electron energy-loss microscope. In such case, the scientific instrument can measure or determine location-wise counts or intensities across a range of defined energy-loss bins or bands for the analytical specimen. As a more general non-limiting example, a scientific instrument can be any suitable type of charged-particle microscope (e.g., some types of microscopes can use beams of non-electron ions to capture images or energy spectra or to otherwise interact with specimens). As another non-limiting example, a scientific instrument can be a mass spectrometer that is operatively coupled to a chromatograph. In such case, the scientific instrument can measure or determine chromatograms (e.g., relative compound abundance as a function of retention time) or ion spectra (e.g., relative ion abundance as a function of mass-to-charge ratio) of the analytical sample. In any of such situations, the scientific instrument can include or otherwise contain a mass analyzer.

In various embodiments, the first logic 104 can involve predicting, by a device operatively coupled to a processor and via execution of one or more reinforcement learning neural networks on present-time state data of the mass analyzer, what adjustments to one or more operational parameters (e.g., electrode voltages, ion injection duration, ion trapping duration) of the mass analyzer would cause the mass analyzer to approach a calibrated state.

In various embodiments, the second logic 106 can involve modifying, by the device, the one or more operational parameters based on the adjustments, thereby causing the mass analyzer to approach the calibrated state.

Accordingly, the scientific instrument module 102 can facilitate mass analyzer calibration via reinforcement learning.

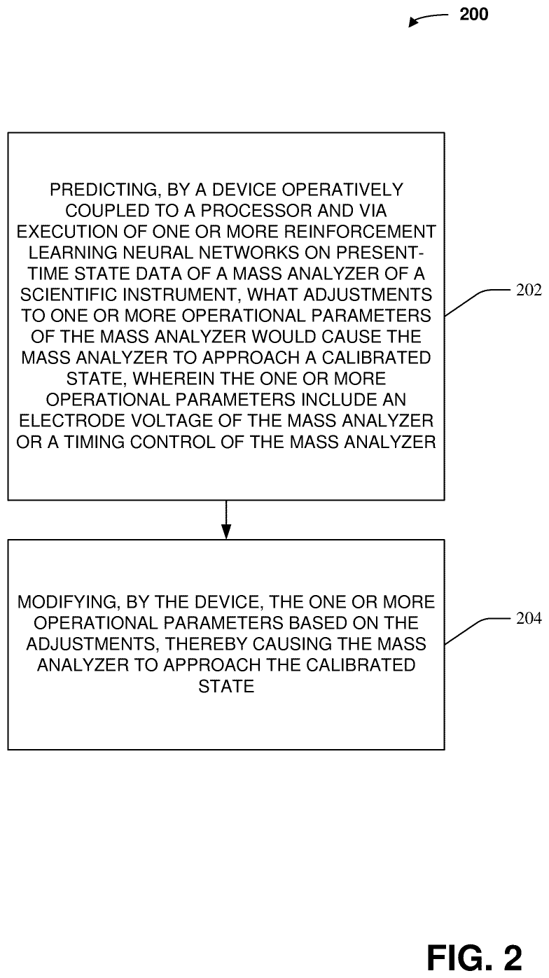

FIG. 2 is an example, non-limiting flow diagram of a computer-implemented method 200 in accordance with various embodiments described herein. The operations of the computer-implemented method 200 may be used in any suitable context to perform any suitable operations (e.g., can be performed by or used in conjunction with any of the various modules, computing devices, or graphical user interfaces described with respect to of FIGS. 1, 15, and 16). Operations are illustrated once each and in a particular order in FIG. 2, but the operations may be reordered or repeated as desired and appropriate (e.g., different operations performed may be performed in parallel, as suitable).

In various aspects, act 202 can include performing first operations predicting, by a device operatively coupled to a processor and via execution of one or more reinforcement learning neural networks on present-time state data of a mass analyzer of a scientific instrument, what adjustments to one or more operational parameters of the mass analyzer would cause the mass analyzer to approach a calibrated state, wherein the one or more operational parameters include an electrode voltage of the mass analyzer or a timing control of the mass analyzer. In various cases, the first logic 104 can perform or otherwise facilitate act 202.

In various aspects, act 204 can include performing second operations modifying, by the device, the one or more operational parameters based on the adjustments, thereby causing the mass analyzer to approach the calibrated state. In various instances, the second logic 106 can perform or otherwise facilitate act 204.

Accordingly, the computer-implemented method 200 can facilitate mass analyzer calibration via reinforcement learning.

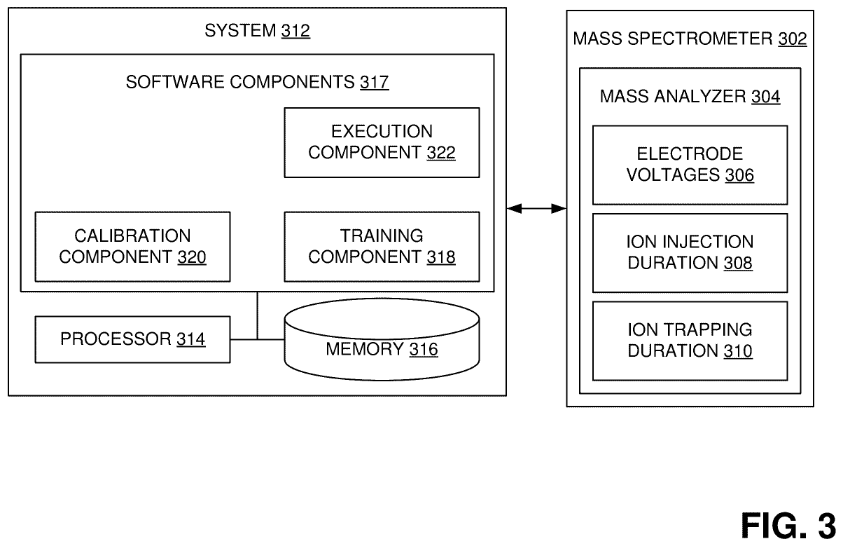

FIG. 3 illustrates a block diagram of an example, non-limiting system that can facilitate mass analyzer calibration via reinforcement learning in accordance with one or more embodiments described herein.

In various embodiments, there can be a mass spectrometer 302. In various aspects, the mass spectrometer 302 can be any suitable type of mass spectrometer exhibiting any suitable design or construction for measuring ion spectra of analytical samples. In various instances, the mass spectrometer 302 can be made up of any suitable constituent hardware. As a non-limiting example, the mass spectrometer 302 can include any suitable ion source or ion beam emitter, such as a matrix assisted laser desorption/ionization (MALDI) source, electrospray ionization (ESI) source, atmospheric pressure chemical ionization (APCI) source, atmospheric pressure photoionization (APPI) source, or inductively coupled plasma (ICP) source. As another non-limiting example, the mass spectrometer 302 can include any suitable ion detectors, such as electron multiplier detectors, microchannel plate detectors, image charge detectors, or Faraday cup detectors. As even another non-limiting example, the mass spectrometer 302 can include any suitable ion optics equipment, such as ion focusing lenses, ion guides, or ion deflectors.

In various cases, one of the pieces of constituent hardware that make up the mass spectrometer 302 can be a mass analyzer 304. In various aspects, the mass analyzer 304 can exhibit any suitable design or construction that can physically separate (or, in some instances, otherwise distinguish without physically separating) ions according to their mass-to-charge ratios. As a non-limiting example, the mass analyzer 304 can be any suitable type of quadrupole filter mass analyzer. As another non-limiting example, the mass analyzer 304 can be any suitable type of time-of-flight mass analyzer. As yet another non-limiting example, the mass analyzer 304 can be any suitable type of orbital trapping mass analyzer. As still another non-limiting example, the mass analyzer 304 can be any suitable type of Fourier transform ion cyclotron resonance mass analyzer. As even another non-limiting example, the mass analyzer 304 can be any suitable type of magnetic sector mass analyzer.

No matter its particular design or construction, the mass analyzer 304 can be considered as having any suitable number of any suitable types of configurable operating parameters. In various aspects, a configurable operating parameter can be any suitable hardware-related characteristic or software-related characteristic of the mass analyzer 304 that can guide, affect, or otherwise dictate how the mass analyzer 304 physically separates or otherwise distinguishes ions according to mass-to-charge ratio and that can be selectively controlled, changed, adjusted, or otherwise set (e.g., by a user of the mass spectrometer 302 or automatically).

In some cases, such configurable operating parameters can include one or more electrode voltages 306 of the mass analyzer 304. Indeed, the mass analyzer 304 can have or be made up of one or more electrodes. As a non-limiting example, a quadrupole mass analyzer can have four rod electrodes arranged in parallel pairs which, when driven by applied voltages, create an electric field that filters passing ions according to mass-to-charge ratio. As another non-limiting example, a quadrupole ion trap or linear ion trap mass analyzer can have an ion trap that is sandwiched between various endcap electrodes and whose central portion is circumscribed by a ring electrode, and driving such electrodes with applied voltages can create an oscillating electric field that can trap and selectively eject ions based on mass-to-charge ratio. As yet another non-limiting example, a time-of-flight mass analyzer can have repeller electrodes that divert ions from an ion source toward a flight tube, accelerator electrodes that speed up the ions in the flight tube, and drift electrodes that help steer the paths of the ions within the flight tube, where the amount of time it takes for a given ion to traverse the flight tube indicates mass-to-charge ratio. As still another non-limiting example, an orbital trapping mass analyzer can have a spindle electrode surrounded by split outer electrodes, such that driving those electrodes via applied voltages causes ions to orbit the spindle electrode, and such that the orbital characteristics (e.g., period) of a given ion indicates its mass-to-charge ratio. In any case, the mass analyzer 304 can have one or more electrodes, and the configurable, controllable, or selectable voltages of those one or more electrodes can be referred to as the one or more electrode voltages 306. In various instances, each of the one or more electrode voltages 306 can be a scalar measured in any suitable units of voltage (e.g., volts, kilovolts, millivolts).

In some cases, the configurable operating parameters of the mass analyzer 304 can include an ion injection duration 308. In various aspects, the ion injection duration 308 can be a configurable, controllable, or selectable amount of time during which the mass analyzer 304 permits ions emitted from an ion source of the mass spectrometer 302 to enter the mass analyzer 304. The longer the ion injection duration 308 is, the more ions that are permitted to enter the mass analyzer 304 during any suitable scan, which can help to increase signal-to-noise ratios of any resulting mass spectra. In various instances, the ion injection duration 308 can be a scalar measured in any suitable units of time (e.g., seconds, milliseconds, microseconds).

In some cases, the configurable operating parameters of the mass analyzer 304 can include an ion trapping duration 310. In various aspects, the ion trapping duration 310 can be a configurable, controllable, or selectable amount of time during which the mass analyzer 304 traps or confines ions to any suitable defined subregion of the mass analyzer 304 (e.g., trapped in a volume bounded by endcap and ring electrodes; trapped in a volume surrounding a spindle electrode and bounded by split outer electrodes). In some cases, the longer the ion trapping duration 310 is, the higher the sensitivity of the mass analyzer 304, but the greater the likelihood of resolution reduction or inter-ion reactions. But in other cases (e.g., for orbital trapping mass analyzers), the longer the ion trapping duration 310, the higher the resolution (assuming adequately low pressure). In various instances, the ion trapping duration 310 can be a scalar measured in any suitable units of time (e.g., seconds, milliseconds, microseconds).

It should be understood or otherwise appreciated that the mass analyzer 304 can have any other suitable types of configurable operating parameters. The one or more electrode voltages 306, the ion injection duration 308, and the ion trapping duration 310 are mere non-limiting examples. For instance, any other suitable type of timing control can be considered as a configurable operating parameter of the mass analyzer 304, such as a time between ion ejections, or such as respective ramping times for the one or more electrode voltages 306.

In any case, the mass analyzer 304 can currently or presently be uncalibrated. In other words, whatever specific values are currently or presently assigned to the one or more electrode voltages 306, to the ion injection duration 308, or the ion trapping duration 310 can cause the mass analyzer 304 to not properly or reliably separate or distinguish ions according to mass-to-charge ratio. Thus, it can be desired to calibrate the mass analyzer 304. In various instances, a system 312 can facilitate such calibration as described herein.

In various aspects, the system 312 can comprise a processor 314 (e.g., computer processing unit, microprocessor) and a non-transitory computer-readable memory 316 that is operably or operatively or communicatively connected or coupled to the processor 314. The non-transitory computer-readable memory 316 can store computer-executable instructions which, upon execution by the processor 314, can cause the processor 314 or other components of the system 312 (e.g., training component 318, calibration component 320, execution component 322) to perform one or more acts. In various embodiments, the non-transitory computer-readable memory 316 can store computer-executable components (e.g., training component 318, calibration component 320, execution component 322), and the processor 314 can execute the computer-executable components.

In various embodiments, the system 312 can electronically access the mass spectrometer 302 and thus the mass analyzer 304. That is, the system 312 can electronically communicate or otherwise electronically interact with (e.g., transmit electronic instructions or commands to, receive electronic data from) the mass spectrometer 302 in any suitable fashion. Accordingly, any suitable components of the system 312 can interact with, communicate with, activate, deactivate, or otherwise manipulate the mass spectrometer 302 or the mass analyzer 304. Note that the system 312 can, in some cases, be implemented on or hosted by the mass spectrometer 302 itself or any suitable computerized workstation that is associated with or coupled to the mass spectrometer 302. In such situations, the system 312 can be considered as being deployed in a client-side fashion (e.g., the system 312 can be considered as being local to the mass spectrometer 302). However, in other cases, the system 312 can instead be implemented or hosted remotely from the mass spectrometer 302, such as in a cloud computing environment. In such situations, the system 312 can be considered as being deployed in a server-side fashion.

In various embodiments, the system 312 can include a training component 318. In various aspects, the training component 318 can, as described herein, train a neural network in reinforcement learning fashion to determine what voltage or timing adjustments would cause any given mass analyzer state to transition closer to a calibrated state.

In various embodiments, the system 312 can include a calibration component 320. In various instances, the calibration component 320 can, as described herein, leverage the trained neural network so as to determine what adjustments to make to the one or more electrode voltages 306, the ion injection duration 308, or the ion trapping duration 310 to cause the mass analyzer 304 to become calibrated.

In various embodiments, the system 312 can include an execution component 322. In various cases, the execution component 322 can, as described herein, actually adjust the one or more electrode voltages 306, the ion injection duration 308, or the ion trapping duration 310 according to the determination of the calibration component 320, thereby actually causing the mass analyzer 304 to get closer to a calibrated state.

Note that, in various instances, the training component 318, the calibration component 320, and the execution component 322 can collectively be considered as being one or more software components 317 of the system 312. In various aspects, it should be appreciated that the one or more software components 317 are described primarily herein as comprising three components (e.g., the training component 318, the calibration component 320, and the execution component 322) for ease of explanation and illustration. However, the one or more software components 317 are not limited to being implemented as exactly such three components in every embodiment. Indeed, in some embodiments, the functionalities described herein of such three components can be combined in any suitable fashions, so as to be implemented in or by fewer than three components (e.g., in some cases, a single component can perform all of the functionalities that are described herein with respect to the training component 318, the calibration component 320, and the execution component 322). In other embodiments, the functionalities described herein of such three components can instead be distributed, separated, split, or fragmented in any suitable fashions, so as to be implemented in or by more than three components (e.g., two or more components can facilitate the functionalities that are performable by the training component 318; two or more components can facilitate the functionalities that are performable by the calibration component 320; two or more components can facilitate the functionalities that are performable by the execution component 322).

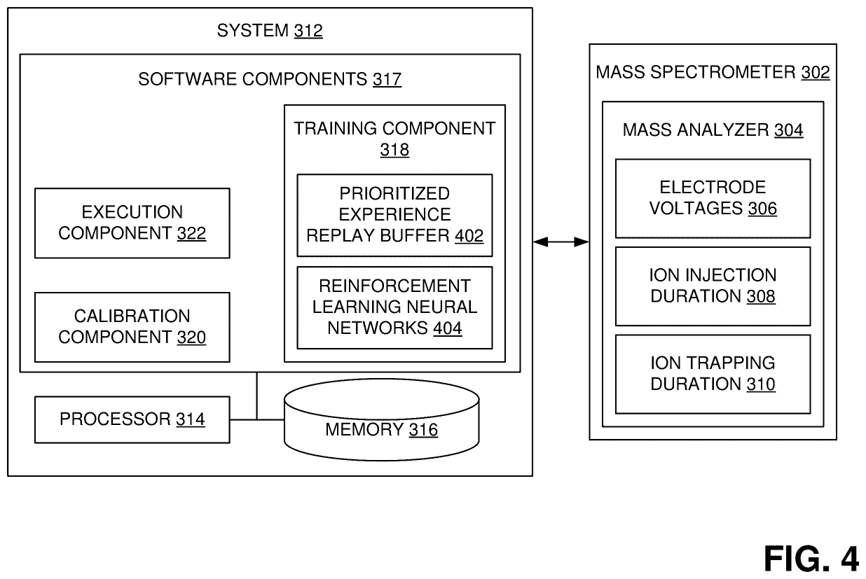

FIG. 4 illustrates a block diagram of an example, non-limiting system including a prioritized experience replay buffer and a set of reinforcement learning neural networks that can facilitate mass analyzer calibration via reinforcement learning in accordance with one or more embodiments described herein.

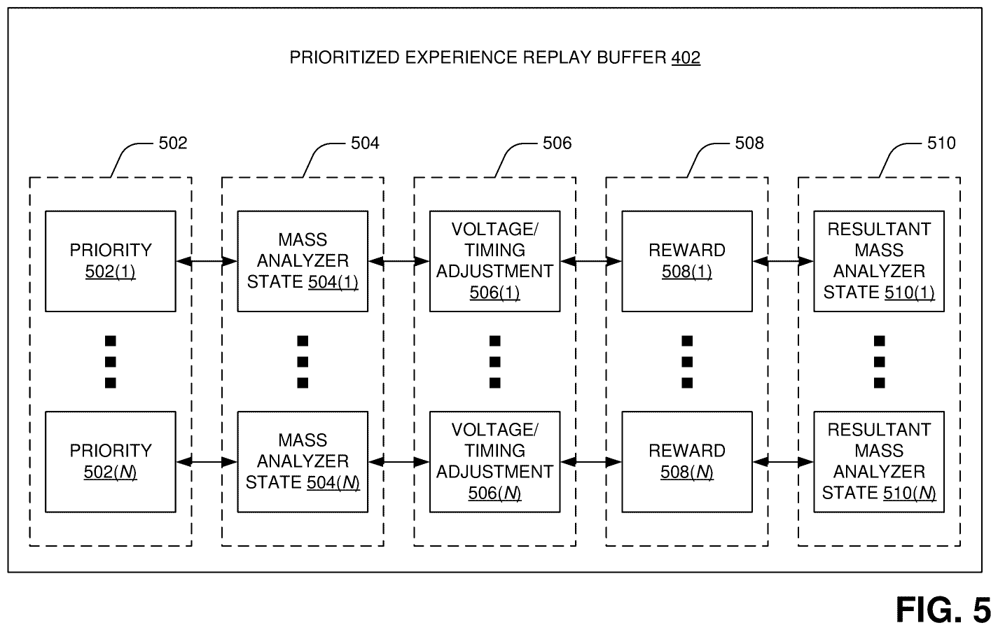

In various embodiments, the training component 318 can electronically store, electronically maintain, electronically control, or otherwise electronically access a prioritized experience replay buffer 402 (hereafter “PER buffer 402”) and a set of one or more reinforcement learning neural networks 404. In various aspects, the training component 318 can train the set of reinforcement learning neural networks 404 to calibrate the mass analyzer 304, by leveraging the PER buffer 402. Various non-limiting details are described with respect to FIGS. 5-12.

FIG. 5 illustrates an example, non-limiting block diagram of the PER buffer 402 in accordance with one or more embodiments described herein.

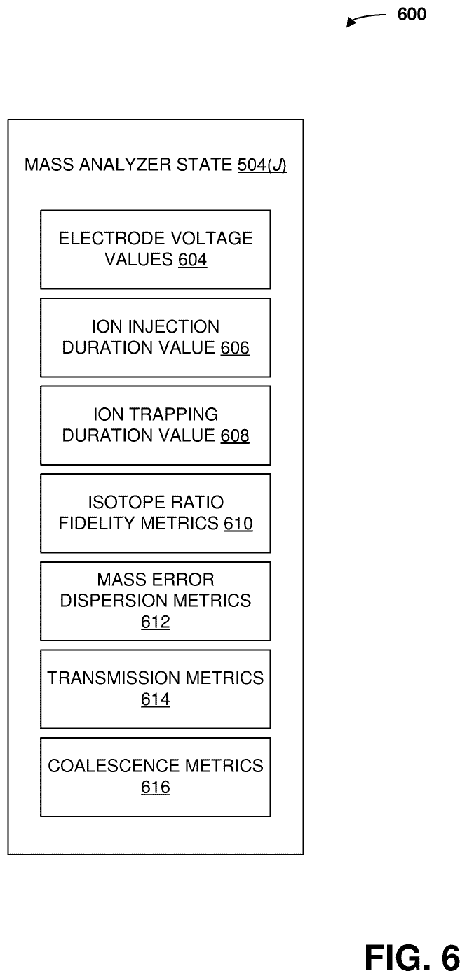

In various embodiments, the PER buffer 402 can include a plurality of mass analyzer states 504. In various aspects, the plurality of mass analyzer states 504 can have a total of n states for any suitable positive integer n>1: a mass analyzer state 504(1) to a mass analyzer state 504(n). In various instances, each of the plurality of mass analyzer states 504 can be any suitable electronic data exhibiting any suitable format, size, or dimensionality (e.g., can be one or more scalars, one or more vectors, one or more matrices, one or more tensors, one or more character strings, or any suitable combination thereof) that indicates, conveys, or otherwise represents an operational status or snap-shot that the mass analyzer 304 could potentially or possibly have. Various non-limiting details are described with respect to FIG. 6

FIG. 6 illustrates an example, non-limiting block diagram of a mass analyzer state 504(j) in accordance with one or more embodiments described herein. In various embodiments, the mass analyzer state 504(j) can be a j-th one of the plurality of mass analyzer states 504, for any suitable positive integer 1≤j≤n. Thus, the mass analyzer state 504(j) can be considered as a j-th possible or potential operational scenario that the mass analyzer 304 can occupy.

In various aspects, the mass analyzer state 504(j) can include or otherwise specify whatever particular values are assigned to the configurable operating parameters of the mass analyzer 304 in the j-th possible or potential operational scenario. As a non-limiting example, the mass analyzer state 504(j) can include one or more electrode voltage values 604, which can respectively indicate the specific voltage values that are assigned to the one or more electrode voltages 306 in the j-th possible or potential operational scenario. As another non-limiting example, the mass analyzer state 504(j) can include an ion injection duration value 606, which can indicate the specific amount, span, or interval of time that is assigned to the ion injection duration 308 in the j-th possible or potential operational scenario. As even another non-limiting example, the mass analyzer state 504(j) can include an ion trapping duration value 608, which can indicate the specific amount, span, or interval of time that is assigned to the ion trapping duration 310 in the j-th possible or potential operational scenario.

In various instances, for any suitable combination of performance metrics associated with the mass analyzer 304, the mass analyzer state 504(j) can include or otherwise specify the specific values of those performance metrics that the mass analyzer 304 exhibits or otherwise has in the j-th possible or potential operational scenario.

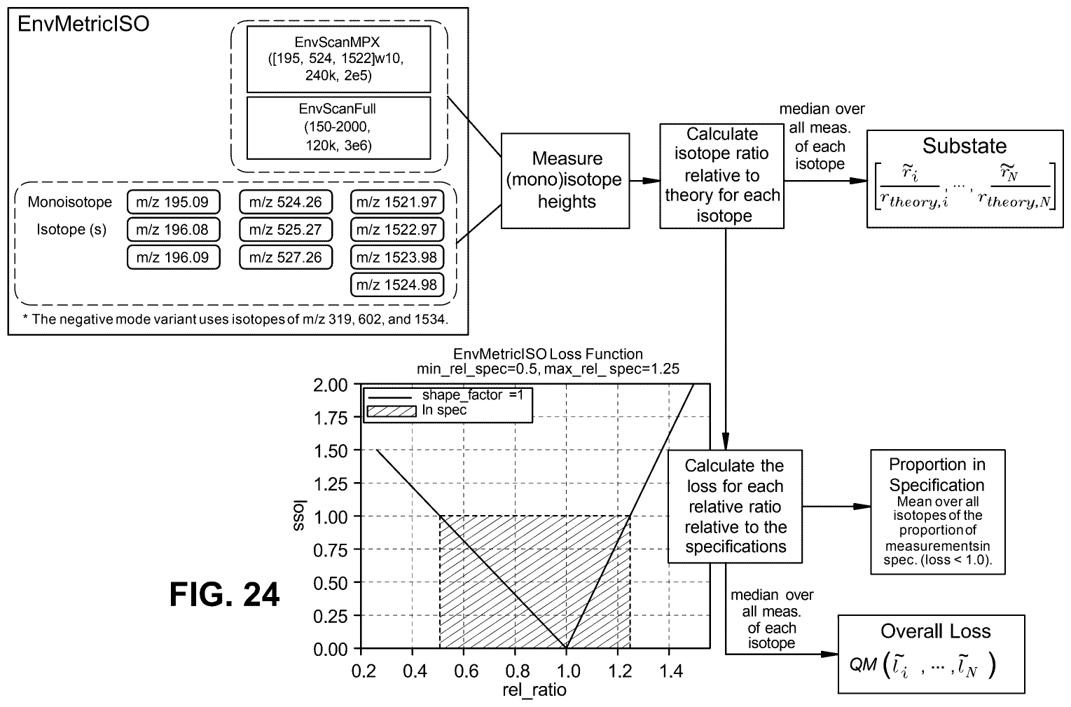

As a non-limiting example, such performance metrics can include one or more isotope ratio fidelity metrics 610. In various aspects, the one or more isotope ratio fidelity metrics 610 can be one or more scalars, one or more vectors, one or more matrices, one or more tensors, or any suitable combination thereof that indicate, pertain to, or are otherwise based on an isotope ratio fidelity exhibited by the mass analyzer 304 in the j-th possible or potential operational scenario. Specifically, when the mass analyzer 304 is in the j-th possible or potential operational scenario, the mass spectrometer 302 can be instructed to perform one or more scans on one or more calibrant samples, and the one or more isotope ratio fidelity metrics 610 can be mathematically derived from the results captured or measured by those scans. Additional explanation regarding how the one or more isotope ratio fidelity metrics 610 can be obtained or derived is described with respect to FIG. 24 using mathematical notation that one of ordinary skill would be able to interpret.

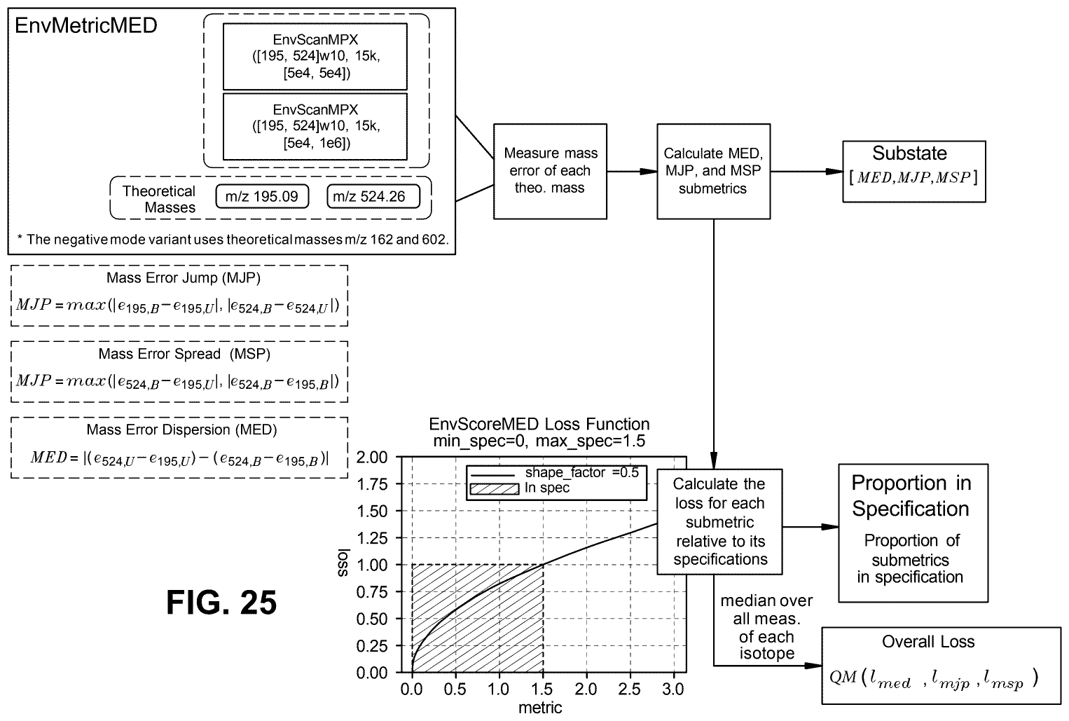

As another non-limiting example, such performance metrics can include one or more mass error dispersion metrics 612. In various aspects, the one or more mass error dispersion metrics 612 can be one or more scalars, one or more vectors, one or more matrices, one or more tensors, or any suitable combination thereof that indicate, pertain to, or are otherwise based on mass error dispersion due to space charge that is exhibited by the mass analyzer 304 in the j-th possible or potential operational scenario. As above, when the mass analyzer 304 is in the j-th possible or potential operational scenario, the mass spectrometer 302 can be instructed to perform one or more scans on one or more calibrant samples, and the one or more mass error dispersion metrics 612 can be mathematically derived from the results captured or measured by those scans. Additional explanation regarding how the one or more mass error dispersion metrics 612 can be obtained or derived is described with respect to FIG. 25 using mathematical notation that one of ordinary skill would be able to interpret.

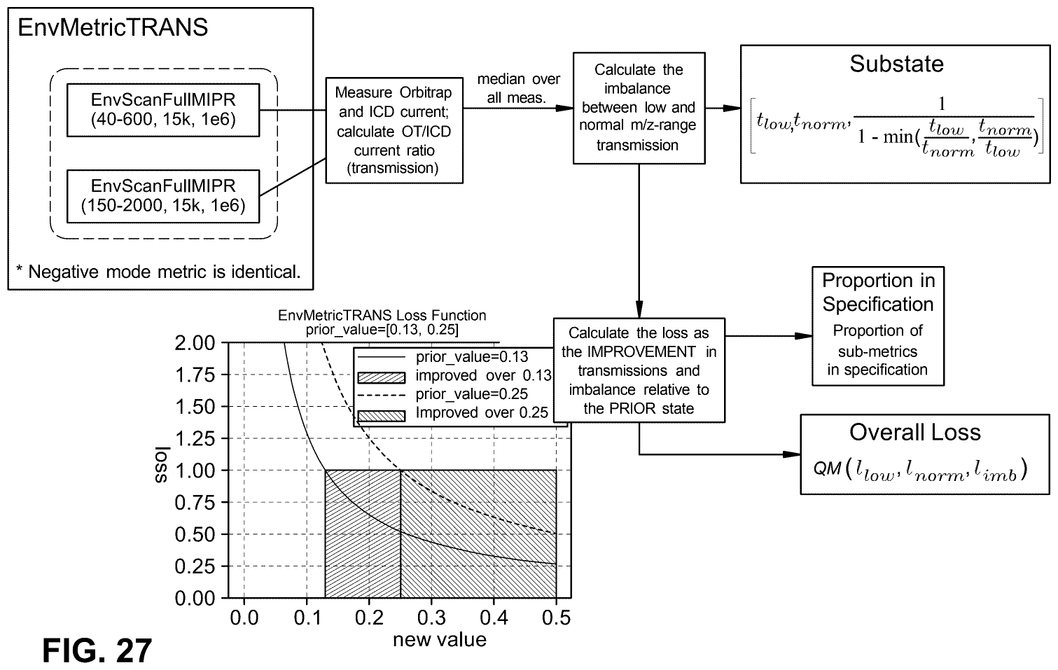

As still another non-limiting example, such performance metrics can include one or more transmission metrics 614. In various aspects, the one or more transmission metrics 614 can be one or more scalars, one or more vectors, one or more matrices, one or more tensors, or any suitable combination thereof that indicate, pertain to, or are otherwise based on ion transmission efficiency or efficacy that is exhibited by the mass analyzer 304 in the j-th possible or potential operational scenario. As above, when the mass analyzer 304 is in the j-th possible or potential operational scenario, the mass spectrometer 302 can be instructed to perform one or more scans on one or more calibrant samples, and the one or more transmission metrics 614 can be mathematically derived from the results captured or measured by those scans. Additional explanation regarding how the one or more transmission metrics 614 can be obtained or derived are described with respect to FIG. 27 using mathematical notation that one of ordinary skill would be able to interpret.

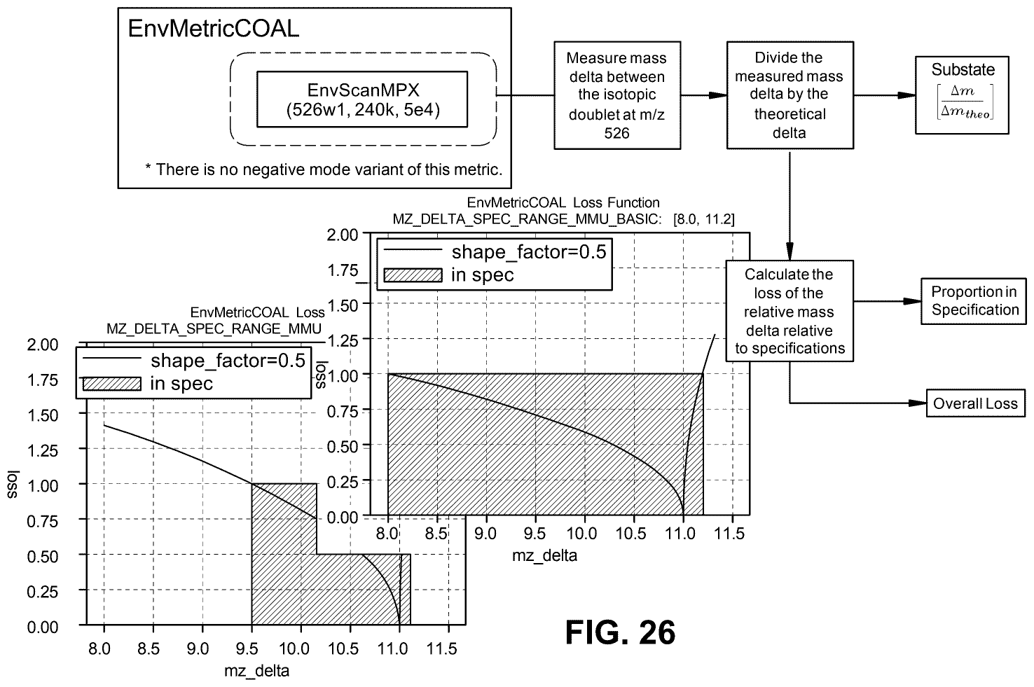

As still another non-limiting example, such performance metrics can include one or more coalescence metrics 616. In various aspects, the one or more coalescence metrics 616 can be one or more scalars, one or more vectors, one or more matrices, one or more tensors, or any suitable combination thereof that indicate, pertain to, or are otherwise based on resilience to coalescence due to space charge that is exhibited by the mass analyzer 304 in the j-th possible or potential operational scenario. As above, when the mass analyzer 304 is in the j-th possible or potential operational scenario, the mass spectrometer 302 can be instructed to perform one or more scans on one or more calibrant samples, and the one or more coalescence metrics 616 can be mathematically derived from the results captured or measured by those scans. Additional explanation regarding how the one or more coalescence metrics 616 can be obtained or derived is described with respect to FIG. 26 using mathematical notation that one of ordinary skill would be able to interpret.

It should be understood or otherwise appreciated that the particular performance metrics shown in FIG. 6 are mere non-limiting examples. In various embodiments, any other suitable types of performance metrics of the mass analyzer 304 that can be derived from scans that are performable by the mass spectrometer 302 can be included in the state information of the mass analyzer 304.

Referring back to FIG. 5, the PER buffer 402 can include a plurality of voltage/timing adjustments 506. In various aspects, the plurality of voltage/timing adjustments 506 can respectively correspond to the plurality of mass analyzer states 504. Thus, since the plurality of mass analyzer states 504 can have n states, the plurality of voltage/timing adjustments 506 can have n adjustments: a voltage/timing adjustment 506(1) to a voltage/timing adjustment 506(n). In various instances, each of the plurality of voltage/timing adjustments 506 can be any suitable electronic data that indicates, specifies, or otherwise represents particular changes that can be made to the configurable operating parameters of the mass analyzer 304 if the mass analyzer 304 were in whatever possible or potential operational scenario that is indicated by a respective one of the plurality of mass analyzer states 504. As a non-limiting example, the voltage/timing adjustment 506(1) can be one or more scalars, one or more vectors, one or more matrices, or one or more tensors that represent or indicate specific absolute or relative increases or decreases that can be made to the one or more electrode voltages 306, to the ion injection duration 308, or to the ion trapping duration 310, when the one or more electrode voltages 306, the ion injection duration 308, or the ion trapping duration 310 have whatever specific values are specified in the mass analyzer state 504(1). As another non-limiting example, the voltage/timing adjustment 506(n) can be one or more scalars, one or more vectors, one or more matrices, or one or more tensors that represent or indicate specific absolute or relative increases or decreases that can be made to the one or more electrode voltages 306, to the ion injection duration 308, or to the ion trapping duration 310, when the one or more electrode voltages 306, the ion injection duration 308, or the ion trapping duration 310 have whatever specific values are specified in the mass analyzer state 504(n).

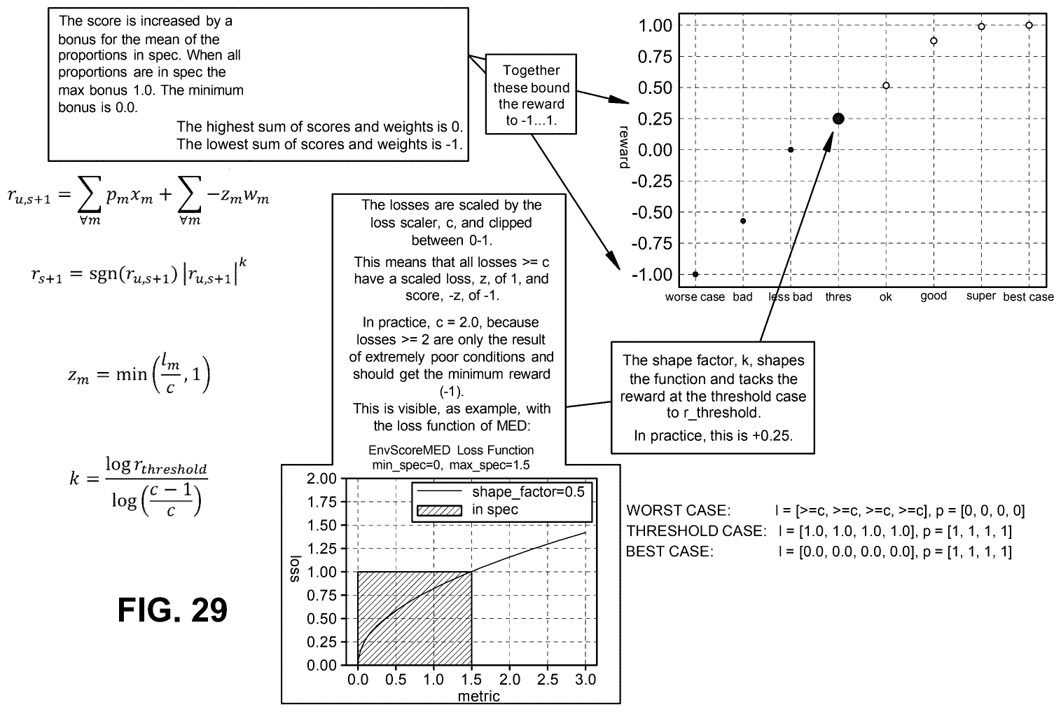

In various aspects, the PER buffer 402 can include a plurality of rewards 508. In various instances, the plurality of rewards 508 can respectively correspond to the plurality of mass analyzer states 504 and to the plurality of voltage/timing adjustments 506. So, the plurality of rewards 508 can have a total of n rewards: a reward 508(1) to a reward 508(n). In various cases, each of the plurality of rewards 508 can be a scalar that indicates how well or how poorly the mass analyzer 304 would be calibrated if a respective one of the plurality of voltage/timing adjustments 506 were applied to a respective one of the plurality of mass analyzer states 504. As a non-limiting example, the reward 508(1) can be a scalar whose magnitude or value indicates how close (e.g., higher magnitudes) or how far (e.g., lower magnitudes) from truly calibrated the mass analyzer 304 would be if the voltage/timing adjustment 506(1) were performed on the mass analyzer 304 when the mass analyzer 304 exhibits the mass analyzer state 504(1). In various cases, the reward 508(1) can be equal to or otherwise based on any suitable mathematical functions or mathematical operators that take as arguments the mass analyzer state 504(1) and the voltage/timing adjustment 506(1). As another non-limiting example, the reward 508(n) can be a scalar whose magnitude or value indicates how close (e.g., higher magnitudes) or how far (e.g., lower magnitudes) from truly calibrated the mass analyzer 304 would be if the voltage/timing adjustment 506(n) were performed on the mass analyzer 304 when the mass analyzer 304 exhibits the mass analyzer state 504(1). As above, the reward 508(n) can be equal to or otherwise based on any suitable mathematical functions or mathematical operators that take as arguments the mass analyzer state 504(n) and the voltage/timing adjustment 506(n). Additional explanation regarding how rewards can be computed when given a mass analyzer state and a voltage/timing adjustment is provided with respect to FIG. 29.

In various embodiments, the PER buffer 402 can include a plurality of resultant mass analyzer states 510. In various aspects, the plurality of resultant mass analyzer states 510 can respectively correspond to the plurality of mass analyzer states 504 and to the plurality of voltage/timing adjustments 506. So, the plurality of resultant mass analyzer states 510 can have a total of n states: a resultant mass analyzer state 510(1) to a resultant mass analyzer state 510(n). In various instances, each of the plurality of resultant mass analyzer states 510 can be any suitable electronic data that is, indicates, or otherwise represents what mass analyzer state would be achieved if a respective one of the plurality of voltage/timing adjustments 506 were performed on the mass analyzer 304 when the mass analyzer 304 exhibits a respective one of the plurality of mass analyzer states 504. As a non-limiting example, the resultant mass analyzer state 510(1) can be whatever state (e.g., whatever electrode voltage values, whatever ion injection timing values, whatever ion trapping duration values, whatever isotope ratio fidelity metrics, whatever mass error dispersion metrics, whatever transmission metrics, whatever coalescence metrics) to which the mass analyzer 304 transitions in response to: the voltage/timing adjustment 506(1) being applied to the mass analyzer 304; when the mass analyzer 304 is the mass analyzer state 504(1). As another non-limiting example, the resultant mass analyzer state 510(n) can be whatever state to which the mass analyzer 304 transitions in response to: the voltage/timing adjustment 506(n) being applied to the mass analyzer 304; when the mass analyzer 304 is the mass analyzer state 504(n).

In various embodiments, the PER buffer 402 can include a set of priorities 502. In various aspects, the set of priorities 502 can respectively correspond to the plurality of mass analyzer states 504, to the plurality of voltage/timing adjustments 506, to the plurality of rewards 508, and to the plurality of resultant mass analyzer states 510. So, the plurality of priorities 502 can have a total of n priorities: a priority 502(1) to a priority 502(n). In various cases, each of the plurality of priorities 502 can be a scalar that indicates how significant or insignificant respective ones of the plurality of the mass analyzer states 504, the plurality of voltage/timing adjustments 506, the plurality of rewards 508, and the plurality of resultant mass analyzer states 510 are with respect to learning how to calibrate the mass analyzer 304. In particular, the plurality of mass analyzer states 504, the plurality of voltage/timing adjustments 506, the plurality of rewards 508, and the plurality of resultant mass analyzer states 510 can be considered as collectively forming or defining a total of n experience tuples, and each of the plurality of priorities 502 can be considered as indicating how important a respective experience tuple is to learning such calibration. As a non-limiting example, the mass analyzer state 504(1), the voltage/timing adjustment 506(1), the reward 508(1), and the resultant mass analyzer state 510(1) can be considered as collectively forming a first experience tuple, and the priority 502(1) can be a scalar whose magnitude or value indicates how important (e.g., higher magnitudes) or unimportant (e.g., lower magnitudes) that first experience tuple is to learning how to calibrate the mass analyzer 304. As another non-limiting example, the mass analyzer state 504(n), the voltage/timing adjustment 506(n), the reward 508(n), and the resultant mass analyzer state 510(n) can be considered as collectively forming an n-th experience tuple, and the priority 502(n) can be a scalar whose magnitude or value indicates how important or unimportant that n-th experience tuple is to learning how to calibrate the mass analyzer 304. In various aspects, all of the plurality of priorities 502 can be initially assigned any suitable default value (e.g., 1), and each of the plurality of priorities 502 can be respectively updated during training, as described later herein.

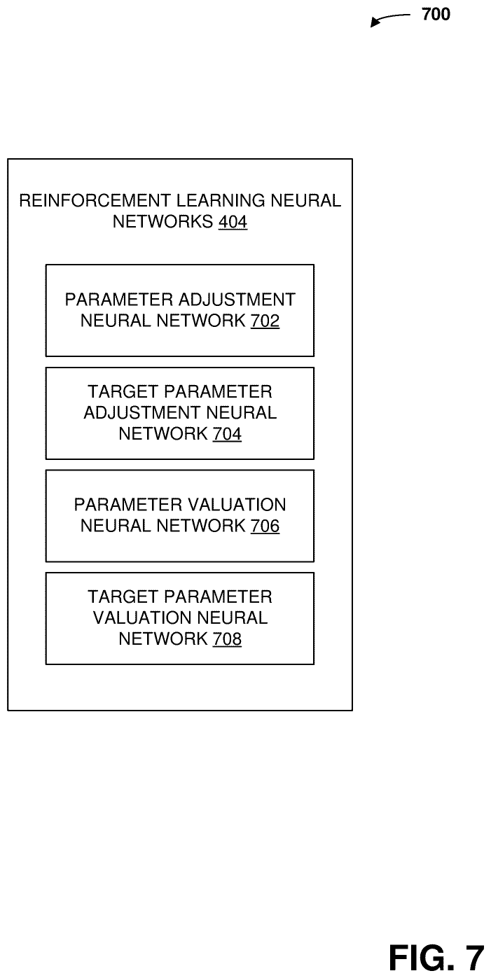

FIG. 7 illustrates an example, non-limiting block diagram showing the set of reinforcement learning neural networks 404 in accordance with one or more embodiments described herein.

In various embodiments, as shown, the set of reinforcement learning neural networks 404 can include a parameter adjustment neural network 702, a target parameter adjustment neural network 704, a parameter valuation neural network 706, and a target parameter valuation neural network 708.

In various aspects, the parameter adjustment neural network 702 can exhibit any suitable deep learning internal architecture. Indeed, in various cases, the parameter adjustment neural network 702 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal weights. For example, any of such input layer, one or more hidden layers, or output layer can be convolutional layers, whose learnable or trainable weights can be convolutional kernels. As another example, any of such input layer, one or more hidden layers, or output layer can be dense layers, whose learnable or trainable weights can be weight matrices or bias values. As still another example, any of such input layer, one or more hidden layers, or output layer can be batch normalization layers, whose learnable or trainable weights can be shift factors or scale factors. As even another example, any of such input layer, one or more hidden layers, or output layer can be LSTM layers, whose learnable or trainable weights can be input-state weight matrices or hidden-state weight matrices. As yet another example, any of such input layer, one or more hidden layers, or output layer can be transformer layers, whose learnable or trainable weights can be single-head or multi-head attention blocks or other weight matrices. Further still, in various cases, any of such layers can be any suitable types of neural network layers having any suitable fixed or non-trainable internal weights. For example, any of such input layer, one or more hidden layers, or output layer can be non-linearity layers, padding layers, pooling layers, or concatenation layers.

Regardless of the specific internal architecture (e.g., the specific numbers, types, or organizations of layers) that is implemented within the parameter adjustment neural network 702, the parameter adjustment neural network 702 can be configured to determine how to adjust the configurable operating parameters of the mass analyzer 304 so as to cause the mass analyzer 304 to become calibrated (or to otherwise approach or get closer to a calibrated state). In other words, the parameter adjustment neural network 702 can be configured to receive as input any given mass analyzer state and to produce as output whatever voltage/timing adjustment that it believes would transition that given mass analyzer state to or toward a calibrated state. In still other words, the parameter adjustment neural network 702 can be considered as a reinforcement learning actor.

In various aspects, the target parameter adjustment neural network 704 can have the same deep learning internal architecture as the parameter adjustment neural network 702. However, the learnable or trainable internal weights of the target parameter adjustment neural network 704 can temporally lag those of the parameter adjustment neural network 702.

In various instances, the parameter valuation neural network 706 can exhibit any suitable deep learning internal architecture. Indeed, in various cases, the parameter valuation neural network 706 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal weights. For example, any of such input layer, one or more hidden layers, or output layer can be convolutional layers, whose learnable or trainable weights can be convolutional kernels. As another example, any of such input layer, one or more hidden layers, or output layer can be dense layers, whose learnable or trainable weights can be weight matrices or bias values. As still another example, any of such input layer, one or more hidden layers, or output layer can be batch normalization layers, whose learnable or trainable weights can be shift factors or scale factors. As even another example, any of such input layer, one or more hidden layers, or output layer can be LSTM layers, whose learnable or trainable weights can be input-state weight matrices or hidden-state weight matrices. As yet another example, any of such input layer, one or more hidden layers, or output layer can be transformer layers, whose learnable or trainable weights can be single-head or multi-head attention blocks or other weight matrices. Further still, in various cases, any of such layers can be any suitable types of neural network layers having any suitable fixed or non-trainable internal weights. For example, any of such input layer, one or more hidden layers, or output layer can be non-linearity layers, padding layers, pooling layers, or concatenation layers.

Regardless of the specific internal architecture that is implemented within the parameter valuation neural network 706, the parameter valuation neural network 706 can be configured to determine how valuable (in terms of approaching calibration) any given voltage/timing adjustment is with respect to any given mass analyzer state. In other words, the parameter valuation neural network 706 can be configured to receive as input the given mass analyzer state and the given voltage/timing adjustment to produce as output a scalar whose magnitude represents how much calibration value (which is not the same as a reinforcement learning reward) that it believes the given voltage/timing adjustment has. In still other words, the parameter valuation neural network 706 can be considered as a reinforcement learning critic.

In various aspects, the target parameter valuation neural network 708 can have the same deep learning internal architecture as the parameter valuation neural network 706. However, the learnable or trainable internal weights of the target parameter valuation neural network 708 can temporally lag those of the parameter valuation neural network 706.

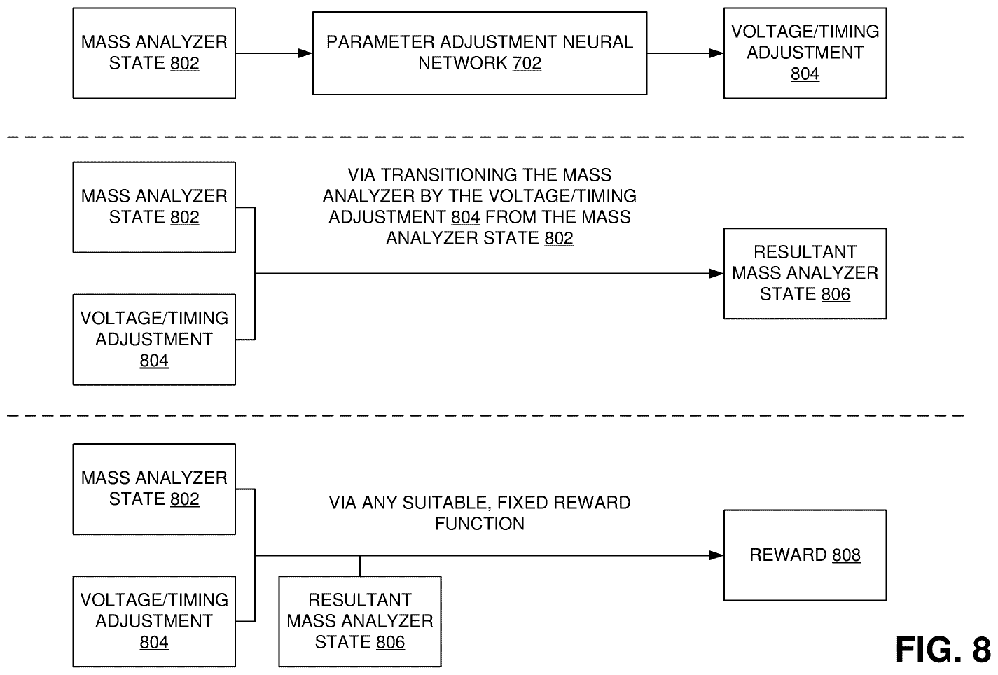

In various embodiments, the training component 318 can electronically initialize in any suitable fashion (e.g., via random initialization) the learnable or trainable internal weights of each of the set of reinforcement learning neural networks 404, and the training component 318 can train the set of reinforcement learning neural networks by using the PER buffer 402. Various non-limiting details are described with respect to FIGS. 8-12.

FIGS. 8-12 illustrate example, non-limiting block diagrams showing how the set of reinforcement learning neural networks 404 can be trained based on the PER buffer 402 in accordance with one or more embodiments described herein.

In order for such training to commence, the PER buffer 402 should first be populated with a non-zero number of experience tuples (e.g., with the information shown in FIG. 5). In various aspects, the training component 318 can facilitate such population via execution of the parameter adjustment neural network 702, regardless of how much or how little training the parameter adjustment neural network 702 has so far undergone. Such execution-based experience generation is shown with respect to FIG. 8.

Consider a mass analyzer state 802. In various aspects, the mass analyzer state 802 can be any mass analyzer state whatsoever. For example, the mass analyzer state 802 can be whatever state (formatted as shown in FIG. 6) that the mass analyzer 304 is in immediately prior to commencement of training of the set of reinforcement learning neural networks 404.

In various instances, the training component 318 can electronically execute the parameter adjustment neural network 702 on the mass analyzer state 802, and such execution can yield a voltage/timing adjustment 804. More specifically, the training component 318 can feed or route the mass analyzer state 802 to the input layer of the parameter adjustment neural network 702. In various cases, the mass analyzer state 802 can complete a forward pass through the one or more hidden layers of the parameter adjustment neural network 702. In various aspects, the output layer of the parameter adjustment neural network 702 can compute or otherwise calculate output data, based on activation maps or feature maps provided by the one or more hidden layers of the parameter adjustment neural network 702.

Note that the format, size, or dimensionality of the output data can be dictated by the number, arrangement, sizes, or other characteristics of the neurons, convolutional kernels, attention blocks, or other internal weights of the output layer (or of any other layers) of the parameter adjustment neural network 702. Accordingly, the output data can be forced to have any desired format, size, or dimensionality, by adding, removing, or otherwise adjusting characteristics of the output layer (or of any other layers) of the parameter adjustment neural network 702. In various aspects, the output data can be considered as whatever absolute or relative adjustments to the one or more electrode voltages 306, to the ion injection duration 308, or to the ion trapping duration 310 which the parameter adjustment neural network 702 infers or predicts would cause the mass analyzer state 802 to transition to or toward a calibrated state. Thus, the output data can be referred to as the voltage/timing adjustment 804. Furthermore, note that, if the parameter adjustment neural network 702 has so far undergone no or little training, then the voltage/timing adjustment 804 can be highly inaccurate.

In various instances, the training component 318 can electronically generate a resultant mass analyzer state 806, based on the mass analyzer state 802 and the voltage/timing adjustment 804. Indeed, as mentioned above, the mass analyzer 304 can already be in or otherwise exhibit the mass analyzer state 802. In various cases, the training component 318 can electronically apply the voltage/timing adjustment 804 to the mass analyzer 304. In other words, the training component 318 can increase, decrease, or otherwise modify the one or more electrode voltages 306, the ion injection duration 308, or the ion trapping duration 310 by whatever absolute or relative amounts are specified in the voltage/timing adjustment 804. After such application, the training component 318 can electronically instruct, command, or otherwise cause the mass spectrometer 302 to perform whatever scans or partial scans from which whatever performance metrics (e.g., 610, 612, 614, 616) that are included in the state-space of the mass analyzer 304 can be derived. In various aspects, the resultant mass analyzer state 806 can thus be any suitable electronic data that indicates: what specific values the configurable operating parameters of the mass analyzer 304 have after application of the voltage/timing adjustment 804; and what specific values the performance metrics of the mass analyzer 304 have after application of the voltage/timing adjustment 804.

In various aspects, the training component 318 can electronically compute a reward 808, based on the mass analyzer state 802, the voltage/timing adjustment 804, or the resultant mass analyzer state 806. As mentioned above, any suitable fixed or non-transient mathematical function can be used to compute such reward (e.g., the reward function shown in FIG. 29).

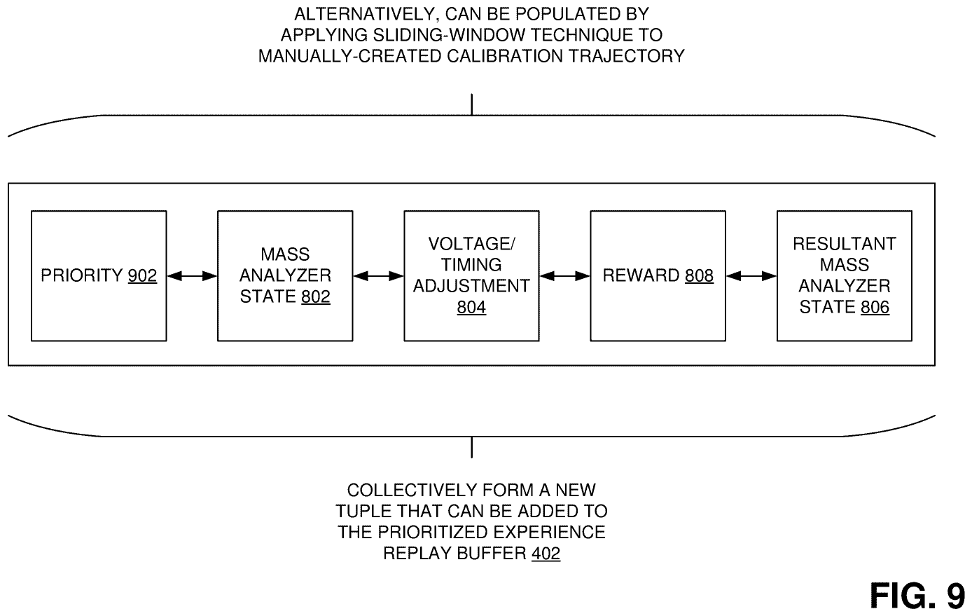

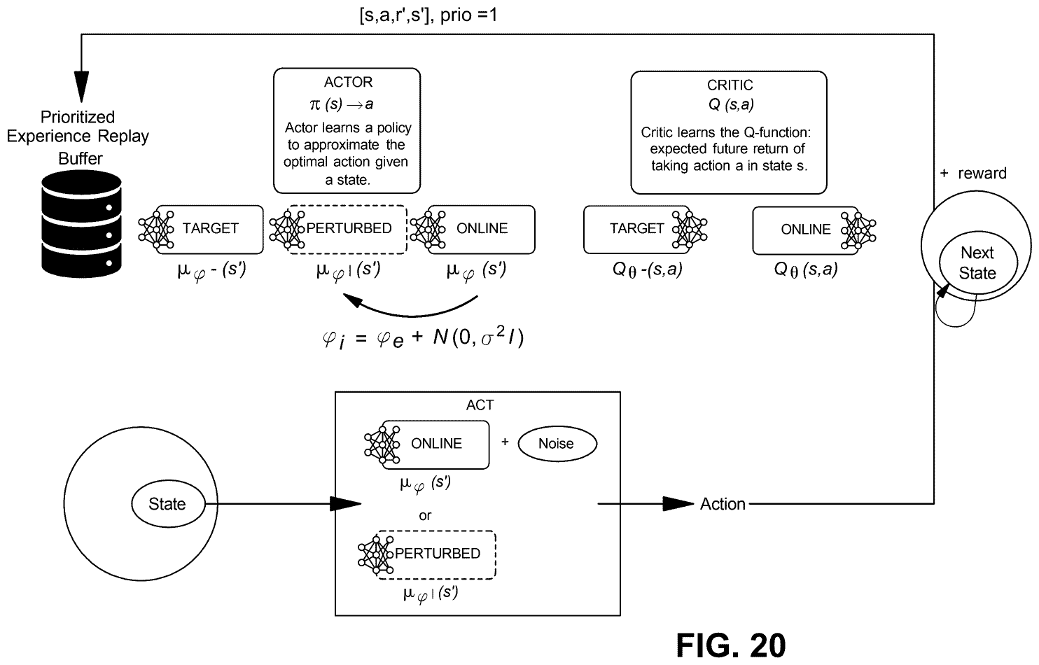

Now, consider FIG. 9. In various embodiments, the mass analyzer state 802, the voltage/timing adjustment 804, the reward 808, and the resultant mass analyzer state 806 can collectively be considered as forming an experience tuple. In various aspects, the training component 318 can assign to that experience tuple a priority 902, which can have any suitable default value (e.g., 1). In various instances, that experience tuple, now tagged with the priority 902, can be added or otherwise inserted into the PER buffer 402 by the training component 318. In various cases, the training component 318 repeat this execution-and-computation procedure for any suitable number of other or different mass analyzer states. In this way, the training component 318 can populate the PER buffer 402 with prioritized experience tuples via execution of the parameter adjustment neural network 702. Various non-limiting details regarding such execution-based population of the PER buffer 402 are described with respect to FIG. 20.

Note that, when the parameter adjustment neural network 702 has not yet received much training, populating the PER buffer 402 via execution of the parameter adjustment neural network 702 can be considered as random exploration of the state-space of the mass analyzer 304. In order to reduce such random exploration or to otherwise reduce the amount of time needed to train the set of reinforcement learning neural networks 404, the training component 318 can, in some cases, pre-populate the PER buffer 402 based on any suitable production logs or records that are associated with the mass analyzer 304.

As a non-limiting example, whatever manufacturer designed or fabricated the mass analyzer 304 can have previously performed manual calibrations on the mass analyzer 304 (or on other instantiations or copies of the mass analyzer 304). Such production logs or records can have tracked the specific voltage/timing adjustments made by technical specialists during such previous manual calibrations and the corresponding mass analyzer states that such adjustments achieved. Thus, in some aspects, those production logs or records can be considered as conveying or representing a state-adjustment trajectory: an alternating sequence of mass analyzer states and the voltage/timing adjustments that respectively achieved those mass analyzer states.

For instance, the state-adjustment trajectory can specify that, when voltage/timing adjustment 1 (which can be denoted as A₁) was performed on mass analyzer state 0 (which can be denoted as S₀), it resulted in mass analyzer state 1 (which can be denoted as S₁). Moreover, the state-adjustment trajectory can specify that, when voltage/timing adjustment 2 (which can be denoted as A₂) was performed on mass analyzer state 1, it resulted in mass analyzer state 2 (which can be denoted as S₂). Furthermore, the state-adjustment trajectory can specify that, when voltage/timing adjustment 3 (which can be denoted as A₃) was performed on mass analyzer state 2, it resulted in mass analyzer state 3 (which can be denoted as S₃). Equivalently, the state-adjustment trajectory can be the following daisy-chained sequence: [S₀, A₁, S₁, A₂, S₂, A₃, S₃].

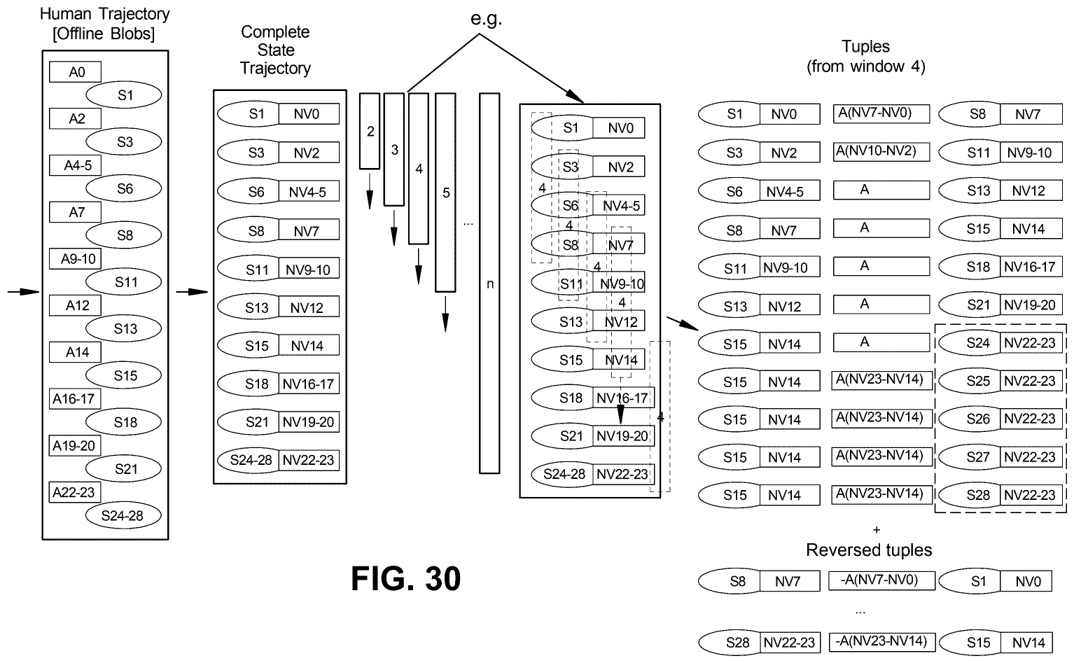

In various aspects, any given pair of states in such state-adjustment trajectory can be considered as defining (in direction-sensitive fashion) a respective experience tuple. For instance, a first experience tuple can be derived from the state pair (S₁, S₂), where: S₁ can be analogous to the mass analyzer state 802; S₂ can be analogous to the resultant mass analyzer state 806; A₂ can be analogous to the voltage/timing adjustment 804; a reward can be computed by feeding S₁, A₂, or S₂ to whatever reward function is being utilized; and where a default priority value can be assigned to such first experience tuple. As another instance, a second experience tuple can be derived from the state pair (S₁, S₃), where: S₁ can be analogous to the mass analyzer state 802; Ss can be analogous to the resultant mass analyzer state 806; A₂+A₃ can be analogous to the voltage/timing adjustment 804; a reward can be computed by feeding S₁, A₂+A₃, or Ss to whatever reward function is being utilized; and where a default priority value can be assigned to such second experience tuple. As yet another instance, a third experience tuple can be derived from the state pair (S₃, S₁), where: S₃ can be analogous to the mass analyzer state 802; S₁ can be analogous to the resultant mass analyzer state 806; −(A₂+A₃) can be analogous to the voltage/timing adjustment 804; a reward can be computed by feeding S₁, −(A₂+A₃), or Ss to whatever reward function is being utilized; and a default priority value can be assigned to such third experience tuple. In some aspects, unique or distinct experience tuples can be obtained from the state-adjustment trajectory by running one or more sliding windows of respective lengths along the state-adjustment trajectory and by selecting whichever mass analyzer states fall on the endpoints of such sliding windows. Various non-limiting aspects of such sliding window technique are described with respect to FIG. 30.

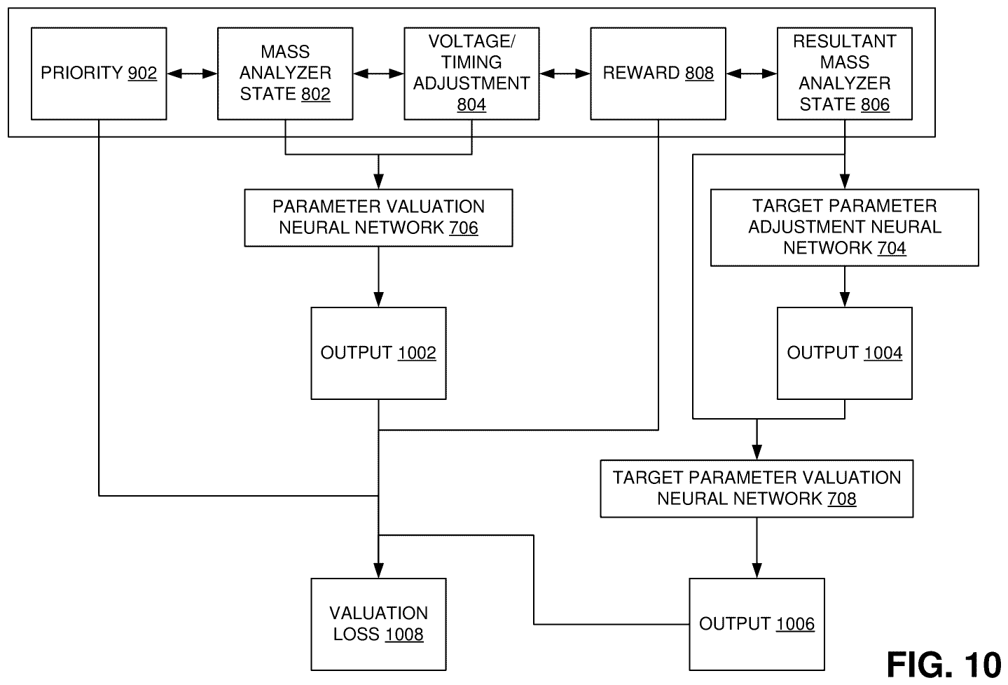

In any case, once the PER buffer 402 is at least partially populated with some experience tuples, the training component 318 can commence training of the set of reinforcement learning neural networks 404. How such training can proceed with respect to one experience tuple is shown in FIGS. 10-12. Specifically, FIGS. 10-12 show how such training can proceed using the experience tuple collectively formed by the mass analyzer state 802, the voltage/timing adjustment 804, the reward 808, the resultant mass analyzer state 806, and the priority 902.

First, consider FIG. 10. In various embodiments, the training component 318 can electronically execute the parameter valuation neural network 706 on the mass analyzer state 802 and on the voltage/timing adjustment 804, and such execution can yield an output 1002. In particular, the training component 318 can concatenate the mass analyzer state 802 and the voltage/timing adjustment 804 together and can feed or route that concatenation to the input layer of the parameter valuation neural network 706. In various cases, that concatenation can complete a forward pass through the one or more hidden layers of the parameter valuation neural network 706. In various aspects, the output layer of the parameter valuation neural network 706 can compute or otherwise calculate the output 1002, based on activation maps or feature maps provided by the one or more hidden layers of the parameter valuation neural network 706.

Just as mentioned above, note that the format, size, or dimensionality of the output 1002 can be dictated by the number, arrangement, sizes, or other characteristics of the neurons, convolutional kernels, attention blocks, or other internal weights of the output layer (or of any other layers) of the parameter valuation neural network 706. Accordingly, the output 1002 can be forced to have any desired format, size, or dimensionality, by adding, removing, or otherwise adjusting characteristics of the output layer (or of any other layers) of the parameter valuation neural network 706. In various aspects, the output 1002 can be a scalar whose magnitude indicates how much calibration value the parameter valuation neural network 706 infers or predicts that the voltage/timing adjustment 804 has when performed on the mass analyzer state 802. Furthermore, note that, if the parameter valuation neural network 706 has so far undergone no or little training, then the output 1002 can be highly inaccurate.

In various aspects, the training component 318 can electronically execute the target parameter adjustment neural network 704 on the resultant mass analyzer state 806, and such execution can yield an output 1004. In particular, the training component 318 can feed or route the resultant mass analyzer state 806 to the input layer of the target parameter adjustment neural network 704. In various cases, the resultant mass analyzer state 806 can complete a forward pass through the one or more hidden layers of the target parameter adjustment neural network 704. In various aspects, the output layer of the target parameter adjustment neural network 704 can compute or otherwise calculate the output 1004, based on activation maps or feature maps provided by the one or more hidden layers of the target parameter adjustment neural network 704.

Because the target parameter adjustment neural network 704 can have the same architecture as (although possibly different weights than) the parameter adjustment neural network 702, the output 1004 can be considered as whatever absolute or relative adjustments to the one or more electrode voltages 306, to the ion injection duration 308, or to the ion trapping duration 310 which the target parameter adjustment neural network 704 infers or predicts would cause the resultant mass analyzer state 806 to transition to or toward a calibrated state. As above, note that, if the target parameter adjustment neural network 704 has so far undergone no or little training, then the output 1004 can be highly inaccurate.

In various aspects, the training component 318 can electronically execute the target parameter valuation neural network 708 on the resultant mass analyzer state 806 and on the output 1004, and such execution can yield an output 1006. In particular, the training component 318 can concatenate the resultant mass analyzer state 806 and the output 1004 together and can feed or route that concatenation to the input layer of the target parameter valuation neural network 708. In various cases, that concatenation can complete a forward pass through the one or more hidden layers of the target parameter valuation neural network 708. In various aspects, the output layer of the target parameter valuation neural network 708 can compute or otherwise calculate the output 1006, based on activation maps or feature maps provided by the one or more hidden layers of the target parameter valuation neural network 708.

Because the target parameter valuation neural network 708 can have the same architecture as (although possibly different weights than) the parameter valuation neural network 706, the output 1006 can be a scalar whose magnitude indicates how much calibration value the target parameter valuation neural network 708 infers or predicts that the voltage/timing adjustments indicated by the output 1004 have when performed on the resultant mass analyzer state 806. Again, if the target parameter valuation neural network 708 has so far undergone no or little training, then the output 1006 can be highly inaccurate.

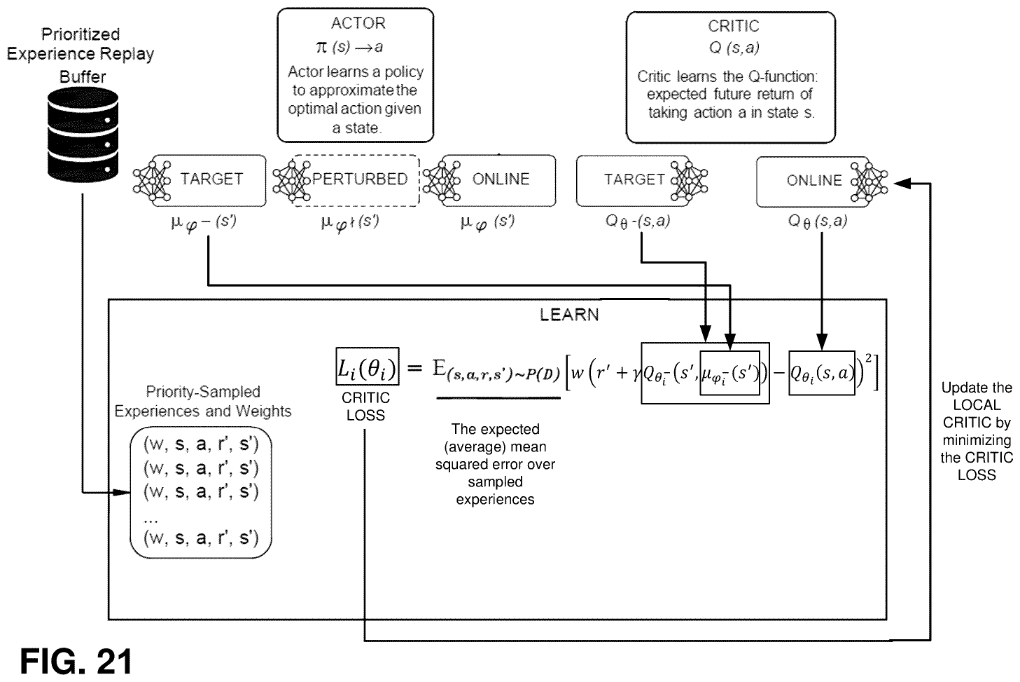

In any case, the training component 318 can electronically compute or calculate a valuation loss 1008, based on the output 1002, the output 1006, the reward 808, and the priority 902. Indeed, a non-limiting example of such loss calculation is shown with respect to FIG. 21 in which the following notation is utilized: an experience tuple (w, s, a, r′, s′) has a priority w (also referred to as a priority weight or as a weight based on prioritization sampling bias), a mass analyzer state s, a voltage/timing adjustment a, a reward r′, and a resultant mass analyzer state s′; μ_{φ} represents the parameter adjustment neural network 702, μ_{φ}, represents an alternate, perturbed version of the parameter adjustment neural network 702 that can be used in some cases; μ_{φ-} represents the target parameter adjustment neural network 704; Q_{θ} represents the parameter valuation neural network 706; Q_{θ-} represents the target parameter valuation neural network 708; γ can be any suitable learning hyperparameter; and L(θ) represents the valuation loss 1008. In various instances, the quantity r′+γQ_{θ-}(s′, μ_{φ-}(s′)−Q_{θ}(s, a) can be referred to as a TD error. In various cases, the training component 318 can update the priority 902 in any suitable fashion based on the TD error (e.g., such priority updating is often utilized in deep deterministic policy gradient techniques).

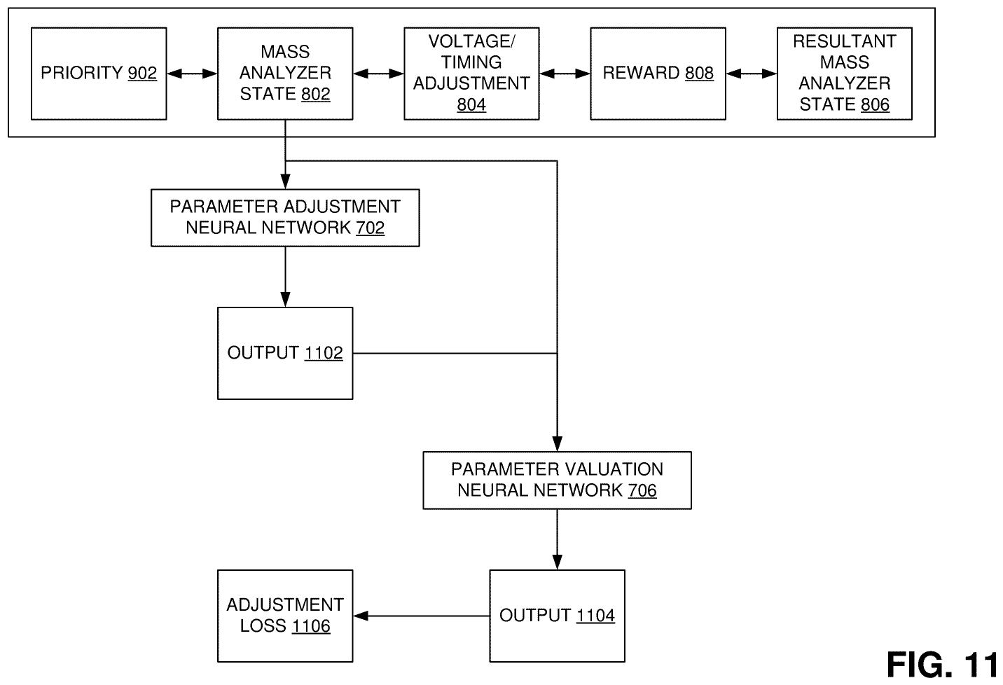

Next, consider FIG. 11. In various embodiments, the training component 318 can electronically execute the parameter adjustment neural network 702 on the mass analyzer state 802, and such execution can yield an output 1102. In particular, the training component 318 can feed or route the mass analyzer state 802 to the input layer of the parameter adjustment neural network 702. In various cases, the mass analyzer state 802 can complete a forward pass through the one or more hidden layers of the parameter adjustment neural network 702. In various aspects, the output layer of the parameter adjustment neural network 702 can compute or otherwise calculate the output 1102, based on activation maps or feature maps provided by the one or more hidden layers of the parameter adjustment neural network 702. Accordingly, the output 1102 can be considered as whatever absolute or relative adjustments to the one or more electrode voltages 306, to the ion injection duration 308, or to the ion trapping duration 310 which the parameter adjustment neural network 702 infers or predicts would cause the mass analyzer state 802 to transition to or toward a calibrated state. As above, note that, if the parameter adjustment neural network 702 has so far undergone no or little training, then the output 1102 can be highly inaccurate.

In various aspects, the training component 318 can electronically execute the parameter valuation neural network 706 on the mass analyzer state 802 and on the output 1102, and such execution can yield an output 1104. In particular, the training component 318 can concatenate the mass analyzer state 802 and the output 1102 together and can feed or route that concatenation to the input layer of the parameter valuation neural network 706. In various cases, that concatenation can complete a forward pass through the one or more hidden layers of the parameter valuation neural network 706. In various aspects, the output layer of the parameter valuation neural network 706 can compute or otherwise calculate the output 1104, based on activation maps or feature maps provided by the one or more hidden layers of the parameter valuation neural network 706. Accordingly, the output 1104 can be a scalar whose magnitude indicates how much calibration value the parameter valuation neural network 706 infers or predicts that the voltage/timing adjustments specified by the output 1102 have when performed on the mass analyzer state 802. Again, note that, if the parameter valuation neural network 706 has so far undergone no or little training, then the output 1104 can be highly inaccurate.

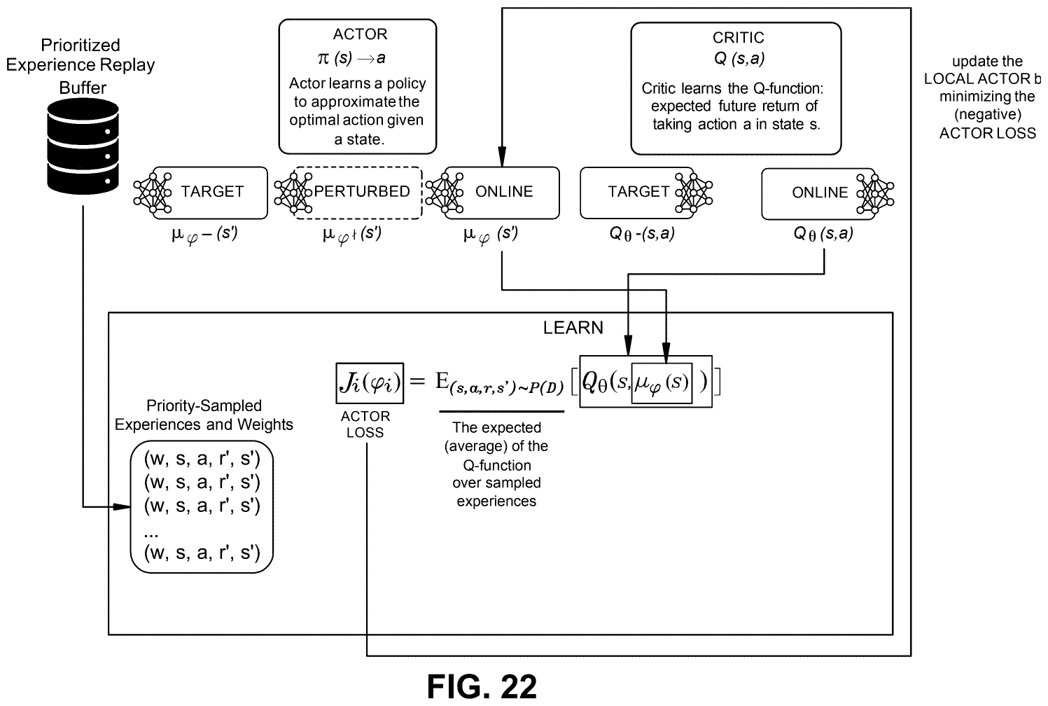

In any case, the training component 318 can electronically compute or calculate an adjustment loss 1106, based on the output 1104. Indeed, a non-limiting example of such loss calculation is shown with respect to FIG. 22 in which the following notation is utilized: J(φ) represents the adjustment loss 1106.

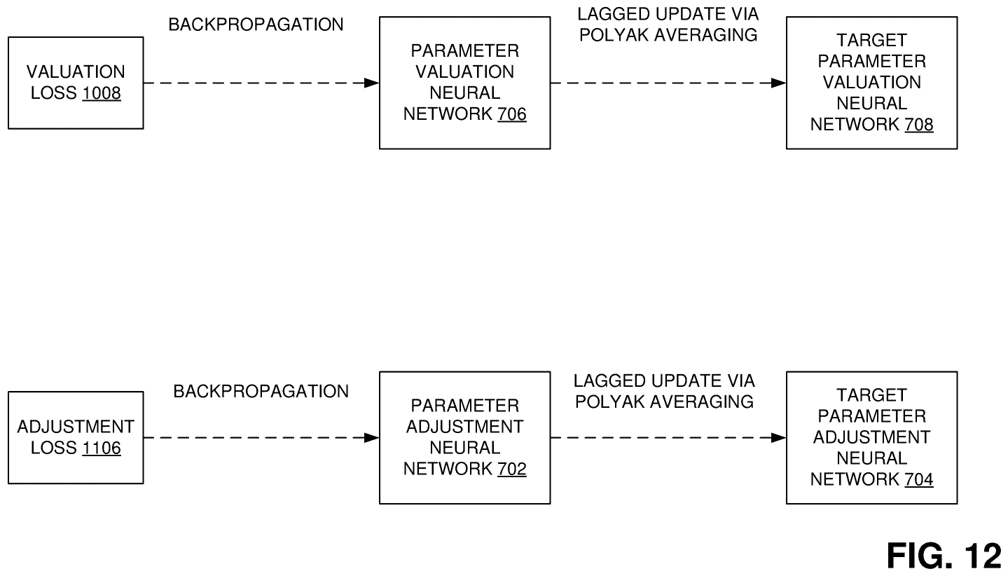

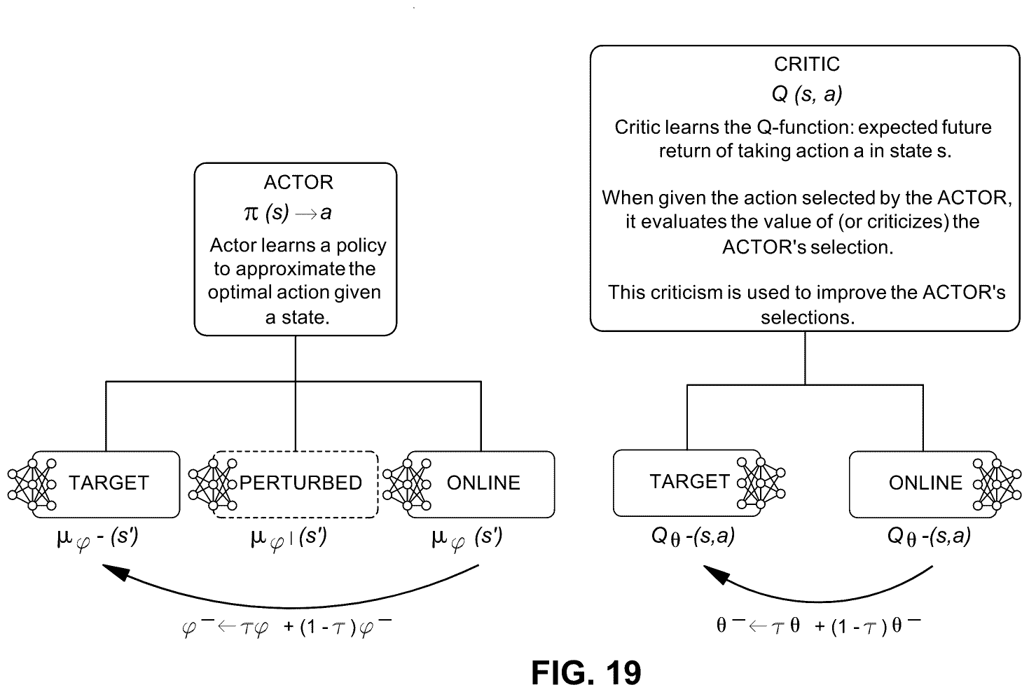

Now, consider FIG. 12. In various embodiments, the training component 318 can incrementally update the learnable or trainable internal weights of the parameter valuation neural network 706 by applying backpropagation (e.g., stochastic gradient descent) driven by the valuation loss 1008. In various aspects, the training component 318 can electronically perform a lagged update to the target parameter valuation neural network 708, by applying Polyak averaging based on the newly-updated learnable or trainable internal weights of the parameter valuation neural network 706. A non-limiting example of such Polyak averaging is shown in FIG. 19 in which τ is a small hyperparameter (e.g., 0.01). Likewise, the training component 318 can incrementally update the learnable or trainable internal weights of the parameter adjustment neural network 702 by applying backpropagation (e.g., stochastic gradient descent) driven by the adjustment loss 1106. Additionally, the training component 318 can electronically perform a lagged update to the target parameter adjustment neural network 704, by applying Polyak averaging based on the newly-updated learnable or trainable internal weights of the parameter adjustment neural network 702, such as shown in FIG. 19.

In various embodiments, the training component 318 can repeat the operations of FIGS. 10-12 for any suitable number of experience tuples (e.g., for all the experience tuples in the PER buffer 402). In various aspects, after training the set of reinforcement learning neural networks 404 on at least some experience tuples as shown with respect to FIGS. 10-12, the training component 318 can populate the PER buffer 402 with new experience tuples by executing the parameter adjustment neural network 702 as shown in FIGS. 8-9. By repeating this training-populating procedure any suitable number of times (e.g., for any suitable number of training epochs, or until any suitable training termination criterion is achieved), the training component 318 can cause the learnable or trainable internal weights of the parameter adjustment neural network 702 to become iteratively optimized for accurately or correctly predicting or inferring the voltage/timing adjustments for calibration purposes when given any mass analyzer state.

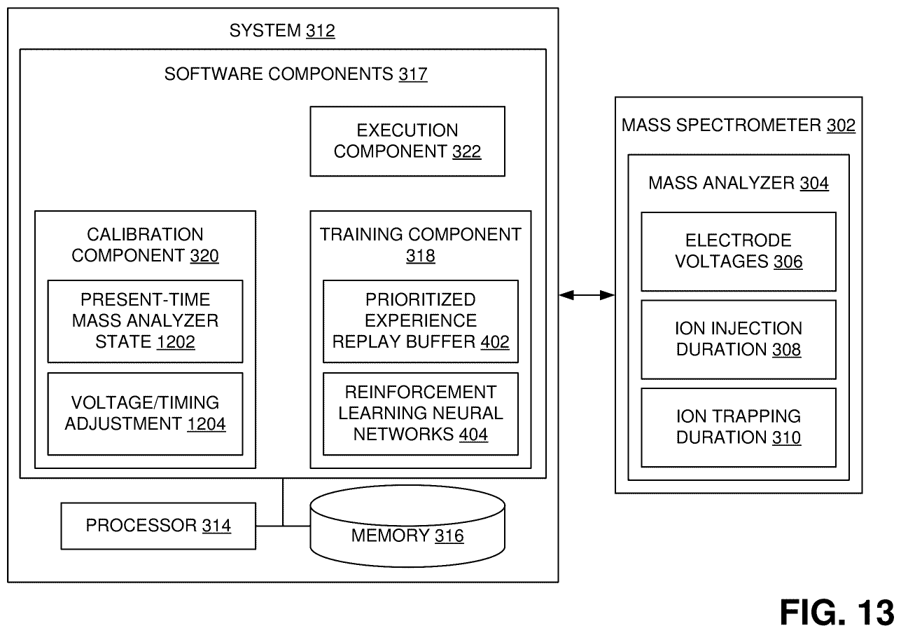

FIG. 13 illustrates a block diagram of an example, non-limiting system including a present-time mass analyzer state and a voltage/timing adjustment that can facilitate mass analyzer calibration via reinforcement learning in accordance with one or more embodiments described herein.

In various embodiments, after the training component 318 has trained the set of reinforcement learning neural networks 404, the calibration component 320 can electronically access a present-time mass analyzer state 1202 and can electronically determine or identify a voltage/timing adjustment 1204 based on the present-time mass analyzer state 1202.

In various aspects, the present-time mass analyzer state 1202 can be whatever mass analyzer state that the mass analyzer 304 currently or presently has after training has been performed on the set of reinforcement learning neural networks 404. That is, the present-time mass analyzer state 1202 can specify: what specific values the one or more electrode voltages 306 have at the moment that calibration is desired; what specific value the ion injection duration 308 has at the moment that calibration is desired; what specific value the ion trapping duration 310 has at the moment that calibration is desired; what specific isotope ratio fidelity metrics that the mass analyzer 304 exhibits or has at the moment that calibration is desired; what specific mass error dispersion metrics that the mass analyzer 304 exhibits or has at the moment that calibration is desired; what specific ion transmission metrics that the mass analyzer 304 exhibits or has at the moment that calibration is desired; or what specific coalescence metrics that the mass analyzer 304 exhibits or has at the moment that calibration is desired.

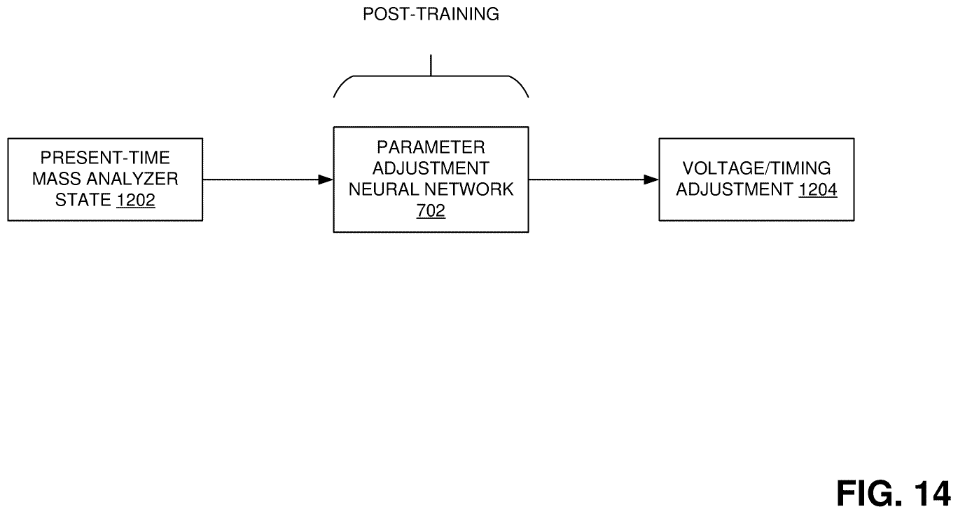

In various instances, the calibration component 320 can electronically execute the parameter adjustment neural network 702 (post-training) on the present-time mass analyzer state 1202, and such execution can yield the voltage/timing adjustment 1204, such as shown in FIG. 14.

More specifically, the calibration component 320 can feed or route the present-time mass analyzer state 1202 to the input layer of the parameter adjustment neural network 702. In various cases, the present-time mass analyzer state 1202 can complete a forward pass through the one or more hidden layers of the parameter adjustment neural network 702. In various aspects, the output layer of the parameter adjustment neural network 702 can compute or otherwise calculate the voltage/timing adjustment 1204, based on activation maps or feature maps provided by the one or more hidden layers of the parameter adjustment neural network 702. Accordingly, the voltage/timing adjustment 1204 can be considered as whatever absolute or relative adjustments to the one or more electrode voltages 306, to the ion injection duration 308, or to the ion trapping duration 310 which the parameter adjustment neural network 702 infers or predicts would cause the present-time mass analyzer state 1202 to transition to or toward a calibrated state. Because the parameter adjustment neural network 702 can have been trained by the training component 318, the voltage/timing adjustment 1204 can have a high likelihood or probability of being correct, accurate, or reliable.

In various embodiments, the execution component 322 can electronically apply the voltage/timing adjustment 1204 to the mass analyzer 304. That is, the execution component 322 can electronically instruct, command, or otherwise cause the mass spectrometer 302 to increase, decrease, or otherwise modify the values of the one or more electrode voltages 306, of the ion injection duration 308, or of the ion trapping duration 310 by whatever amounts are specified in the voltage/timing adjustment 1204. Such increase, decrease, or modification can thus cause the mass analyzer 304 to actually or physically transition to a new state that is calibrated (or that is at least significantly closer to being calibrated than the present-time mass analyzer state 1202 is). In some cases, the calibration component 320 and the execution component 322 can repeat their above-described actions any suitable number times, so as to minimize the distance between the final state of the mass analyzer 304 and a truly or properly calibrated state.

In various aspects, the parameter adjustment neural network 702 can be utilized, without retraining, to calibrate any other instantiations, copies, versions, or reproductions of the mass analyzer 304 as desired.

Although various embodiments are described herein with respect to calibration of mass analyzers, these are mere non-limiting examples. In some aspects, various teachings described herein can be readily applied to the calibration of any suitable scientific instruments (e.g., not limited just to mass analyzers).

Although various embodiments described herein involve implementation of prioritized experience replay buffers (e.g., 402), these are mere non-limiting examples. In various cases, any suitable non-prioritized experience replay buffer can be implemented.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence (class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

In order to provide additional context for various embodiments described herein, FIG. 15 and the following discussion are intended to provide a brief, general description of a suitable computing environment 1500 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 15, the example environment 1500 for implementing various embodiments of the aspects described herein includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors. Dual microprocessors and other multi-processor architectures can also be employed as the processing unit 1504.

The system bus 1508 can be any of several types of bus structure that can further interconnect to a memory bus (with or without a memory controller), a peripheral bus, and a local bus using any of a variety of commercially available bus architectures. The system memory 1506 includes ROM 1510 and RAM 1512. A basic input/output system (BIOS) can be stored in a non-volatile memory such as ROM, erasable programmable read only memory (EPROM), EEPROM, which BIOS contains the basic routines that help to transfer information between elements within the computer 1502, such as during startup. The RAM 1512 can also include a high-speed RAM such as static RAM for caching data.

The computer 1502 further includes an internal hard disk drive (HDD) 1514 (e.g., EIDE, SATA), one or more external storage devices 1516 (e.g., a magnetic floppy disk drive (FDD) 1516, a memory stick or flash drive reader, a memory card reader, etc.) and a drive 1520, e.g., such as a solid state drive, an optical disk drive, which can read or write from a disk 1522, such as a CD-ROM disc, a DVD, a BD, etc. Alternatively, where a solid state drive is involved, disk 1522 would not be included, unless separate. While the internal HDD 1514 is illustrated as located within the computer 1502, the internal HDD 1514 can also be configured for external use in a suitable chassis (not shown). Additionally, while not shown in environment 1500, a solid state drive (SSD) could be used in addition to, or in place of, an HDD 1514. The HDD 1514, external storage device(s) 1516 and drive 1520 can be connected to the system bus 1508 by an HDD interface 1524, an external storage interface 1526 and a drive interface 1528, respectively. The interface 1524 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1502, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1512, including an operating system 1530, one or more application programs 1532, other program modules 1534 and program data 1536. All or portions of the operating system, applications, modules, or data can also be cached in the RAM 1512. The systems and methods described herein can be implemented utilizing various commercially available operating systems or combinations of operating systems.

Computer 1502 can optionally comprise emulation technologies. For example, a hypervisor (not shown) or other intermediary can emulate a hardware environment for operating system 1530, and the emulated hardware can optionally be different from the hardware illustrated in FIG. 15. In such an embodiment, operating system 1530 can comprise one virtual machine (VM) of multiple VMs hosted at computer 1502. Furthermore, operating system 1530 can provide runtime environments, such as the Java runtime environment or the .NET framework, for applications 1532. Runtime environments are consistent execution environments that allow applications 1532 to run on any operating system that includes the runtime environment. Similarly, operating system 1530 can support containers, and applications 1532 can be in the form of containers, which are lightweight, standalone, executable packages of software that include, e.g., code, runtime, system tools, system libraries and settings for an application.

Further, computer 1502 can be enable with a security module, such as a trusted processing module (TPM). For instance with a TPM, boot components hash next in time boot components, and wait for a match of results to secured values, before loading a next boot component. This process can take place at any layer in the code execution stack of computer 1502, e.g., applied at the application execution level or at the operating system (OS) kernel level, thereby enabling security at any level of code execution.

A user can enter commands and information into the computer 1502 through one or more wired/wireless input devices, e.g., a keyboard 1538, a touch screen 1540, and a pointing device, such as a mouse 1542. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1504 through an input device interface 1544 that can be coupled to the system bus 1508, but can be connected by other interfaces, such as a parallel port, an IEEE 1394 serial port, a game port, a USB port, an IR interface, a BLUETOOTH® interface, etc.

A monitor 1546 or other type of display device can be also connected to the system bus 1508 via an interface, such as a video adapter 1548. In addition to the monitor 1546, a computer typically includes other peripheral output devices (not shown), such as speakers, printers, etc.

The computer 1502 can operate in a networked environment using logical connections via wired or wireless communications to one or more remote computers, such as a remote computer(s) 1550. The remote computer(s) 1550 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1552 is illustrated. The logical connections depicted include wired/wireless connectivity to a local area network (LAN) 1554 or larger networks, e.g., a wide area network (WAN) 1556. Such LAN and WAN networking environments are commonplace in offices and companies, and facilitate enterprise-wide computer networks, such as intranets, all of which can connect to a global communications network, e.g., the Internet.

When used in a LAN networking environment, the computer 1502 can be connected to the local network 1554 through a wired or wireless communication network interface or adapter 1558. The adapter 1558 can facilitate wired or wireless communication to the LAN 1554, which can also include a wireless access point (AP) disposed thereon for communicating with the adapter 1558 in a wireless mode.

When used in a WAN networking environment, the computer 1502 can include a modem 1560 or can be connected to a communications server on the WAN 1556 via other means for establishing communications over the WAN 1556, such as by way of the Internet. The modem 1560, which can be internal or external and a wired or wireless device, can be connected to the system bus 1508 via the input device interface 1544. In a networked environment, program modules depicted relative to the computer 1502 or portions thereof, can be stored in the remote memory/storage device 1552. It will be appreciated that the network connections shown are example and other means of establishing a communications link between the computers can be used.

When used in either a LAN or WAN networking environment, the computer 1502 can access cloud storage systems or other network-based storage systems in addition to, or in place of, external storage devices 1516 as described above, such as but not limited to a network virtual machine providing one or more aspects of storage or processing of information. Generally, a connection between the computer 1502 and a cloud storage system can be established over a LAN 1554 or WAN 1556 e.g., by the adapter 1558 or modem 1560, respectively. Upon connecting the computer 1502 to an associated cloud storage system, the external storage interface 1526 can, with the aid of the adapter 1558 or modem 1560, manage storage provided by the cloud storage system as it would other types of external storage. For instance, the external storage interface 1526 can be configured to provide access to cloud storage sources as if those sources were physically connected to the computer 1502.

The computer 1502 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 16 is a schematic block diagram of a sample computing environment 1600 with which the disclosed subject matter can interact. The sample computing environment 1600 includes one or more client(s) 1610. The client(s) 1610 can be hardware or software (e.g., threads, processes, computing devices). The sample computing environment 1600 also includes one or more server(s) 1630. The server(s) 1630 can also be hardware or software (e.g., threads, processes, computing devices). The servers 1630 can house threads to perform transformations by employing one or more embodiments as described herein, for example. One possible communication between a client 1610 and a server 1630 can be in the form of a data packet adapted to be transmitted between two or more computer processes. The sample computing environment 1600 includes a communication framework 1650 that can be employed to facilitate communications between the client(s) 1610 and the server(s) 1630. The client(s) 1610 are operably connected to one or more client data store(s) 1620 that can be employed to store information local to the client(s) 1610. Similarly, the server(s) 1630 are operably connected to one or more server data store(s) 1640 that can be employed to store information local to the servers 1630.

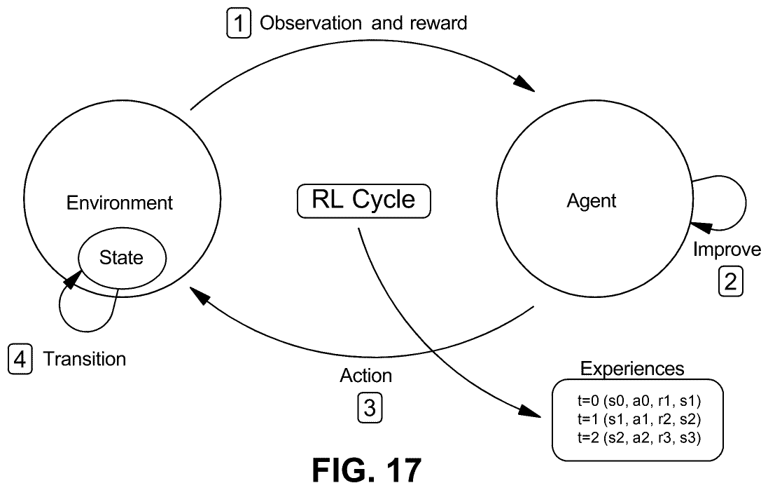

Now, consider FIGS. 17-33.

The embodiments disclosed herein combine the disciplines of mass spectrometry (e.g., calibration of mass spectrometry instruments or components, such as orbital trapping mass analyzers), or more generally the multi-dimensional, multi-objective calibration of scientific instruments), and the artificial intelligence/machine learning (AI/ML) field of Deep Reinforcement Learning (DRL), particularly as applied to problems where exploration is costly and data efficiency is critical.

Disclosed herein are scientific instrument self-calibration systems, as well as related methods, computing devices, and computer-readable media. While AI/ML and deep learning approaches have been applied in the processing of data generated by mass spectrometers, on-instrument applications of AI/ML and deep learning algorithms are in their nascent stages. Various embodiments disclosed herein include novel and innovative techniques in which deep reinforcement learning is used to solve a mass spectrometry calibration problem. As discussed herein, various embodiments include innovative approaches to the design of a DRL environment to allow prior manufacturing data to be leveraged for pre-training, enhancing the practicality of the systems and methods disclosed herein. As discussed herein, various scientific instrument self-calibration embodiments may achieve improved performance relative to existing calibration techniques. The embodiments disclosed herein thus provide improvements to scientific instrument technology (e.g., improvements in the computer technology supporting such scientific instruments, among other improvements).

Calibration is important in establishing and maintaining the performance of scientific (i.e., analytical) instrumentation, like mass spectrometers. Generally, one or more metrics, considered together, are used as a proxy for the performance of an instrument, or part thereof; in mass spectrometry, metrics like transmission or resolution, etc., may be used as proxies for performance. The goal of calibration may be to optimize all the relevant metrics by finding a set of optimal instrument parameters. However, the complexity of doing so can vary from relatively simple, single-parameter and single-objective problems, to intractable multi-dimensional problems comprising non-independent parameters and multiple, competing objectives, with stochasticity and measurement noise often providing further complication. While the former may be addressed with standard techniques (e.g., filtering, fitting model functions to collected data, and maximizing the objective metrics), standard techniques are insufficient for the latter. Such standard techniques may struggle due to the high dimensionality of the parameter space and the impracticality of sampling this space, the inability to describe such spaces with model functions, and the difficulty of finding a general optimum for the objective metrics, for example.

Various embodiments disclosed herein may address a problem of the latter category, and may be discussed for illustrative purposes with reference to calibration of the Orbitrap™ mass analyzer. The embodiments disclosed herein, however, can also be seen more generally as a blueprint for approaching similarly complex calibration problems pertaining to analytical instrumentation, and thus any discussion of particular embodiments related to calibration of orbital trapping mass analyzers should be viewed as illustrative but not limiting with respect to application of the techniques discussed herein to analogous technologies.

In some embodiments, a goal of orbital trapping mass analyzer calibration is to find the set of orbital trapping tuning parameters (electrode voltages) which simultaneously optimize the following performance metrics over the entire range of analyzable mass-to-charge ratios: isotopic ratio fidelity, mass error dispersion, transmission, and resilience to coalescence. This optimization problem is particularly intractable due to the large parameter space (nine continuous tuning variables), the high time cost of determining the metrics (evaluation procedures requiring tens of seconds to several minutes), the complex interplay of competing objectives that must be balanced for optimal performance, and the lack of independence of the tuning parameters.

Conventional approaches to calibration include some automatic procedures, but automatic procedures that successfully integrate all metrics and that are practical in a supplier, production, and/or customer environment have been elusive. Conventional automatic solutions remain generally inferior to manual calibration by highly experienced production test engineers.

The embodiments disclosed herein counter-intuitively approach the scientific instrument calibration problem not as a multi-objective optimization of a high-dimensional hyperplane, but as a problem of making complex sequential decisions under uncertainty to arrive at a goal in the shortest amount of time possible. This clever approach may allow the problem to be addressed in the machine learning domain of reinforcement learning (RL), and when utilizing deep neural networks as function approximators, deep reinforcement learning (DRL).

In (D)RL, a machine, or agent, is tasked with learning how to act with an environment in the most rewarding way through trial and error, that is, by taking actions and observing its rewards and the resulting state of the environment. Each iteration of interaction yields an experience, a tuple of (state, action, reward, next state) which embodies an opportunity for learning and performance improvement for the agent, such as shown in FIG. 17. The agent uses the experiences to improve the actions it takes to maximize the reward it accumulates over its lifetime.

(D)RL assumes such decision-making problems, or environments, can be formalized as Markov Decision Processes (MDP). An MDP is a tuple consisting of a set of states S, a set of actions A, a reward function R(sₜ,aₜ), a state transition function P(sₜ₊₁|sₜ,aₜ), and a discount factor γ. In each state sₜ∈S, the agent takes an action aₜ∈A, receives a reward rₜ₊₁=R(sₜ,aₜ), and subsequently reaches a new state sₜ₊₁ as determined by the transition function probability distribution P(sₜ₊₁|sₜ,aₜ). The transition function of the environment must satisfy (as close as possible) the Markov property: P(sₜ₊₁|sₜ,aₜ)=P(sₜ₊₁|sₜ,aₜ,sₜ₋₁,aₜ₋₁, . . . ) which expresses that the probability of the next state given the current state and current action is equal to the probability of the next state given the entire history of agent-environment interactions.

A policy function π determines the action a that the agent will take in state s; this policy may be deterministic, yielding a single action, or stochastic, yielding a probability distribution over the available actions. The goal of the agent is to find or approximate an optimal policy π* mapping states to actions that maximizes the expected discounted total reward, or return, Gₜ=rₜ₊₁+γrₜ₊₂+γ²rₜ₊₃+ . . . +γ^{T-1}r_{T} over the agent's entire interaction trajectory, τ=(sₜ,aₜ,rₜ₊₁,sₜ₊₁,aₜ₊₁,rₜ₊₂,sₜ₊₂, . . . , r_{T},s_{T}). This concept is formalized by the functions given in Table 1 below, where the return is used in its recursive form Gₜ=Rₜ₊₁+γGₜ₊₁.

TABLE 1

| Function | Description | Formula |
|---|---|---|
| Policy, π | Given a state s, the | π(s) → a |
| | policy outputs an | π(s\|a) → P(A\|s) |
| | action a, or a prob- | |
| | ability distribution | |
| | over actions. | |
| State- | The value of a state | V_{π}(s) = |
| Value, V | s under policy π is | [symbol] _{π}[Rₜ₊₁ + |
| | the expectation of | γGₜ₊₁\|Sₜ = s] |
| | returns given that | |
| | the agent is in state | |
| | s at timestep t, and | |
| | thereafter acts | |
| | according to its | |
| | policy. | |
| Action- | The value of an | Q_{π}(s, a) = |
| Value, Q | action a in state s | [symbol] _{π}[Rₜ₊₁ + |
| | under policy π is | γGₜ₊₁\|Sₜ = s, |
| | the expectation of | Aₜ = a] |
| | returns given that | |
| | the agent selects | |
| | action a in state s | |
| | at timestep t, and | |
| | thereafter acts | |
| | according to its | |
| | policy. | |
| Action- | The advantage of | A_{π}(s, a) = |
| Advantage, | action a in state s | Q_{π}(s, a) − V_{π}(s) |
| A | under policy π is | |
| | the difference | |
| | between the value | |
| | of the action and | |
| | the value of the | |
| | state, both under | |
| | policy π. | |

There are a number of algorithms that may be used for finding or approximating the optimal policy. In policy-based algorithms, one learns the policy directly. In value-based algorithms, one learns the optimal policy indirectly by learning one or more value functions (Table 1). It should be noted that value and policy functions are linked: finding the optimal action-value function, Q*, yields the optimal policy:

$${π}^{*} ( s ) = {arg max}_{a} {Q}^{*} ( s , a ) .$$

One might also learn both policy and value functions in combined methods, termed actor-critic algorithms.

In various ones of the embodiments disclosed herein (e.g., for the purpose of orbital trapping mass analyzer calibration), the RL framework described above may be applied as follows. The environment may be defined as everything except the algorithm that “acts”, i.e., the agent. The environment includes the scientific instrument (e.g., a mass spectrometer) and its state (e.g., temperatures, pressures, sample, ionization conditions, electronics, hardware, etc.), the surroundings external to the instrument (e.g., room temperature, humidity, vibrations, etc.), as well as the information related to the task at hand, or the state. The state for an orbital trapping mass analyzer may include the following components, some which are observable by the agent and some which are not: the scans collected and the ion flux conditions; the curated spectral data extracted from the scans to describe the state of the orbital trapping mass analyzer calibration (this comprises the observation provided to the agent; note that, when the state is partially observable, it is not strictly correct to refer to the agent receiving the state s of the environment; rather, the agent is provided observation o of the state s; however, for simplicity, the term “state” will be used exclusively in this disclosure; it should be understood that any state accessible to the agent represents an observation (partial state) of the complete state); the actions available to the agent; the reward function Rₜ(sₜ,aₜ,sₜ₊₁)→rₜ₊₁ providing the reward to the agent; and the state of the mass calibration and extended dynamic range Fourier transform (eFT) phase calibration.

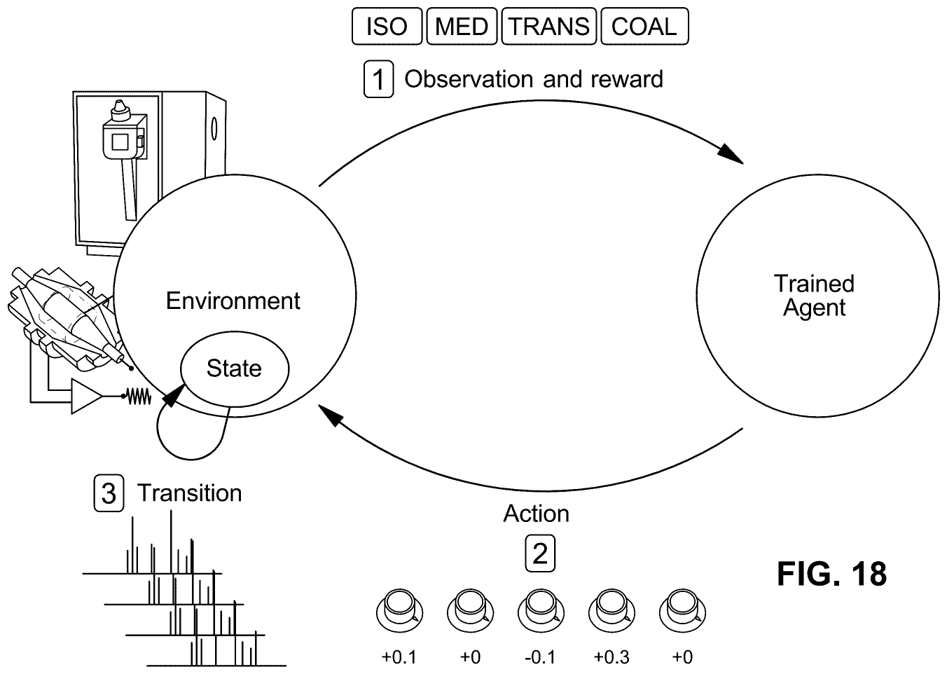

In some embodiments, it may be assumed that the usual starting conditions for an instrument procedure/calibration are present. For example, it may be assumed that the (state of the) surroundings and mass spectrometer are static and not part of the environment's transition function. Everything else—the task-related information—may be considered dynamic and part of the transition function and described by the (full) state of the environment. These concepts are illustrated by FIG. 18.

The orbital trapping mass analyzer calibration is a continuous control problem with both continuous state and action spaces. We take an actor-critic approach, learning both policy and action-value functions, each represented by neural networks. In some particular embodiments, the Deep Deterministic Policy Gradient (DDPG) algorithm may be modified for use as the basis for the orbital trapping mass analyzer calibration agent's algorithm, but other algorithms (e.g. Twin Delayed DDPG (TD3), or soft actor-critic (SAC)) may be used instead of DDPG.

The DDPG algorithm trains a policy to approximate the optimal action (the actor) while simultaneously training an action-value function (the critic) which has the role of evaluating (or “criticizing”) the value of the action selected by the policy (actor) for the given state. Notable characteristics are 1) its applicability to continuous state and action spaces, 2) use off-policy learning via an experience replay buffer, 3) use of target networks to stabilize training by promoting stationary optimization targets and improving convergence properties, and 4) the ease of the algorithm's extensibility for inclusion of algorithmic advances. In some embodiments, the original DDPG algorithm may be expanded by inclusion of a prioritized replay buffer and Parameter Space Noise, in lieu of action-space noise. The flowcharts in FIGS. 19-22 illustrate the function of some embodiments of the DDPG algorithm disclosed herein, as well as explain various components.

As illustrated in FIG. 19, the DDPG agent includes the actor, which learns a policy that generates deterministically the best action for a given state, and a critic. The deterministic policy makes this algorithm applicable to continuous action spaces. The critic learns the action-value, Q, function which is the value of taking an action in a given state, thereby evaluating, or criticizing, the action chosen by the actor. The “critique” of the actor's errors is used to learn. Learning is done in an “off-policy” manner, in which the “online” policy generating the actions is different from the policy being learned, the “target.” Thus, the actor and the critic are split into online and target parts. Learning off-policy makes the target of the optimization, the learning objective, effectively stationary. Without this, the learning objective is a moving target that changes with every new action and state, which can lead to catastrophic divergence during training.

As illustrated in FIG. 20, when the policy being learned is deterministic, the agent's actions will be deterministic. To encourage exploration of large state and action spaces, noise may be injected into the actions, either after action selection or at the point of action generation (e.g., by use of a perturbed variant of the online actor). Each interaction generates an experience that may be recorded in an experience replay buffer.

As illustrated in FIG. 21, the stored experiences may be used when the agent learns. After sufficient exploration, a batch of experiences may be selected from the replay buffer. Using a replay buffer may randomize experiences, removing correlations and smoothing over changes in the data distribution. This may result in the data looking more independent and identically distributed, which, along with stationary data, may aid the optimizer performing gradient descent. Effectively, each learning step may be turned into a small, supervised learning problem by use of a replay buffer, where the temporal different (TD) Target serves as the ground-truth label, and the error of the online critic's prediction of the TD Target, or the critic loss, is minimized. The TD Target, or temporal-difference target, is being learned. It is the one-step, bootstrapped estimate according to the target networks of the expected future return when taking action a and in state s. The online critic predicts the expected future return for the same state and action, and the difference to the TD Target, or TD Error, is calculated. The online critic's parameters are updated to minimize the TD Error, moving it closer to the predictions of the target critic. The TD Error is effectively a measure of how important, or “surprising,” an experience was to the online critic. If the error is high, the online critic was far off the TD Target—it was “surprised” by the experience, and this is a good indicator for a learning opportunity. Thus, the TD Error is additionally used to adjust the priorities of the experiences in the prioritized replay buffer. Surprising experiences may be prioritized higher to ensure that the agent learns from them more often than from less important experiences.

As illustrated in FIG. 22, after the critic learns, the actor is updated. The actor is learning the policy—what action to take in a given state. The optimal policy for a given state is the action which gives the maximum expected future return. The expected future return may also be given via the action-value function, Q. So, to improve the actor's policy toward the optimum, the Q function is maximized. The online critic evaluates the actions predicted by the online actor for a given state, and the online actor parameters may be updated with the result of this evaluation, pushing the online actor toward selecting actions with higher value.

In some embodiments, the calibration agent, with the goal of determining the best, highest reward, calibration for an orbital trapping mass analyzer within a fixed time period (episode), observes the state of the orbital trapping mass analyzer, acts by adjusting the electrode voltages, and observes the effects of the action through the next state of the orbital trapping mass analyzer and the reward it receives. In some particular embodiments, the calibration agent may start with the Rough Isotope Optimization, which performs a rough optimization of isotope ratio fidelity by optimizing up to three electrode voltages. Subsequently, voltage changes, guided by the result of four evaluation procedures described herein, are made until all procedures give a passing result. The procedures evaluating the aforementioned performance metrics may include the 1) Isotope Ratio Check (isotopic ratio fidelity), 2) Mass Error Dispersion Check (mass error dispersion), 3) Transmission Check by Injection Time (transmission), and 4) Coalescence Threshold Check (resilience to coalescence). The observed state of the orbital trapping mass analyzer may include metrics directly related to the evaluation procedures, while the provided scalar reward may represent the composite of the performance metrics and whether the metrics are in specification in the context of the production processes.

In some embodiments, the observed state of the orbital trapping mass analyzer shared with the agent is made up of what are referred to as “EnvMetrics” and the “EnvScans” that inform them. EnvMetrics evaluate the quality of the state; there is one for each performance metric: EnvMetricISO for the isotope ratio metric, EnvMetricMED for the mass error dispersion metric, EnvMetricTRANS for the transmission metric, and EnvMetricCOAL for the coalescence metric. The EnvMetrics determine the spectral data needed and thus the EnvScans, i.e., orbital trapping scans, to be acquired. EnvScans include scans with one or more isolation targets (referred to as EnvScanMPX), full scans (referred to as EnvScanFull), and full scans with independent charge detector (referred to as ICD) information. The ICD is an upstream electrometer providing an independent measurement of ion flux before ions reach the orbital trapping mass analyzer for determination of the transmission. Each EnvScan requires injection time information to reach the target ion numbers needed to assess the EnvMetrics. This information is provided by one or more flux scans (referred to as fEnvScanFlux) which can be any type of EnvScan. With this scheme, the normal automatic gain control (AGC) mechanism is bypassed and fixed injection times, calculated from single flux scan measurements for both orbital trapping and ICD injections, are used. Flux scans may be measured at regular intervals to update injection time information and account for drifts in ionization conditions. Multiple EnvMetrics may use data from the same EnvScan, while an EnvScanFlux may provide ion flux information to multiple EnvScans. This construction (as illustrated in FIG. 23) may generate the state of the orbital trapping mass analyzer from several scans in seconds, rather than in the several minutes needed in the manual process to execute the evaluation procedures. The scan notation shown in FIG. 23 should understood or otherwise appreciated by those of ordinary skill in the art (e.g., regarding EnvScanMPX([195, 524, 1522]w10, 240 k, 2e5), a person of ordinary skill will appreciate that: 195, 524, and 1522 are distinct mass-to-charge ratios that are being selectively monitored; w10 indicates a quadrupole width; 240 k indicates a scanning resolution; and 2e5 indicates a desired ion population size).

In some embodiments, as discussed below with respect to the example implementation, in total, to generate a state, nine EnvScans are performed to inform the four EnvMetrics, which can take about 4.3 s. Occasional updates of injection time information require the acquisition of 22 EnvScanFlux, which can take about 1.1 s.

EnvMetrics may process the data collected by the EnvScans and have three deliverables: 1) the metric's part of the state, or substate, 2) overall loss for the metric, a composite score of how optimal the tuning is according to the metric), and 3) the proportion of contributing sub-metrics that are in specification. FIGS. 24-27 illustrate inputs, processing steps, and outputs of each EnvMetric. The EnvMetricISO measures numerous isotope ratios in selective ion monitoring (SIM) and full scans resulting in its substate, and scores the ratios relative to theoretical expectations to result in the overall loss and proportion-in-specification deliverables. The EnvMetricMED performs a Mass Error Dispersion Check procedure. In some embodiments, the EnvMetricCOAL and EnvMetricTRANS have some aspects that are particularly distinct from the evaluation procedures of a manual process. Rather than direct measurement of the coalescence threshold (a prohibitively costly measurement), EnvMetricCOAL uses a proxy for this value determinable via a single scan. This value may also be tracked as an additional parameter by the prevailing Coalescence Threshold Check procedure and thus part of the production data. EnvMetricTRANS, like the Transmission Test by Injection Time, also describes orbital trapping transmission with three sub-metrics (low m/z full scan transmission, normal m/z full scan transmission, and the imbalance between low and normal transmission). In some embodiments, injection time may not be utilized as proxy for transmission, but rather the ratio of the orbital trapping current to the ICD current may be used as an ion source-independent transmission measure.

FIG. 24 is a schematic of EnvMetricISO, in accordance with various embodiments, evaluating the isotope ratio fidelity. In some embodiments, the EnvMetric tracks several isotopes and requires two analytical EnvScans. From each scan, the heights of the mono-isotopes and their isotopes are measured. An isotope ratio is calculated (iso/mono) relative to theoretical expectations for the isotope ratio. The median relative isotope ratio for each isotope forms the substate. A loss is calculated for median relative isotope ratio via the loss function. For each isotope, the proportion of measurements is tracked where the loss was in specification (≤1.0). The mean over all isotopes becomes the proportion-in-specification for this metric. The overall loss may be defined as the quadratic mean (also referred to as root mean square) of the median loss for each isotope.

FIG. 25 is a schematic of EnvMetricMED, in accordance with various embodiments, evaluating the mass error dispersion metrics. The EnvMetric measures the mass error of two isolated m/z from a scan having balanced AGC targets and a scan having highly imbalanced AGC targets and calculates the known sub-metrics, mass error jump, mass error spread, and mass error dispersion, which form the substate. The losses from the sub-metrics are combined to yield overall loss and the proportion-in-specification in the same way as done by EnvMetricISO.

FIG. 26 is a schematic of EnvMetricCOAL, in accordance with various embodiments, evaluating the resilience to coalescence. The EnvMetric may use a single low-target SIM scan of the mass-range-for-analysis (MRFA) isotopic doublet at m/z 526 as a proxy for coalescence resilience.

FIG. 27 is a schematic of EnvMetricTRANS, in accordance with various embodiments, evaluating the orbital trapping transmission. The EnvMetric uses the orbital trapping and ICD currents measured from two full scans to describe the improvement transmission over the prior state. It is comprised of three sub-metrics-low m/z full scan transmission, normal m/z full scan transmission, and the imbalance between low and normal transmission.

Together with the concatenated sub-states from the four EnvMetrics, the state provided to the agent additionally includes the normalized values of applied electrode voltages. These normalized voltages are provided by system objects which wrap electrode voltages, like the Deflector-Measure voltage, and scale the allowable range of voltages to between 0-1. Herein-described system can also handle the sign of voltages at the point of setting the underlying voltage to make the agent agnostic with respect to ion polarity. In some embodiments, the herein-described systems process the actions coming from the agent, as changes in normalized voltages, and apply them to the instrument. In some embodiments, the environment makes changes to the following instrument voltages available as actions to the agent: C-Trap HV Offset, C-Trap Push, HV Focus Lens, V Lens, Z Lens, Deflector—Inject, Deflector—Measure, CE—Inject, and Waves-to-Inject.

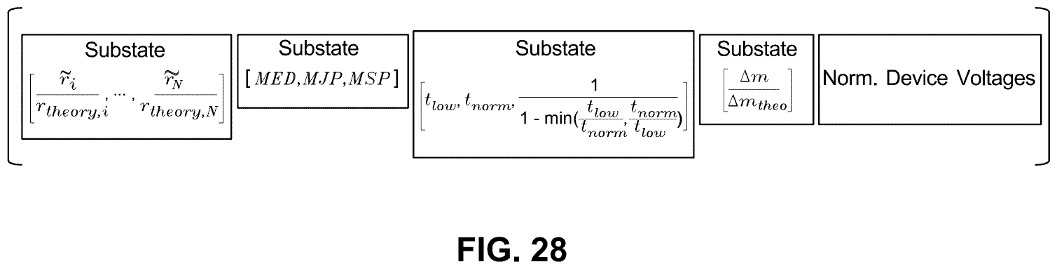

A schematic of the state provided to the agent is shown in FIG. 28.

The reward function combines the overall losses and proportion-in-specification deliverables from the EnvMetrics to yield a single reward for the state. The reward function illustrated in FIG. 29 was designed with the following characteristics: −1 when the losses/proportions are the worst possible; +1 when the losses/proportions are the best possible; +0.25 when the losses/proportions on the threshold of being in specification (i.e., losses all 1.0, proportions-in-specification all 1.0). The score at the “threshold case” is a tunable hyperparameter.

In some embodiments, the use of a bounded reward spanning from the worst to best possible case with a clear value marking the threshold where all EnvMetrics are in specification is intended to aid in interpretability of the agent's training process and its relationship to the production context.

The discussion above listed the components of the state which are observable by the agent and those which are not in certain embodiments. In this list, in addition to the ion flux conditions, for which injection times may be periodically adjusted via EnvFluxScans, two problem-specific and domain-specific aspects are not observable by the agent: the applicability of the mass calibration and eFT phase calibration following changes in the electrode voltages. When electrode voltages are modified, the m/z and the eFT phase shift (e.g., shift of reference time point to). Since, in some embodiments, neither the mass accuracy, nor to, are observed by the agent, and no actions to correct either are provided to the agent, low reward from EnvMetrics that cannot be properly measured given the massive mass errors and/or peak splitting (result of a to shift) may be improperly interpreted by the agent as being due selection of poor actions. This may destabilize training, as well as effectively limit the optimal tuning space to the extent of applicability of the mass and eFT calibrations, convoluting the result of the optimization.

To prevent this, in some embodiments, the mass calibration and eFT phase calibration may be corrected after application of the agent's actions and before generation of the next state. The mass calibration and eFT phase calibration may be determined in procedures taking numerous scans over tens of seconds. In some embodiments, determination of these calibrations may be reduced to two low-resolution full scans. In a first scan, the eFT phase's to parameter is determined and applied. In the second scan, frequency ratio-based detection of the calibrant (FlexMix) may be used to replace the entire mass calibration in a technique similar to an Auto Two-Point Mass Calibration and FlexMix Detection (Frequency-Based Calibrant Detection) routine. The second scan may also be used for further refinement of to.

As mentioned above, despite the substantial reduction of scans and time required to evaluate all performance metrics (compared to a manual process), the turn-around time for generation of a state in the orbital trapping mass analyzer calibration environment may remain higher than desired. This experience generation time underpins one of the major challenges of applying DRL in real-world settings.

DRL algorithms generally require extensive amounts of data (experiences gained from agent-environment interactions) to gain proficiency in the task at hand. This can typically be several million interactions of very poor performance until a good policy is learned. This slow convergence originates from the inherent data inefficiency of trial-and-error learning, the enormous data requirements of deep neural networks, and the desire to encourage exploration though initial random actions. For tasks carried out in simulated environments, like the near ubiquitous game simulator environments (e.g. Atari, Go, Quake, StarCraft) seen in the literature, this data inefficiency is easily overcome by near instantaneous experience generation. For real-world applications with physical environments, these characteristics have conventionally made application of DRL prohibitive and have limited its widespread adoption, even when using off-policy algorithms which reuse data during learning via a prioritized experience replay buffers, like DDPG.

Additionally, in the domain of orbital trapping calibration, there is the additional challenge of providing the calibration agent with experiences reflecting the full diversity of orbital trapping mass analyzers, with their inherent mechanical differences, of tolerances of the control electronics, and of mass spectrometer variants (e.g., round-bore and letter-box inlet; atmospheric pressure ionization (API) vs electron ionization (EI); liquid chromatography vs gas chromatography). Exposing the agent to the full diversity of states that it could encounter “in the wild” during training may be practically impossible.

Various ones of the embodiments disclosed herein may use directly related metrics, and include context-specific specifications, to overcome the limitations of conventional approaches. While including the specifications ensures that a successful agent's calibration result is also a valid and successful calibration in the context of production, the embodiments disclosed herein enable usage of previously-generated production data. This production data, constructed into demonstrations, can guide initial exploration, provide diversity in the early training process, and offset the experience generation time bottleneck explained above.

Experiences (e.g., state-action-reward-next-state tuples) may be reconstructed from production logs and procedure data acquired during the manual calibration process carried out on each orbital trapping mass analyzer block at the supplier, and on each instrument in production.

The main steps of the reconstruction process, in various embodiments, may be as follows.

For each instrument block, the instrument log files may be filtered for the relevant events and split by critical hardware changes (e.g., block changes) forming a trajectory of actions (manual voltage changes) and partial state information from executed evaluation procedures.

For each trajectory, consecutive partial state information may be accumulated to form raw states where information about each performance metric is available. In the case of consecutive/repetitive procedure execution, aliased raw states may be created. A “human trajectory” of alternating actions sets and (aliased) raw states may be formed.

Assuming initial default voltages, each (aliased) raw state may be labeled with the (normalized) voltages applied given the preceding actions.

By parsing the procedure results associated with each component of the (aliased) raw state, equivalent substate, loss, and proportion-in-specification metrics for each of the EnvMetrics may be generated. These substates may be concatenated with the normalized voltages from the prior step to form a (n) (aliased) state like in FIG. 28. This forms a complete state trajectory of voltage labeled (aliased) states.

From this complete state trajectory, all possible (state, action, next state)-tuples may be created by using sliding windows of length 2 to N, where N is the length of the complete state trajectory. Each aliased state may be unpacked and all combinations of state-next state pairs may be created. Actions may be determined by taking the difference of the normalized voltages between the state and the next state in the tuple. Additionally, the inverse tuple may be created.

Finally, for each tuple, the reward function may be used to calculate the reward and construct a (state, action, reward, next state)-transition.

FIG. 30 schematically shows an example of the last part of the workflow: creation of tuples from the state-action trajectory.

The DDPG algorithm, or any actor-critic algorithm using off-policy learning from mini-batches of experiences drawn from an experience replay buffer, may be well-suited for injection of foreign (non-agent origin) data. Thus, the production-origin demonstration transitions can be used to prepopulate the experience replay buffer. Without any algorithmic modifications, this would enable the Base DDPG agent to learn immediately during on-instrument training—there may be no need to wait, executing random actions, until the buffer has enough entries to sample a mini-batch. However, initial performance of the agent may still be poor and despite immediate learning may still take numerous interactions to overcome. Thus, the base DDPG algorithm described above may be modified with a combination of advances from the DDPG from Demonstration (DDPGfD) and DDPG with a Double Critic (DDPGfDBC) algorithms. These modifications may introduce the concept of initial, offline pretraining and behavioral cloning. Related approaches, such as the Actor-critic with Experience Replay and Advantage-weighted Regression (AWAC) algorithm are also suitable here and may be used.

In some embodiments, the modifications may include inclusion of the demonstration transitions permanently in the prioritized experience replay buffer or modification of the actor loss function to include a behavior cloning loss, L_{BC}, as shown below and as often used in imitation learning. This loss is computed on sampled demonstration transitions and represents the mean squared error between the actor-predicted actions and the demonstration actions for the same states.

$${L}_{B C} = {\sum }_{i = 1}^{N} {‖ {μ}_{φ} ( {s}_{i} ) - {a}_{i} ‖}^{2}$$

The actor loss then becomes a linear combination of the policy gradient (J) and behavioral cloning losses weighted by two hyperparameters, where policy gradient loss is maximized, and behavioral cloning loss is minimized.

$${λ}_{P G} {∇}_{φ} J - {λ}_{B C} {∇}_{φ} {L}_{B C}$$

The behavior cloning loss, used directly, has the effect of preventing the actor from improving its policy significantly beyond the performance embodied by the demonstrations. As demonstrations may be suboptimal (e.g., associated with suboptimal orbital trapping mass analyzers that were later exchanged, associated with the human learning process of the manual tuner, etc.), usage of the behavior cloning loss in online training may be conditioned such that it is considered only when the critic predicts the demonstration actions to be superior to the actor's predicted actions. If the actor's predictions have more value, the behavior cloning loss may be set to zero for that sample. Thus, as the agent improves beyond the demonstrations, this Q-filter ensures that the behavior cloning loss is gradually phased out, reverting the actor loss to the classical DDPG loss.

Rather than one learning update every N timesteps of the environment, as typical for simulated environments, the algorithm may be modified to perform multiple learning updates on every timestep.

In some embodiments, the modifications may include modification of the scheme for prioritization in the experience replay buffer. Rather than just the TD Error, δ, originating from the critic's assessment of the experience, experience prioritization may be expanded to include the loss applied to the actor (policy gradient and behavior cloning losses), and, for demonstrations, a positive constant, ∈_{D}, to increase the probability that demonstrations are sampled for learning. The priority, pᵢ, of a transition is

$${δ}_{i}^{2} + {λ}_{P G P} {\vert {∇}_{a} {Q}_{θ} ( {s}_{i} , {a}_{i} ) \vert}^{2} + {{λ}_{B C P} ( {μ}_{φ} ( {s}_{i} ) - {a}_{i} )}^{2} + ε + {ε}_{D}$$

where λ_{PGP} and λ_{BCP} weight the contributions of the policy and behavior cloning losses, respectively, relative to the TD Error. The prioritization of the replay buffer in this way additionally provides dynamic control of the ratio between native (agent-generated) and demonstration samples. At the beginning of training, demonstration samples will have higher priority and be sampled more often. As training progresses, and the agent becomes more proficient at the task, dependence on the demonstrations is naturally annealed via the prioritization in the replay buffer.

In some embodiments, the modifications may include offline pretraining of the agent using the demonstration data prior to on-instrument learning. This pretraining draws from the demonstrations in the experience buffer and applies the same loss and prioritization as the online training, but without the Q-filter.

Some or all of these modifications may address the bottlenecks of practical DRL, data efficiency and exploration cost, in one aspect or another. Via pretraining with demonstrations and behavior cloning, usage of the information content in the demonstrations may be increased without large time penalty (e.g., on GPU-enabled PCs). The generated model parameters and prioritized (demonstration-only) buffer then provide a warm start for online training with reduced need for initial random exploration and better early performance of the actor. This may reduce the interactions needed to gain proficiency in the online task. Further, weaning the agent at the appropriate time from the demonstrations ensures the agent can gain proficiency beyond the demonstrations. Lastly, multiple learning steps per online interaction may improve transition usage.

The following paragraphs describe an example implementation of some of the embodiments disclosed herein on an Orbitrap™ Exploris 120 (OE 120) test system of the systems and methods disclosed herein, in the context of an instrument procedure which acquires Orbitrap™ states, provides them to an agent (which may be a random agent), processes agent actions, and calculates rewards. Acquisition parameters/methods have been selected to achieve stable determination of EnvMetrics in acceptably low acquisition time. On an Orbitrap™ Exploris 120 system, state generation requires ˜4.3 s.

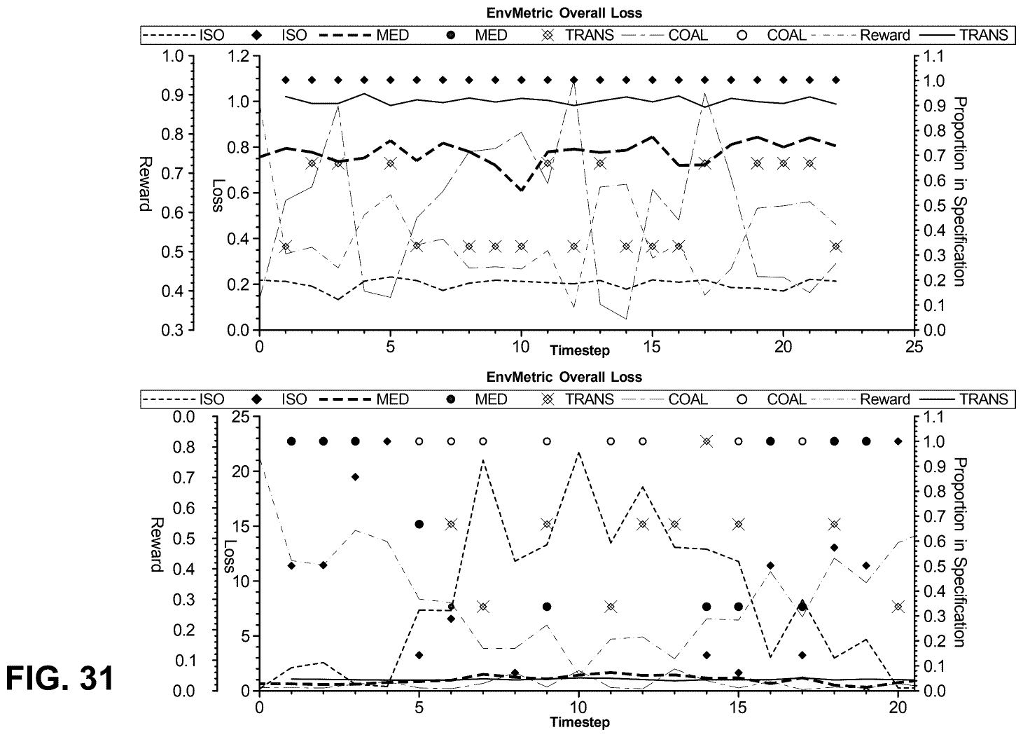

FIG. 31 shows Orbitrap™ tuning state information (individual EnvMetric Loss and Proportion-in-Specification metrics, as well as overall Reward) over several timesteps on-instrument in response to (top) no agent interaction, and (bottom) random agent interaction. In FIG. 31, solid lines for EnvMetrics ISO, MED, TRANS, and COAL indicate the loss from each metric (2nd left y-axis), same-colored dots the proportion-in-specification (right y-axis). Reward is plotted on the 1st left y-axis.

Demonstrations have been generated from supplier and production data. Combined, over 1.815 million demonstration transitions were generated. Initial pre-training was completed after a short hyperparameter optimization. The hyperparameters listed in Table 2 were used for pretraining in this example.

TABLE 2

| Feature | Description | Value |
|---|---|---|
| Environment | Gamma | 0.99 |
| Agent Model | Actor | Dense(23 → 1024) |
| Architecture | | LayerNorm(1024) |
| | | ReLU( ) |
| | | Dense(1024 → 512) |
| | | LayerNorm(512) |
| | | ReLU( ) |
| | | Dense(512 → 256) |
| | | LayerNorm(256) |
| | | ReLU( ) |
| | | Dense(256 → 128) |
| | | LayerNorm(128) |
| | | ReLU( ) |
| | | Dense(128 → 9) |
| | | Tanh( ) |
| | Critic | Dense(23 → 1024) |
| | | LayerNorm(1024) |
| | | ReLU( ) |
| | | Cat(x, actions)(1033) |
| | | Dense(1033 → 512) |
| | | LayerNorm(512) |
| | | ReLU( ) |
| | | Dense(512 → 256) |
| | | LayerNorm(256) |
| | | ReLU( ) |
| | | Dense(256 → 128) |
| | | LayerNorm(128) |
| | | ReLU( ) |
| | | Dense(128 → 1) |
| Optimizer | Type | Adam |
| | Learning Rate | Actor 1E-3, |
| | | Critic 1E-3 |
| | Weight Decay | Actor 0, Critic 0 |
| Loss Function | λ_{PG} | 5E-4 |
| | λ_{BC} | 1.0 (further divided |
| | | by batch size, 1/256) |
| Prioritized | Batch Size | 256 |
| Experience | Alpha | Constant, 1.0 |
| Buffer | Beta | Constant, 1.0 |
| | Epsilon, ε | 1E-6 |
| Prioritization | Type | DDPGfD_BC |
| Scheme | λ_{PGP} | 1.0 |
| | λ_{BCP} | 100 |
| | Demo | 1.0 |
| | Epsilon, ε_{D} | |

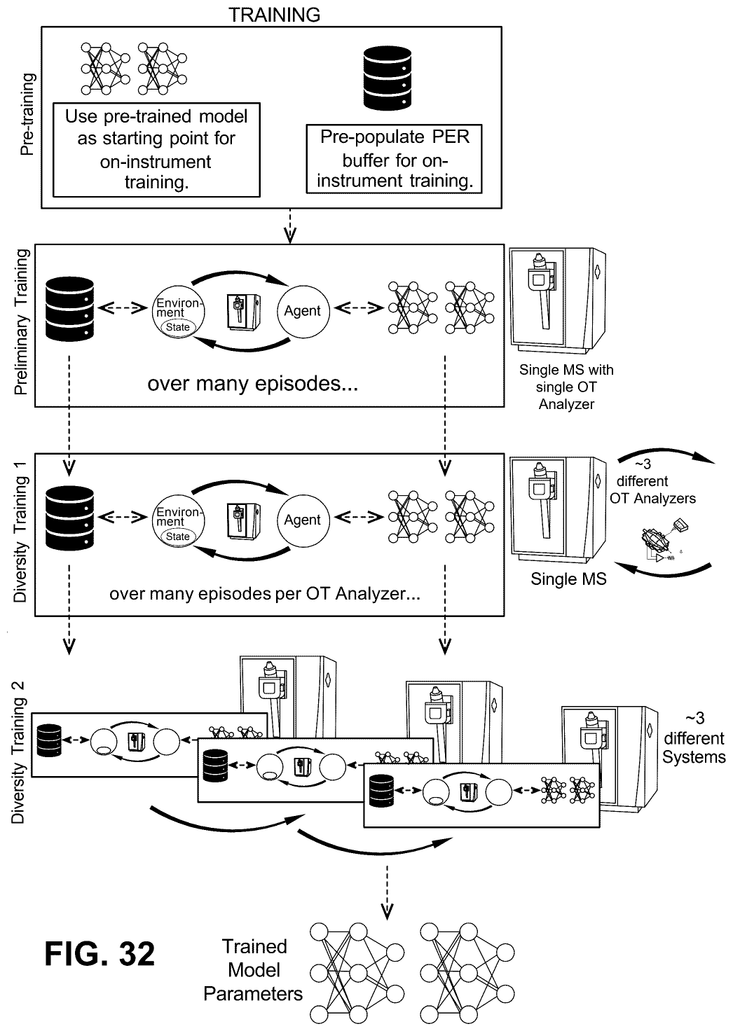

The saved model may be uploaded on the instrument to begin online training. The online training phases are shown in FIG. 32. Following preliminary training on one instrument with one Orbitrap™ block, the agent is exposed to more diverse states in a first diversity training by exchanging Orbitraps™ in a single instrument, and in a second diversity training step by exposing the agent to multiple instrument/Orbitrap™ block combinations.

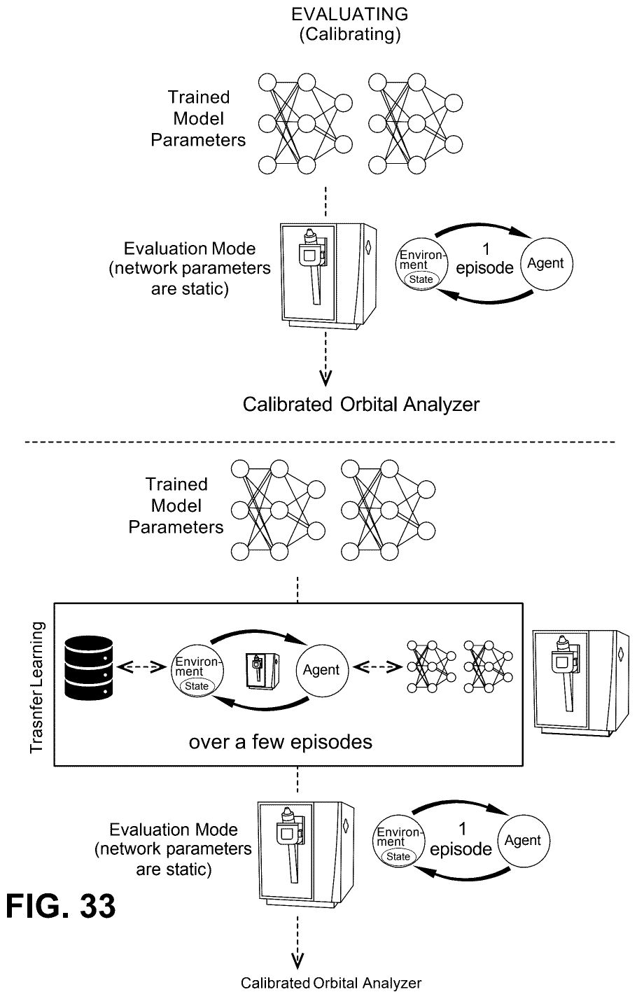

Once training is successfully completed, trained model parameters are used in “evaluation mode” to calibrate Orbitraps™ in a calibration procedure having a fixed duration of 1 episode, such as shown in the top of FIG. 33. The optimal/required length of an episode is determined during the training phase, but in some embodiments, will not exceed 10 minutes, the maximum time judged to still be practical in certain example production processes. A second approach, depending on the generalizability of the learned model, is to incorporate a short transfer learning training on each instrument to generate an instrument-specific model which is then leveraged for calibration of the Orbitrap™ such as shown in bottom of FIG. 33.

This calibration may be used in the context of production's final testing of instruments prior to shipment. The generated experiences from its application in production may be retained for continued training steps to further improve the model. Further deployment to the Orbitrap™ suppliers, field service, and finally customers (in the context of the customer's System Calibration) may be undertaken.

Various embodiments disclosed herein generate a model that has promise to be highly generalizable and extensible. By using production data and reusing experiences (generated from the future trained agent), pre-existing knowledge may be advantageously utilized, and continual re-training (and thereby adaption of the calibration as production processes evolve) may be enabled. As the model may embody the learnings of numerous past experiences, the time-to-calibration should be much quicker than methods which do not have access to prior information (e.g., conventional evolutionary or genetic algorithms).

An automated orbital trapping mass analyzer calibration may address inefficiencies in the lifecycle of orbital trapping instrumentation managed using conventional techniques. Namely, various embodiments disclosed herein may decrease time and testing costs at the supplier. In production, various ones of the embodiments disclosed herein will streamline instrument testing while yielding better and less variable orbital trapping performance. Efficiency is increased when servicing instruments in the field by having an Orbitrap™ calibration, decreasing customer downtime and saving resources. Likewise, various ones of the embodiments disclosed herein may achieve fewer customer down events via gradual recalibration of the orbital trapping mass analyzer within the customer's System Calibration.

Further, as discussed above, the present disclosure outlines a framework for practical use of DRL algorithms on mass spectrometers and other analytical instrumentation. This paves the way for applying such algorithms to other use cases both for calibration purposes and base operation strategies.

Usage of DRL in such a framework may be applied to a wide range of calibration problems with large state and action spaces and multiple optimization objectives. These might include problems as varied as spray condition optimization, as well as calibration of other analyzers, like the Astral analyzer.

The developed orbital trapping calibration may also be validly applied to orbital trapping instrumentation with non-atmospheric ionization modalities, like the Exploris GC/GC 240. Through transfer learning and adaptation of the metrics to the FC-43 calibrant solution, the learned model can be further adapted to this instrument class.

Various embodiments may be a system, a method, an apparatus or a computer program product at any possible technical detail level of integration. The computer program product can include a computer readable storage medium (or media) having computer readable program instructions thereon for causing a processor to carry out aspects of various embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various embodiments can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform various aspects.

Various aspects are described herein with reference to flowchart illustrations or block diagrams of methods, apparatus (systems), and computer program products according to various embodiments. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that various aspects can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various non-limiting aspects are described in the following examples.

EXAMPLE 1: A system can comprise: a processor that executes computer-executable components stored in a non-transitory computer-readable memory, wherein the computer-executable components can comprise: a calibration component that can predict, via execution of one or more reinforcement learning neural networks on present-time state data of a mass analyzer of a scientific instrument, what adjustments to one or more operational parameters of the mass analyzer would cause the mass analyzer to approach a calibrated state, wherein the one or more operational parameters include an electrode voltage of the mass analyzer or a timing control of the mass analyzer; and an execution component that can modify the one or more operational parameters based on the adjustments, thereby causing the mass analyzer to approach the calibrated state.

EXAMPLE 2: The system of any preceding example can be implemented, wherein the computer-executable components can comprise: a training component that can train the one or more reinforcement learning neural networks.

EXAMPLE 3: The system of any preceding example can be implemented, wherein the one or more reinforcement learning neural networks can comprise: a parameter adjustment neural network that can: receive, as input, state data of the mass analyzer; and produce, as output, parameter adjustments based on such inputted state data; a target parameter adjustment neural network whose internal weights can lag those of the parameter adjustment neural network; a parameter valuation neural network that can: receive, as input, the state data and the parameter adjustments; and produce, as output, a scalar that represents a valuation of the parameter adjustments; and a target parameter valuation neural network whose internal weights can lag those of the parameter valuation neural network.

EXAMPLE 4: The system of any preceding example can be implemented, wherein the training component can utilize a prioritized experience replay buffer having pre-populated tuples, wherein each pre-populated tuple can comprise a respective state, one or more respective parameter adjustments, a respective reward, and a respective resultant state, and wherein the pre-populated tuples can be derived from one or more prior calibrations of the mass analyzer.

EXAMPLE 5: The system of any preceding example can be implemented, wherein the one or more prior calibrations can collectively form a state-action trajectory, and wherein the pre-populated tuples can be computed from endpoints of one or more sliding windows that are run along the state-action trajectory.

EXAMPLE 6: The system of any preceding example can be implemented, wherein the training component can utilize the pre-populated tuples only when valuations of the pre-populated tuples are higher than corresponding valuations of tuples that are derived from parameter adjustments predicted by the one or more reinforcement learning neural networks.

EXAMPLE 7: The system of any preceding example can be implemented, wherein the present-time state data can comprise: one or more first scalars associated with an isotope ratio fidelity of the mass analyzer; one or more second scalars associated with an extent of mass error dispersion due to space charge of the mass analyzer; one or more third scalars associated with a transmission of the mass analyzer; and one or more fourth scalars associated with a resilience to coalescence due to space charge of the mass analyzer.

EXAMPLE 8: The system of any preceding example can be implemented, wherein: the training component can determine: the one or more first scalars via a first mapping function executed on a partial isotope ratio fidelity of the mass analyzer; the one or more second scalars via a second mapping function executed on a partial extent of mass error dispersion due to space charge of the mass analyzer; the one or more third scalars via a third mapping function executed on a partial transmission of the mass analyzer; and the one or more fourth scalars via a fourth mapping function executed on a partial resilience to coalescence due to space charge of the mass analyzer.

EXAMPLE 9: The system of any preceding example can be implemented, wherein the mass analyzer can be an orbital trapping mass analyzer.

In various embodiments, any combination or combinations of examples 1-9 can be implemented.

EXAMPLE 10: A computer-implemented method can comprise: predicting, by a device operatively coupled to a processor and via execution of one or more reinforcement learning neural networks on present-time state data of a mass analyzer of a scientific instrument, what adjustments to one or more operational parameters of the mass analyzer would cause the mass analyzer to approach a calibrated state, wherein the one or more operational parameters include an electrode voltage of the mass analyzer or a timing control of the mass analyzer; and modifying, by the device, the one or more operational parameters based on the adjustments, thereby causing the mass analyzer to approach the calibrated state.

EXAMPLE 11: The computer-implemented method of any preceding example can be implemented, further comprising: training, by the device, the one or more reinforcement learning neural networks.

EXAMPLE 12: The computer-implemented method of any preceding example can be implemented, wherein the one or more reinforcement learning neural networks can comprise: a parameter adjustment neural network that can: receive, as input, state data of the mass analyzer; and produce, as output, parameter adjustments based on such inputted state data; a target parameter adjustment neural network whose internal weights can lag those of the parameter adjustment neural network; a parameter valuation neural network that can: receive, as input, the state data and the parameter adjustments; and produce, as output, a scalar that represents a valuation of the parameter adjustments; and a target parameter valuation neural network whose internal weights can lag those of the parameter valuation neural network.

EXAMPLE 13: The computer-implemented method of any preceding example can be implemented, wherein the training can utilize a prioritized experience replay buffer having pre-populated tuples, wherein each pre-populated tuple can comprise a respective state, one or more respective parameter adjustments, a respective reward, and a respective resultant state, and wherein the pre-populated tuples can be derived from one or more prior calibrations of the mass analyzer.

EXAMPLE 14: The computer-implemented method of any preceding example can be implemented, wherein the one or more prior calibrations can collectively form a state-action trajectory, and wherein the pre-populated tuples can be computed from endpoints of one or more sliding windows that are run along the state-action trajectory.

EXAMPLE 15: The computer-implemented method of any preceding example can be implemented, wherein the training can utilize the pre-populated tuples only when valuations of the pre-populated tuples are higher than corresponding valuations of tuples that are derived from parameter adjustments predicted by the one or more reinforcement learning neural networks.

EXAMPLE 16: The computer-implemented method of any preceding example can be implemented, wherein the present-time state data can comprise: one or more first scalars associated with an isotope ratio fidelity of the mass analyzer; one or more second scalars associated with an extent of mass error dispersion due to space charge of the mass analyzer; one or more third scalars associated with a transmission of the mass analyzer; and one or more fourth scalars associated with a resilience to coalescence due to space charge of the mass analyzer.

EXAMPLE 17: The computer-implemented method of any preceding example can be implemented, wherein: the device can determine: the one or more first scalars via a first mapping function executed on a partial isotope ratio fidelity of the mass analyzer; the one or more second scalars via a second mapping function executed on a partial extent of mass error dispersion due to space charge of the mass analyzer; the one or more third scalars via a third mapping function executed on a partial transmission of the mass analyzer; and the one or more fourth scalars via a fourth mapping function executed on a partial resilience to coalescence due to space charge of the mass analyzer.

EXAMPLE 18: The computer-implemented method of any preceding example can be implemented, wherein the mass analyzer can be an orbital trapping mass analyzer.

In various embodiments, any combination or combinations of examples 10-18 can be implemented.

EXAMPLE 19: A computer program product for facilitating mass analyzer calibration via reinforcement learning can comprise a non-transitory computer-readable memory having program instructions embodied therewith. In various aspects, the program instructions can be executable by a processor to cause the processor to: access present-time state data of a mass analyzer of a mass spectrometer; predict, via execution of one or more reinforcement learning neural networks on the present-time state data, what adjustments to one or more electrode voltages of the mass analyzer would cause the mass analyzer to get closer to a calibrated state; and increase or decrease the one or more electrode voltages according to the predicted adjustments, thereby causing the mass analyzer to be calibrated.

EXAMPLE 20: The computer program product of any preceding example can be implemented, wherein the program instructions are executable to cause the processor to: train the one or more reinforcement learning neural networks according to a deep deterministic policy gradient technique that includes a prioritized experience replay buffer which is pre-populated with data derived from prior calibrations of the mass analyzer.

In various embodiments, any combination or combinations of examples 19-20 can be implemented.

In various embodiments, any combination or combinations of examples 1-20 can be implemented.

What is claimed is:

1. A system, comprising:
a processor that executes computer-executable components stored in a non-transitory computer-readable memory, wherein the computer-executable components comprise:
a calibration component that predicts, via execution of one or more reinforcement learning neural networks on present-time state data of a mass analyzer of a scientific instrument, what adjustments to one or more operational parameters of the mass analyzer would cause the mass analyzer to approach a calibrated state, wherein the one or more operational parameters include an electrode voltage of the mass analyzer or a timing control of the mass analyzer; and
an execution component that modifies the one or more operational parameters based on the adjustments, thereby causing the mass analyzer to approach the calibrated state.

2. The system of claim 1, wherein the computer-executable components comprise:
a training component that trains the one or more reinforcement learning neural networks.

3. The system of claim 2, wherein the one or more reinforcement learning neural networks comprise:
a parameter adjustment neural network that:
receives, as input, state data of the mass analyzer; and
produces, as output, parameter adjustments based on such inputted state data;
a target parameter adjustment neural network whose internal weights lag those of the parameter adjustment neural network;
a parameter valuation neural network that:
receives, as input, the state data and the parameter adjustments; and
produces, as output, a scalar that represents a valuation of the parameter adjustments; and
a target parameter valuation neural network whose internal weights lag those of the parameter valuation neural network.

4. The system of claim 2, wherein the training component utilizes a prioritized experience replay buffer having pre-populated tuples, wherein each pre-populated tuple comprises a respective state, one or more respective parameter adjustments, a respective reward, and a respective resultant state, and wherein the pre-populated tuples are derived from one or more prior calibrations of the mass analyzer.

5. The system of claim 4, wherein the one or more prior calibrations collectively form a state-action trajectory, and wherein the pre-populated tuples are computed from endpoints of one or more sliding windows that are run along the state-action trajectory.

6. The system of claim 5, wherein the training component utilizes the pre-populated tuples only when valuations of the pre-populated tuples are higher than corresponding valuations of tuples that are derived from parameter adjustments predicted by the one or more reinforcement learning neural networks.

7. The system of claim 2, wherein the present-time state data comprises:
one or more first scalars associated with an isotope ratio fidelity of the mass analyzer;
one or more second scalars associated with an extent of mass error dispersion due to space charge of the mass analyzer;
one or more third scalars associated with a transmission of the mass analyzer; and
one or more fourth scalars associated with a resilience to coalescence due to space charge of the mass analyzer.

8. The system of claim 7, wherein:
the training component determines:
the one or more first scalars via a first mapping function executed on a partial isotope ratio fidelity of the mass analyzer;
the one or more second scalars via a second mapping function executed on a partial extent of mass error dispersion due to space charge of the mass analyzer;
the one or more third scalars via a third mapping function executed on a partial transmission of the mass analyzer; and
the one or more fourth scalars via a fourth mapping function executed on a partial resilience to coalescence due to space charge of the mass analyzer.

9. The system of claim 1, wherein the mass analyzer is an orbital trapping mass analyzer.

10. A computer-implemented method, comprising:
predicting, by a device operatively coupled to a processor and via execution of one or more reinforcement learning neural networks on present-time state data of a mass analyzer of a scientific instrument, what adjustments to one or more operational parameters of the mass analyzer would cause the mass analyzer to approach a calibrated state, wherein the one or more operational parameters include an electrode voltage of the mass analyzer or a timing control of the mass analyzer; and
modifying, by the device, the one or more operational parameters based on the adjustments, thereby causing the mass analyzer to approach the calibrated state.

11. The computer-implemented method of claim 10, further comprising:
training, by the device, the one or more reinforcement learning neural networks.

12. The computer-implemented method of claim 11, wherein the one or more reinforcement learning neural networks comprise:
a parameter adjustment neural network that:
receives, as input, state data of the mass analyzer; and
produces, as output, parameter adjustments based on such inputted state data;
a target parameter adjustment neural network whose internal weights lag those of the parameter adjustment neural network;
a parameter valuation neural network that:
receives, as input, the state data and the parameter adjustments; and
produces, as output, a scalar that represents a valuation of the parameter adjustments; and
a target parameter valuation neural network whose internal weights lag those of the parameter valuation neural network.

13. The computer-implemented method of claim 11, wherein the training utilizes a prioritized experience replay buffer having pre-populated tuples, wherein each pre-populated tuple comprises a respective state, one or more respective parameter adjustments, a respective reward, and a respective resultant state, and wherein the pre-populated tuples are derived from one or more prior calibrations of the mass analyzer.

14. The computer-implemented method of claim 13, wherein the one or more prior calibrations collectively form a state-action trajectory, and wherein the pre-populated tuples are computed from endpoints of one or more sliding windows that are run along the state-action trajectory.

15. The computer-implemented method of claim 14, wherein the training utilizes the pre-populated tuples only when valuations of the pre-populated tuples are higher than corresponding valuations of tuples that are derived from parameter adjustments predicted by the one or more reinforcement learning neural networks.

16. The computer-implemented method of claim 11, wherein the present-time state data comprises:
one or more first scalars associated with an isotope ratio fidelity of the mass analyzer;
one or more second scalars associated with an extent of mass error dispersion due to space charge of the mass analyzer;
one or more third scalars associated with a transmission of the mass analyzer; and
one or more fourth scalars associated with a resilience to coalescence due to space charge of the mass analyzer.

17. The computer-implemented method of claim 16, wherein:
the device determines:
the one or more first scalars via a first mapping function executed on a partial isotope ratio fidelity of the mass analyzer;
the one or more second scalars via a second mapping function executed on a partial extent of mass error dispersion due to space charge of the mass analyzer;
the one or more third scalars via a third mapping function executed on a partial transmission of the mass analyzer; and
the one or more fourth scalars via a fourth mapping function executed on a partial resilience to coalescence due to space charge of the mass analyzer.

18. The computer-implemented method of claim 10, wherein the mass analyzer is an orbital trapping mass analyzer.

19. A computer program product for facilitating mass analyzer calibration via reinforcement learning, the computer program product comprising a non-transitory computer-readable memory having program instructions embodied therewith, the program instructions executable by a processor to cause the processor to:
access present-time state data of a mass analyzer of a mass spectrometer;
predict, via execution of one or more reinforcement learning neural networks on the present-time state data, what adjustments to one or more electrode voltages of the mass analyzer would cause the mass analyzer to get closer to a calibrated state; and
increase or decrease the one or more electrode voltages according to the predicted adjustments, thereby causing the mass analyzer to be calibrated.

20. The computer program product of claim 19, wherein the program instructions are executable to cause the processor to:
train the one or more reinforcement learning neural networks according to a deep deterministic policy gradient technique that includes a prioritized experience replay buffer which is pre-populated with data derived from prior calibrations of the mass analyzer.
